(19) United States
(12) Patent Application Publication
(10) Pub. No.: US 2018/0169935 A1
(43) Pub. Date: Jun. 21, 2018

(54) FORMING APPARATUS AND FORMING METHOD

(71) Applicant: MIMAKI ENGINEERING CO., LTD., Nagano (JP)

(72) Inventors: Kunio HAKKAKU, Nagano (JP); Kazuhiro OCHI, Nagano (JP); Terusumi EGUCHI, Nagano (JP)

(21) Appl. No.: 15/737,409

(22) PCT Filed: Jun. 30, 2016
(86) PCT No.: PCT/JP2016/069466

§ 371 Date: Dec. 18, 2017

(30) Foreign Application Priority Data
Jun. 30, 2015 (JP) 2015-132011
Jun. 30, 2015 (JP) 2015-132012

(51) Int. Cl. B29C 64/112; B29C 64/209; B29C 64/232; B29C 64/236; B29C 64/218

(52) U.S. Cl. CPC B29C 64/112; B29C 64/209; B33Y 10/00; B29C 64/236; B29C 64/218; B29C 64/232

(57) ABSTRACT

[Object] With the present invention, it is possible to, for example, more appropriately flatten a layer of ink during formation of a three-dimensional object.

[Means of Realizing the Object] A forming apparatus for forming a three-dimensional object by additive manufacturing include an inkjet head, flattening means, a platform, a main scanning driver, and a deposition direction driver to change a head-to-platform distance being a distance between the inkjet head and the platform. In an operation of forming a layer of ink, the forming apparatus causes a plurality of times of the first direction scanning intended to cause the inkjet head to move in one direction with respect to an identical position of the three-dimensional object in the middle of formation, and increases the head-to-platform distance during a main scanning operation to be performed later than the head-to-platform distance during the main scanning operation to be performed earlier in an operation of forming a layer of ink.

### TECHNICAL FIELD

The present invention relates to a forming apparatus and a forming method.

### BACKGROUND ART

Inkjet printers to perform printing by an inkjet scheme have conventionally been widely used (for example, refer to non-patent document 1). As a forming method using a forming apparatus (3D printer) that forms a three-dimensional object, a method of carrying out formation using an inkjet head (inkjet formation method) has recently been considered.

The forming method includes an additive manufacturing of forming a three-dimensional object by depositing a plurality of layers of ink ejected from the inkjet head one upon another.

### RELATED ART DOCUMENTS

### Non-Patent Documents

Non-patent document 1: Internet URL http://wwwv.mimami.co.jp

### DISCLOSURE OF THE INVENTION

### Problems to be Solved by the Invention

When the formation is carried out using the inkjet head, a layer of ink is formed by ejection of ink droplets from a fine nozzle hole disposed on the inkjet head. In this case, it is however unavoidable that a certain degree of variation can occur in volume of ink droplets ejected under the principle of the inkjet head. When forming a three-dimensional object by the additive manufacturing, the three-dimensional object is formed by depositing a plurality of layers of ink one upon another. Therefore, upon occurrence of variation in volume of the ink droplets, the influence of the variation can become significant in a stacked state.

In view of this, it is conceivable to flatten the layer of ink by using flattening means, such as a roller, in order to reduce the influence of the variation of the volume of ink droplets. In this case, however, the use of the flattening means, such as the roller, a new problem may occur.

It is therefore desirable to carry out flattening in a configuration taking the new problem into consideration, instead of only using the flattening means when carrying out the flattening.

Additionally, when forming the three-dimensional object by the additive manufacturing, it becomes necessary to carry out formation by depositing a plurality of layers of ink one upon another, and hence the forming may require a lot of time. Recently, however, there is a demand for a configuration that makes it possible to carry out the formation in a shorter time because of expanding application of 3D printers, or the like.

In cases where a three-dimensional object is formed by the additive manufacturing, it is also conceivable to, for example, speed up individual operations performed during the formation (such as a moving speed of the inkjet head) in order to reduce formation time. This however deteriorates precision of landing position of ink droplets, and therefore modeling precision is deteriorated, making it difficult to form the three-dimensional object with high precision. Hence, there is a demand for reduction in formation time with a more suitable method.

Accordingly, the present invention aims at providing a forming apparatus and a forming method which are capable of solving the above problems.

### Means of Solving the Problems

The inventor of the present application has conducted earnest study on various problems or the like caused by using the flattening means when carrying out the formation with the additive manufacturing by using an inkjet head. More specifically, when forming a three-dimensional object by using the inkjet head, there are problems generated by using inks, such as ultraviolet curable ink, to be cured according to a predetermined condition.

When carrying out formation with the additive manufacturing by using the inkjet head, in some cases, the formation may be carried out with a multi-pass method in order to, for example, improve resolution and average ejection characteristics of nozzles. As used herein, the phrase “carrying out formation of a layer of ink with a multi-pass method” refers to, for example, carrying out a plurality of times of main scanning operations with respect to individual positions of a three-dimensional object in the middle of formation. As used herein, the term “the main scanning operation” refers to, for example, an operation of the inkjet head that ejects ink droplets while moving in a preset main scanning direction.

In this case, it is also conceivable, in the main scanning operations in individual times, to cure dots of ink formed by the main scanning operation in the individual time. It is conceivable to carry out the flattening using the flattening means, such as the roller, in each or some of the main scanning operations carried out a plurality of times.

When carrying out the formation with the multi-pass method and also carrying out the flattening, it is conceivable to, for example, make setting so that only a dot of ink formed by the final pass (main scanning operation) comes into contact with the flattening means. However, in the configuration of an actual forming apparatus, a dot of ink, which is already formed by a pass other than the final pass and is already cured, can come into contact with the flattening means due to influences of an error generated in the flattening means, variation in the landing position of ink droplets, and the like.

In this regard, the inventor of the present application has specifically conducted tests and the like to confirm that a contact between dots of ink being cured ink and the flattening means actually occurs. The inventor has also found that due to the contact, for example, the cured dot can be rubbed out to generate excessive residue (for example, flaky ink residue).

When carrying out the flattening, the occurrence of the residue can interfere with the operation of the flattening. More specifically, when the flattening is carried out using the roller, it is conceivable to remove the ink on the surface of the roller by a blade member or the like after scraping excessive ink by the roller. In this case, the scraping of the excessive ink containing the residue can cause the residue to remain on the blade member, thereby interfering with the operation of the roller. Besides the occurrence of the residue, it is also conceivable that the contact between the dots of ink being cured and the flattening means can cause, for example, unnecessary vibration (chatter vibration), thereby affecting the result of the flattening.

In this regard, the inventor of the present application has conducted further earnest study and has had thought about a stepwise increase in distance between a platform that supports a three-dimensional object and the inkjet head on a main scanning operation basis in the individual main scanning operations intended to perform flattening when carrying out the formation with the multi-pass method or the like. The earnest study has also found that the stepwise increase makes it difficult to cause the contact between the dots of ink being cured and the flattening means, and consequently prevents, for example, the occurrence of the residue, leading to more appropriate flattening. Furthermore, these characteristic features have been more generalized to specify the configurations of the invention as follows. In other words, the present invention has the following configurations in order to solve the above problems.

(Configuration 1) A forming apparatus for forming a three-dimensional object by additive manufacturing includes: an inkjet head configured to eject ink droplets by inkjet scheme; flattening means for flattening a layer of ink formed by ink ejected from the inkjet head; a platform being a table-shaped member to support the three-dimensional object in a middle of formation and being configured to be disposed at a position opposed to the inkjet head; a first direction scanning driver configured to cause the inkjet head to perform a first direction scanning including movement relative to the platform in a preset first direction while ejecting ink droplets; and a deposition direction driver configured to change a head-to-platform distance being a distance between the inkjet head and the platform by causing at least one of the platform and the inkjet head to move in a deposition direction being orthogonal to the first direction and being a direction in which a plurality of layers are deposited in additive manufacturing. The inkjet head includes an array of nozzles with a plurality of nozzles arranged in a nozzle array direction being nonparallel to the first direction. The first direction scanning driver is configured to cause, in the first direction scanning, the inkjet head to move in at least one direction in the first direction, and configured to cause, in an operation of forming a layer of ink, a plurality of times of the first direction scanning intended to cause the inkjet head to move in the one direction with respect to an identical position of the three-dimensional object in the middle of formation. The flattening means is configured to flatten a layer of ink by moving together with the inkjet head in the first direction scanning in the one direction. The deposition direction driver is configured to increase the head-to-platform distance by an amount of a preset thickness of a layer of ink than before starting formation of the layer of ink whenever the layer of ink is formed, and is configured to increase the head-to-platform distance during the first direction scanning to be performed later, than the head-to-platform distance during the first direction scanning to be performed earlier in each of at least part of a plurality of times of the first direction scanning in the one direction to be performed during the operation of forming the layer of ink.

With this configuration, the head-to-platform distance during the first direction scanning intended to perform flattening of a layer of ink can be increased stepwise in the operation of forming the layer of ink. Therefore, this configuration makes it possible to, for example, appropriately prevent dots of ink formed (cured) during a preceding first direction scanning from coming into contact with the flattening means. Consequently, for example, the occurrence of excessive residue is preventable, leading to more appropriate flattening.

In this case, attachment of the residue to the flattening means is more appropriately preventable by preventing the occurrence of the residue or the like. More specifically, in the case where a roller is used as flattening means, and the blade or the like removes the ink scraped up by the roller, residue may remain on the blade or the like when the roller scrapes up ink containing excessive residue. Therefore, the blade may not appropriately remove ink scraped up later by the roller.

In contrast, this configuration makes it possible to appropriately prevent the attachment of residue to the roller and the blade. It is consequently possible to stabilize processing of the ink without deteriorating a flow of excessive ink recovered by the flattening. It is also possible to appropriately prevent, for example, ink clogging in a recovery channel for ink.

When the dots of ink formed by the preceding main scanning and the flattening means contact with each other, as described above, it is conceivable, for example, that unnecessary vibration (chatter vibration) occurs and affects the result of the flattening. For example, when the roller is used as the flattening means, vibration of the roller can generate unintended irregularities (such as chatter marks) on the surface of the layer of ink after flattening. In contrast, with the above configuration, it is possible to appropriately prevent the occurrence of the irregularities by, for example, preventing the contact between the dots of ink formed by the preceding first direction scanning and the flattening means.

Also in this case, for example, the surface of the three-dimensional object can be made smooth by gradually increasing the head-to-platform distance for each of the main scanning operations in at least part of the first direction scanning. More specifically, even when the surface of the three-dimensional object has a gentle slope shape, for example, occurrence of outstanding steps in the form of contours is preventable, and it is therefore possible to more appropriately perform the formation that ensures a smooth surface.

In this configuration, the first direction is, for example, a preset main scanning direction. In this case, the first direction scanning is the main scanning operation. The forming apparatus may perform the operation of forming a layer of ink by a multi-pass method. As used herein, the phrase “forming a layer of ink by multi-pass method” refers to, for example, causing the inkjet head to perform the main scanning operation a plurality of times with respect to an identical position of a three-dimensional object in the middle of formation, in the operation of forming the layer of ink.

The inkjet head ejects, for example, ink droplets of ink being curable according to predetermined conditions. More specifically, UV curable ink, which is curable by irradiation of ultraviolet, is suitably usable as the ink. In this case, the forming apparatus preferably further includes, for example, an UV irradiation part to irradiate UV light.

The flattening means flattens the layer of ink by, for example, removing a part of uncured ink. In this case, it is conceivable to perform flattening in a state in which dots of ink formed by the preceding first direction scanning are already cured, in the first direction scanning intended to perform the flattening. A roller or the like configured to scrape off the uncured ink is suitably usable as the flattening means. In this case, for example, the roller flattens the surface of the ink during the operation of forming a layer of ink. As used herein, the phrase “fattening the layer of ink” may be, for example, removing ink lying on a portion beyond the thickness being preset as the thickness of the layer of ink.

Alternatively, in this configuration, the first direction may be a direction orthogonal to the direction of the array of nozzles. It is also conceivable that the first direction is a direction intersecting the direction of the array of nozzle at an angle other than right angles. The deposition direction is, for example, a direction orthogonal to the first direction and the nozzle array direction.

(Configuration 2) The deposition direction driver is configured to differentiate the head-to-platform distance, in between at least part of the plurality of times of the first direction scanning, by a distance smaller than the preset thickness of the layer of ink.

With this configuration, the head-to-platform distance differentiated between the first direction scanning in one direction can be made smaller than a distance over which the inkjet head or the platform is moved in the deposition direction after forming the layer of ink. Consequently, for example, the head-to-platform distance is more appropriately changeable within a possible range for flattening.

In this case, it is preferable to bring a difference of the head-to-platform distance into a distance smaller than the preset thickness of a layer of ink, in between the first direction scanning performed first and the first direction scanning performed finally of a plurality of times of the first direction scanning in one direction which are performed during the operation of forming the layer of ink. With this configuration, for example, the head-to-platform distance is more appropriately changeable.

(Configuration 3) The flattening means is a roller to flatten a layer of ink by coming into contact with a surface of the layer of ink.

With this configuration, for example, the flattening of the layer of ink is more appropriately performable.

(Configuration 4) This is configured so as to further include a second direction scanning driver configured to cause the inkjet head to move relative to the platform in a second direction orthogonal to the first direction. The first direction scanning driver causes the inkjet head to perform the first direction scanning corresponding to a plurality of preset number of passes with respect to individual positions of the layer of ink in the operation of forming the layer of ink. The second direction scanning driver causes the inkjet head to move relative to the platform in the second direction by an amount of a pass width that is a width obtained by dividing a length of the array of nozzles in the second direction by the number of passes, whenever a preset number of times of the first direction scanning are performed in the operation of forming the layer of ink.

With this configuration, it is possible to cause the inkjet head to appropriately perform the main scanning operation by, for example, a method in which the first direction is the main scanning direction, and a feed rate of the inkjet head toward the second direction is set to a predetermined pass width (a large pitch pass method).

By performing, between the main scanning operations, the operation of causing the inkjet head to move relative to the platform in the second direction, the three-dimensional object is appropriately formable by driving the inkjet head in serial mode, for example, even when the width of a three-dimensional object in the second direction is larger than the length of the array of nozzles of the inkjet head.

Also in this case, by increasing the head-to-platform distance whenever at least a part of the first direction scanning is carried out, the formation by the multi-pass method is appropriately performable while appropriately performing flattening. Consequently, for example, the three-dimensional object is more appropriately formable with high precision.

In this configuration, the second direction may be a sub-scanning direction orthogonal to the main scanning direction. The second direction scanning driver may cause the inkjet head to move relative to the platform in the second direction by an amount of a pass width, for example, whenever the first direction scanning is carried out once. The pass width may be a width substantially equal to a width obtained by dividing the length of the array of nozzles by the number of passes.

(Configuration 5) This is configured so as to further include a second direction scanning driver configured to cause the inkjet head to move relative to the platform in a second direction orthogonal to the first direction. The first direction scanning driver causes the inkjet head to perform the first direction scanning corresponding to a plurality of preset number of passes with respect to individual positions of the layer of ink in the operation of forming the layer of ink. The second direction scanning driver causes the inkjet head to move relative to the platform in the second direction by a second direction movement distance that is a distance smaller than a width obtained by dividing the length of the array of nozzles in the second direction by the number of passes, whenever a preset number of times of the first direction scanning are performed in the operation of forming the layer of ink. The second direction movement is a distance obtained by adding an integer multiple of a nozzle pitch second direction component that is a distance between the nozzles adjacent to each other in the array of nozzles in the second direction, and a distance less than the nozzle pitch second direction component.

Here, the second direction scanning driver may cause the inkjet head to move by this distance relative to the platform in the second direction, for example, whenever the first direction scanning is carried out once.

The term “integer multiple of a nozzle pitch second direction component” refers to, for example, a product of the nozzle pitch second direction component and an integer of zero or more.

With this configuration, it is possible to cause the inkjet head to appropriately perform the main scanning operation by, for example, a method in which the first direction is the main scanning direction, and a feed rate of the inkjet head toward the second direction is set to a small distance (a small pitch pass method). Consequently, for example, compared with the case of performing formation by the large pitch pass method, the number of times of the necessary main scanning operations can be decreased to reduce formation time.

In this case, in association of the plurality of times of the first direction scanning (the main scanning operations) carried on the identical position of the three-dimensional object in the middle of formation, a position in the second direction is shifted by a distance smaller than the nozzle pitch second direction component, instead of only the integer multiple of the nozzle pitch second direction component. Thereby, in terms of a resolution in the second direction, a high resolution corresponding to the distance smaller than the nozzle pitch second direction component is achievable. Therefore, this configuration makes it possible to, for example, appropriately perform the formation of the three-dimensional object at high resolution.

In this case, for example, when a width of a three-dimensional object formed in the second direction is smaller than the length of the array of nozzles, it is conceivable to simultaneously eject ink droplets from nozzle holes over a full width of the three-dimensional object. With this configuration, the formation by the multi-pass can be appropriately carried out, for example, in the same manner as in the case of using a line-type inkjet head.

Alternatively, the width of the three-dimensional object in the second direction may be made larger than the length of the array of nozzle of the inkjet head. In this case, it is conceivable, for example, that after the main scanning operations corresponding to the number of passes are carried out on a region corresponding to the length of the array of nozzles, the inkjet head is moved relative to the platform in the second direction by a distance corresponding to the length of the array of nozzles. It is also conceivable that the main scanning operations corresponding to the number of passes are further carried out after the inkjet head is moved in the second direction. With this configuration, even when a three-dimensional object to be formed has a large size, the formation of the three-dimensional object is appropriately performable.

Also in this case, by increasing the head-to-platform distance whenever at least a part of the first direction scanning is carried out, the formation by the multi-pass method is appropriately performable while appropriately performing flattening. Consequently, for example, the three-dimensional object is more appropriately formable with high precision.

(Configuration 6) This is configured so as to further include a second direction scanning driver configured to cause the inkjet head to move relative to the platform in a second direction orthogonal to the first direction. The first direction scanning driver causes the inkjet head to perform the first direction scanning corresponding to a plurality of preset number of passes with respect to individual positions of the layer of ink in the operation of forming the layer of ink. The second direction scanning driver causes the inkjet head to move relative to the platform in the second direction by a distance corresponding to the length of the array of nozzles in the second direction, whenever the first direction scanning is performed once in the operation of forming the layer of ink. The first direction scanning driver causes the inkjet head to perform the first direction scanning for a second time on each position of the layer of ink after the first direction scanning for a first time is carried out over the entirety of a region over which the layer of ink needs to be formed.

With this configuration, it is possible to cause the inkjet head to appropriately perform the main scanning operation by, for example, a method in which the first direction is the main scanning direction, and the main scanning operations in an identical time are carried out sequentially over a full surface of a layer of ink (full-surface sequential pass method). Consequently, for example, compared with the case of performing formation by the large pitch pass method, the number of times of the necessary main scanning operations can be decreased to reduce formation time.

Also in this case, by increasing the head-to-platform distance whenever at least a part of the first direction scanning is carried out, the formation by the multi-pass method is appropriately performable while appropriately performing flattening. Consequently, for example, the three-dimensional object is more appropriately formable with high precision.

In this case, a distance over which the inkjet head is moved in the second direction may be a distance substantially equal to the length of the array of nozzles in the second direction. When the number of passes is three or more, the first direction scanning (the main scanning operation) in each of the third and subsequent times is preferably carried out after the preceding first direction scanning is carried out over the entirety of the layer of ink. With this configuration, the formation by the full-surface sequential pass method is more appropriately performable.

In association with the operation of the second direction scanning driver, the phrase “the inkjet head is moved whenever the main scanning operation in the first direction scanning is carried out once” denotes, for example, that during the operation in which the first direction scanning in an identical time (for example, the first direction scanning for the first time or the first direction scanning for the second time) are carried out on individual positions, the inkjet head is moved in the second direction whenever the first direction scanning in that time is carried out.

Therefore, in timing that the first direction scanning for a certain time (for example, for the first time) is carried out on the entirety of the region, and then the first direction scanning for the subsequent time (for example, for the second time) is started, it is also conceivable not to cause, therebetween, no movement of the inkjet head in the second direction.

(Configuration 7) The first direction scanning driver causes the inkjet head to perform the first direction scanning in the one direction in the first direction, and the first direction scanning in another direction in the first direction. The flattening means flattens a layer of ink only during the first direction scanning in the one direction of the first direction scanning in one direction and the another direction. The deposition direction driver sets the head-to-platform distance to an identical distance in each of a plurality of times of the first direction scanning in the another direction performed during the operation of forming the layer of ink.

With this configuration, the formation of a three-dimensional object is performable in a shorter time by performing the first direction scanning in two directions (both directions) of one (a forward path) and another (a backward path). In this case, the layer of ink can be appropriately and sufficiently flattened by performing flattening during the first direction scanning in one direction. For example, the configuration and control of the forming apparatus can be appropriately simplified by performing no flattening during the first direction scanning in another direction, and by setting the head-to-platform distance to an identical distance.

(Configuration 8) The first direction scanning driver causes the inkjet head to perform the first direction scanning in the one direction in the first direction, and the first direction scanning in another direction in the first direction. The flattening means includes first flattening means for flattening a layer of ink during the first direction scanning in the one direction, and second flattening means for flattening a layer of ink during the first direction scanning in the another direction. The deposition direction driver increases the head-to-platform distance by an amount of a preset thickness of a layer of ink than before starting formation of the layer of ink whenever the layer of ink is formed, and increases the head-to-platform distance during the first direction scanning to be performed later than the head-to-platform distance during the first direction scanning to be performed earlier in each of at least part of a plurality of times of the first direction scanning in the another direction to be performed during the operation of forming the layer of ink.

With this configuration, the formation of a three-dimensional object is performable in a shorter time by performing the first direction scanning in two directions (both directions) of one (a forward path) and another (a backward path). In this case, appropriate flattening is performable during the first direction scanning in either one or another direction by using a plurality of flattening means according to the direction of the first direction scanning.

Furthermore, it is possible to, for example, appropriately prevent the dots of ink formed during the preceding first direction scanning from coming into contact with the flattening means by also further increasing the head-to-platform distance during the subsequent first direction scanning in each of a plurality of times of the first direction scanning in another direction. This leads to, for example, more appropriate flattening.

(Configuration 9) This is configured so as to further include a second direction scanning driver configured to cause the inkjet head to move relative to the platform in a second direction orthogonal to the first direction. The second direction scanning driver causes the inkjet head to move relative to the platform in one direction in the second direction, subsequently to part of the first direction scanning, and causes the inkjet head to move relative to the platform in another direction in the second direction, subsequently to at least another part of the first direction scanning.

With this configuration, the formation of a three-dimensional object is performable in a shorter time by performing the second direction scanning in two directions (both directions) of one (a forward path) and another (a backward path). In this case, the deposition direction driver changes the head-to-platform distance according to, for example, the direction of scanning in the second direction.

More specifically, in this case, it is conceivable to set the change of the head-to-platform distance, for example, so as to have a step shape in opposite directions between when the second direction scanning is one direction and when the second direction scanning is another direction. In the operation of the second direction scanning driver, the operation of causing the inkjet head to move relative to the platform in one direction and another direction may be the second direction scanning (for example, a sub-scanning operation) carried out during the operation of forming a layer of ink.

(Configuration 10) A forming method for forming a three-dimensional object by additive manufacturing uses an inkjet head configured to eject ink droplets by inkjet scheme, flattening means for flattening a layer of ink formed by ink ejected from the inkjet head, and a platform being a table-shaped member to support the three-dimensional object in a middle of formation and being configured to be disposed at a position opposed to the inkjet head. The forming method includes: causing the inkjet head to perform a first direction scanning including movement relative to the platform in a preset first direction while ejecting ink droplets; and changing a head-to-platform distance being a distance between the inkjet head and the platform by causing at least one of the platform and the inkjet head to move in a deposition direction being orthogonal to the first direction and being a direction in which a plurality of layers are deposited in additive manufacturing. The inkjet head includes an array of nozzles with a plurality of nozzles arranged in a nozzle array direction being nonparallel to the first direction. The method includes causing, in the first direction scanning, the inkjet head to move in at least one direction in the first direction; causing, in an operation of forming a layer of ink, a plurality of times of the first direction scanning intended to cause the inkjet head to move in the one direction with respect to an identical position of the three-dimensional object in the middle of formation. The flattening means is configured to flatten a layer of ink by moving together with the inkjet head in the first direction scanning in the one direction. The forming method includes increasing the head-to-platform distance by an amount of a preset thickness of a layer of ink than before starting formation of the layer of ink whenever the layer of ink is formed, and increasing the head-to-platform distance during the first direction scanning to be performed later than the head-to-platform distance during the first direction scanning to be performed earlier in each of at least part of a plurality of times of the first direction scanning in the one direction to be performed during the operation of forming the layer of ink.

With this configuration, it is possible to obtain the effect similar to that of Configuration 1.

(Configuration 11) A forming apparatus for forming a three-dimensional object by additive manufacturing includes: an inkjet head configured to eject ink droplets by inkjet scheme; flattening means for flattening a layer of ink formed by ink ejected from the inkjet head; a platform being a table-shaped member to support the three-dimensional object in a middle of formation and being configured to be disposed at a position opposed to the inkjet head; a first direction scanning driver configured to cause the inkjet head to perform a first direction scanning including movement relative to the platform in a preset first direction while ejecting ink droplets; and a deposition direction driver configured to change a head-to-platform distance being a distance between the inkjet head and the platform by causing at least one of the platform and the inkjet head to move in a deposition direction being orthogonal to the first direction and being a direction in which a plurality of layers are deposited in additive manufacturing. The inkjet head includes an array of nozzles with a plurality of nozzles arranged in a nozzle array direction being nonparallel to the first direction. The first direction scanning driver is configured to cause, in the first direction scanning, the inkjet head to move in at least one direction in the first direction, and is configured to cause, in an operation of forming a layer of ink, a plurality of times of the first direction scanning intended to cause the inkjet head to move in the one direction with respect to an identical position of the three-dimensional object in the middle of formation. The flattening means is configured to flatten a layer of ink by moving together with the inkjet head in the first direction scanning in the one direction. The deposition direction driver is configured to increase the head-to-platform distance by an amount of a preset thickness of a layer of ink than before starting formation of the layer of ink, whenever the layer of ink is formed, and is configured to differentiate the head-to-platform distance during the first direction scanning to be performed later from the head-to-platform distance during the first direction scanning to be performed earlier in each of at least part of a plurality of times of the first direction scanning in the one direction to be performed during the operation of forming the layer of ink.

With this configuration, for example, the surface of the three-dimensional object to be formed can be made smooth by gradually changing the head-to-platform distance for each of the first direction scanning. More specifically, even when the surface of the three-dimensional object has a gentle slope shape, for example, occurrence of outstanding steps in the form of contours is preventable, and it is therefore possible to more appropriately perform the formation that ensures a smooth surface.

(Configuration 12) A forming method for forming a three-dimensional object by additive manufacturing uses an inkjet head configured to eject ink droplets by inkjet scheme, flattening means for flattening a layer of ink formed by ink ejected from the inkjet head, and a platform being a table-shaped member to support the three-dimensional object in a middle of formation and being configured to be disposed at a position opposed to the inkjet head. The forming method includes: causing the inkjet head to perform a first direction scanning including movement relative to the platform in a preset first direction while ejecting ink droplets; and changing a head-to-platform distance being a distance between the inkjet head and the platform by causing at least one of the platform and the inkjet head to move in a deposition direction being orthogonal to the first direction and being a direction in which a plurality of layers are deposited in additive manufacturing. The inkjet head includes an array of nozzles with a plurality of nozzles arranged in a nozzle array direction being nonparallel to the first direction. The forming method includes causing, in the first direction scanning, the inkjet head to move in at least one direction in the first direction, and causing, in an operation of forming a layer of ink, a plurality of times of the first direction scanning intended to cause the inkjet head to move in the one direction with respect to an identical position of the three-dimensional object in the middle of formation. The flattening means is configured to flatten a layer of ink by moving together with the inkjet head in the first direction scanning in the one direction. The forming method includes increasing the head-to-platform distance by an amount of a preset thickness of a layer of ink than before starting formation of the layer of ink, whenever the layer of ink is formed; and differentiating the head-to-platform distance during the first direction scanning to be performed later from the head-to-platform distance during the first direction scanning to be performed earlier in each of at least part of a plurality of times of the first direction scanning in the one direction to be performed during the operation of forming the layer of ink.

With this configuration, it is possible to obtain, for example, the effect similar to that of Configuration 11.

The inventor of the present application has also conducted further earnest study of a method of reducing formation time. Then, the configuration of the invention of this application capable of reducing formation time has been achieved by focusing on characteristic features peculiar to the case of forming a three-dimensional object by additive manufacturing.

More specifically, when a three-dimensional object is formed by additive manufacturing, each layer of ink is usually formed by an identical or similar operation to that in a printing apparatus (2D printer) that prints a two-dimensional image. In this case, a layer of ink is formed by repeating, for example, the main scanning operation and the sub-scanning operation by the inkjet head.

Here, when printing the two-dimensional image, it is usually necessary to form only a layer of ink. Therefore, the sub-scanning operation is carried out by causing a medium or inkjet head to move in a predetermined one direction. Hence, the direction in which the inkjet head is moved relative to the medium during the sub-scanning operation is usually only the predetermined one direction.

In contrast, when forming a three-dimensional object, a plurality of layers of ink are deposited. The inventor of this application has conceived to differentiate the direction of relative movement of the inkjet head during the sub-scanning operation, for example, for each of layers of ink. The inventor of this application has also conceived that the direction of relative movement of the inkjet head during the sub-scanning operation is set to, for example, two directions (both directions) of one direction and another direction in the operation of forming a layer of ink, depending on a specific operation of forming a layer of ink.

Furthermore, the inventor of this application has conducted specific tests and the like to confirm that a three-dimensional object is appropriately formable even when the direction in which the inkjet head is subjected to relative movement during the sub-scanning operation is set to the two directions (both directions) as described above. Based on these findings, the configurations of the invention are specified in a more generalized manner. In other words, in order to solve the above problems, the present invention has the following configurations.

(Configuration 13) A forming apparatus for forming a three-dimensional object by additive manufacturing includes: an inkjet head configured to eject ink droplets by inkjet scheme; a platform being a table-shaped member to support the three-dimensional object in a middle of formation and being configured to be disposed at a position opposed to the inkjet head; a first direction scanning driver configured to cause the inkjet head to perform a first direction scanning including movement relative to the platform in a preset first direction while ejecting ink droplets; a second direction scanning driver configured to cause the inkjet head to move relative to the platform in a second direction orthogonal to the first direction; and a deposition direction driver configured to change a head-to-platform distance being a distance between the inkjet head and the platform by causing at least one of the platform and the inkjet head to move in a deposition direction being orthogonal to the first direction and being a direction in which a plurality of layers are deposited in additive manufacturing. The second direction scanning driver is configured to cause the inkjet head to move in one direction in the second direction, subsequently to part of the first direction scanning, and configured to cause the inkjet head to move relative to the platform in another direction in the second direction, subsequently to at least another part of the first direction scanning.

With this configuration, layers of ink constituting a three-dimensional object (two-dimensional slice layers) are appropriately formable by, for example, the configuration that the first direction scanning driver causes the inkjet head to perform the first direction scanning and the second direction scanning driver causes the inkjet head to move relative to the platform.

By suitably changing the distance between the inkjet head and the platform by the deposition direction driver, it is possible to deposit a plurality of layers of ink one upon another. Therefore, with this configuration, the three-dimensional object is appropriately formable by additive manufacturing.

In this case, by setting the direction, in which the inkjet head is subjected to relative movement by the second direction scanning driver, not only one direction but also two directions (both directions) of one direction and another direction, it is possible to, for example, eliminate unnecessary time needed for the operation for returning to an initial position in association with the relative movement of the inkjet head in the second direction. This leads to a reduction in time needed for formation.

In this configuration, the first direction is, for example, a preset main scanning direction. In this case, the first direction scanning is the main scanning operation. The term “main scanning operation” refers to, for example, an operation of ejecting ink droplets while moving in the preset main scanning direction. The second direction may be the sub-scanning direction orthogonal to the main scanning operation. In the operation of the second direction scanning driver, the operation of causing the inkjet head to move relative to the platform in one direction and another direction may be the second direction scanning performed during the operation of forming a layer of ink (for example, the sub-scanning operation).

The forming apparatus may perform the operation of forming a layer of ink by the multi-pass method. As used herein, the phrase “forming a layer of ink by the multi-pass method” refers to, for example, causing the inkjet head to perform the main scanning operation a plurality of times with respect to an identical position of a three-dimensional object in the middle of formation in the operation of forming a layer of ink. The phrase “causing the inkjet heads to perform the main scanning operation a plurality of times with respect to an identical position” refers to, for example, causing the inkjet head to perform the main scanning operation a plurality of times by interposing therebetween the sub-scanning operation.

The inkjet head may have an array of nozzles with a plurality of nozzle holes arranged side by side in a nozzle array direction nonparallel to the first direction. In this case, the first direction may be, for example, a direction orthogonal to the nozzle array direction. It is also conceivable that the first direction is a direction intersecting the nozzle array direction at an angle other than right angles. The deposition direction is, for example, a direction orthogonal to the first direction and the nozzle array direction. The forming apparatus may include a plurality of inkjet heads.

Alternatively, the first direction scanning driver may cause the inkjet head to perform the first direction scanning in one direction in the first direction (for example, a forward path), and the first direction scanning in another direction in the first direction (for example, a backward path). With this configuration, the formation of a three-dimensional object is performable in a shorter time by performing the first direction, for example, two directions (both directions).

(Configuration 14) The forming apparatus forms a three-dimensional object based on formation data indicating a position at which ink droplets need to be ejected by the inkjet head. The second direction scanning driver causes the inkjet head to move relative to the platform whenever a preset number of times of the first direction scanning are performed. The first direction scanning driver causes the inkjet head to perform a plurality of times of the first direction scanning in an operation of forming a layer of ink. When performing the first direction scanning for at least a first time of the plurality of times of the first direction scanning performed during formation of the layer of ink, a position in the second direction, at which the inkjet head is disposed, is set based on the formation data, according to an end of a position at which ink droplets need to be ejected for forming the layer of ink.

With this configuration, for example, a plurality of times of the first direction scanning is more appropriately performable according to a region over which a layer of ink needs to be formed. Consequently, the number of times of the first direction scanning necessary for forming a layer of ink can be appropriately decreased to reduce formation time.

This configuration is one in which an ejection start position of ink droplets in one direction and another direction in the second direction (for example, a printing start end in the sub-scanning operations in each of predetermined forward path and backward path directions) is aligned with a start end of data corresponding to each of layers of ink (data start end on each of the forward path and the backward path in association with a slice layer).

The phrase “setting a position in the second direction at which the inkjet head is disposed (hereinafter referred to as “a scan initial position”) according to, for example, an end of a position at which ink droplets need to be ejected for forming a layer of ink” refers to, for example, setting the scan initial position, for example, so that the position of the end of the position at which ink droplets need to be ejected falls within a scanning range of the initial first direction scanning.

In this case, it is preferable to, for example, set the scan initial position so as to minimize the number of times of the first direction scanning necessary for forming a layer of ink. More specifically, it is conceivable to, for example, set the scan initial position so that an end of the inkjet head at the scan initial position agrees with the position of the end of the position at which the ink droplets need to be ejected.

As used herein, the term “end of the inkjet head at the scan initial position” denotes an end located on a rear side during movement in the second direction.

Alternatively, the end of the inkjet head at the scan initial position and the position of the end of the position at which ink droplets need to be ejected may agree with each other with a predetermined allowance interposed therebetween.

When the support layer to support a three-dimensional object in the middle of formation is formed around the three-dimensional object, the end of position at which ink droplets need to be ejected is preferably an end when viewed by including a region over which the support layer is formed.

(Configuration 15) The first direction scanning driver causes the inkjet head to perform a plurality of times of the first direction scanning as at least part of the operation of forming the layer of ink, and, in between the plurality of times of the first direction scanning, the second direction scanning driver causes the inkjet head to move relative to the platform by setting a movement direction in the second direction to an identical direction. When performing the first direction scanning for at least a first time of the plurality of times of the first direction scanning performed while a direction of movement in the second direction is being set to an identical direction, a position in the second direction, at which the inkjet head is disposed, is set based on the formation data, according to an end of a position at which ink droplets need to be ejected for forming the layer of ink.

With this configuration, for example, the scan initial position is more appropriately settable. This leads to a reduction in formation time.

(Configuration 16) When an operation of causing the inkjet head to move relative to the platform in the second direction is referred to as a second direction scanning, the second direction scanning driver causes, in between at least part of second direction scanning sequentially performed two times, the inkjet head to temporarily move relative to the platform in a direction opposite to a direction in which the inkjet head is moved relative to the platform in the second direction scanning of a subsequent time of the two times.

When the relative movement of the inkjet head in the second direction is carried out in two directions (both directions), an error can occur in the amount of movement of the inkjet head due to the influence of backlash or the like.

Whereas with this configuration, the backlash can be avoided to appropriately reduce the influence of the backlash or the like by, for example, subjecting the inkjet head to temporal movement in the opposite direction before the relative movement in the second direction scanning. Consequently, even when the relative movement of the inkjet head in the second direction is carried out in two directions (both directions), a three-dimensional object is more appropriately formable with high precision.

The operation of causing the inkjet head to temporarily move in a direction opposite to the direction in which the inkjet head is moved is preferably performed, in timing of switching the direction of the relative movement of the inkjet head, at least before the second direction scanning after the switching.

Alternatively, the operation of causing the inkjet head to temporarily move in a direction opposite to the direction in which the inkjet head is moved may be carried out in the second direction scanning on each time.

(Configuration 17) When an operation of causing the inkjet head to move relative to the platform in the second direction is referred to as a second direction scanning, the second direction scanning driver causes the inkjet head to perform the second direction scanning in one direction intended to cause the inkjet head to move relative to the platform in one direction in the second direction, and the second direction scanning in another direction intended to cause the inkjet head to move relative to the platform in another direction in the second direction. The forming apparatus includes, as the inkjet head, a coloring head being an inkjet head to eject ink droplets for coloring, and a build material head being an inkjet head to eject ink droplets of ink used for formation in a region of the three-dimensional object not subjected to coloring. When performing the first direction scanning interposing therebetween the second direction scanning in the one direction, the first direction driver causes both of the coloring head and the build material head to eject ink droplets. When performing the first direction scanning interposing therebetween the second direction scanning in the another direction, the first direction driver causes only the build material head of the coloring head and the build material head to eject ink droplets.

Here, it is also conceivable that a difference in landing manner of ink droplets can occur depending on the direction of movement when the second direction scanning is carried out in two directions (both directions). Upon occurrence of a difference in landing manner of ink droplets in, for example, coloring ink, influence can occur on an expressed color.

Whereas with this configuration, the precision of landing position of ink droplets for coloring can be appropriately enhanced by causing the coloring head to eject ink droplets only during the first direction scanning while interposing therebetween the second direction scanning in one direction.

By causing the build material head to eject ink droplets in each of the second direction scanning in two directions (both directions), formation time is reducible. Therefore, with this configuration, for example, when forming a three-dimensional object being colored with the coloring ink, formation time is reducible while enhancing the precision of coloring.

(Configuration 18) This is configured so as to further include flattening means for flattening a layer of ink formed by the inkjet head. The inkjet head includes an array of nozzles with a plurality of nozzles arranged in a nozzle array direction being nonparallel to the first direction. The first direction scanning driver is configured to cause, in the first direction scanning, the inkjet head to move in at least one direction in the first direction, and configured to cause, in an operation of forming a layer of ink, a plurality of times of the first direction scanning intended to cause the inkjet head to move in the one direction with respect to an identical position of the three-dimensional object in the middle of formation. The flattening means is configured to flatten a layer of ink by moving together with the inkjet head in the first direction scanning in the one direction. The deposition direction driver is configured to increase the head-to-platform distance by an amount of a preset thickness of a layer of ink than before starting formation of the layer of ink, whenever the layer of ink is formed, and is configured to increase the head-to-platform distance during the first direction scanning to be performed later than the head-to-platform distance during the first direction scanning to be performed earlier in each of at least part of a plurality of times of the first direction scanning in the one direction to be performed during the operation of forming the layer of ink.

With this configuration, compared with the case of not employing the above configuration, a layer of ink is formable with higher precision by, for example, flattening the layer of ink by the flattening means. This leads to formation of a three-dimensional object with higher precision.

(Configuration 19) The first direction scanning driver causes the inkjet head to perform the first direction scanning corresponding to a plurality of preset number of passes with respect to individual positions of the layer of ink in the operation of forming the layer of ink. The second direction scanning driver causes the inkjet head to move relative to the platform in the second direction by an amount of a pass width that is a width obtained by dividing a length of the array of nozzles in the second direction by the number of passes, whenever a preset number of times of the first direction scanning are performed in the operation of forming the layer of ink.

With this configuration, it is possible to cause the inkjet head to appropriately perform the main scanning operation by, for example, a method in which the first direction is the main scanning direction, and a feed rate of the inkjet head toward the second direction is set to a predetermined pass width (a large pitch pass method).

By performing, in between the main scanning operations, the operation of causing the inkjet head to move relative to the platform in the second direction, a three-dimensional object is appropriately formable by driving the inkjet head in serial mode, for example, even when the width of the three-dimensional object is larger than the length of the array of nozzles of the inkjet head in the second direction.

In this configuration, the second direction scanning driver preferably changes the direction of the relative movement of the inkjet head, for example, for each of layers of ink.

For example, when forming two layers of ink deposited one upon another in the deposition direction, the direction of relative movement of the inkjet head during formation of a lower layer of ink is set to one direction in the second direction, the direction of relative movement of the inkjet head during formation of an upper lower layer of ink is preferably another direction in the second direction.

With this configuration, for example, the direction of relative movement of the inkjet head in the second direction is appropriately changeable.

Alternatively, the second direction scanning driver may cause the inkjet head to move relative to the platform in the second direction by an amount of a pass width, for example, whenever the first direction scanning is carried out once. The pass width may also be a width substantially equal to a width obtained by dividing the length of the array of nozzles by the number of passes.

(Configuration 20) The first direction scanning driver causes the inkjet head to perform the first direction scanning corresponding to a plurality of preset number of passes with respect to individual positions of the layer of ink in the operation of forming the layer of ink. The second direction scanning driver causes the inkjet head to move relative to the platform in the second direction by a second direction movement distance that is a distance smaller than a width obtained by dividing the length of the array of nozzles in the second direction by the number of passes, whenever a preset number of times of the first direction scanning are performed in the operation of forming the layer of ink. The second direction movement is a distance obtained by adding an integer multiple of a nozzle pitch second direction component that is a distance between the nozzles adjacent to each other in the array of nozzles in the second direction, and a distance less than the nozzle pitch second direction component.

With this configuration, it is possible to cause the inkjet head to appropriately perform the main scanning operation by, for example, a method in which the first direction is the main scanning direction, and a feed rate of the inkjet head toward the second direction is set to a small distance (a small pitch pass method). Consequently, for example, compared with the case of performing formation by the large pitch pass method, the number of times of the necessary main scanning operations can be decreased to reduce formation time.

In this case, in association of the plurality of times of the first direction scanning (the main scanning operations) carried on the identical position of the three-dimensional object in the middle of formation, a position in the second direction is shifted by a distance smaller than the nozzle pitch second direction component, instead of only the integer multiple of the nozzle pitch second direction component. Thereby, in terms of a resolution in the second direction, a high resolution corresponding to the distance smaller than the nozzle pitch second direction component is achievable. Therefore, this configuration makes it possible to, for example, appropriately perform formation of the three-dimensional object at high resolution.

The term “integer multiple of a nozzle pitch second direction component” refers to, for example, a product of the nozzle pitch second direction component and an integer of zero or more. In this configuration, the second direction scanning driver preferably changes the direction of the relative movement of the inkjet head, for example, for each of layers of ink.

With this configuration, for example, the direction of relative movement of the inkjet head in the second direction is appropriately changeable.

In this case, for example, when a width of a three-dimensional object formed in the second direction is smaller than the length of the array of nozzles, it is conceivable to simultaneously eject ink droplets from the nozzle holes over a full width of the three-dimensional object. With this configuration, the formation by the multi-pass method can be appropriately carried out, for example, in the same manner as in the case of using a line-type inkjet head.

Alternatively, the width of the three-dimensional object in the second direction may be made larger than the length of the array of nozzle of the inkjet head. In this case, it is conceivable, for example, that after the main scanning operation corresponding to the number of passes are carried out on a region corresponding to the length of the array of nozzles, the inkjet head is moved relative to the platform in the second direction by a distance corresponding to the length of the array of nozzles. It is also conceivable that the main scanning operations corresponding to the number of passes are further carried out after the inkjet head is moved. With this configuration, even when a three-dimensional object to be formed has a large size, it is possible to appropriately form the three-dimensional object.

(Configuration 9) This is configured so as to further include a second direction scanning driver configured to cause the inkjet head to move relative to the platform in a second direction orthogonal to the first direction. The first direction scanning driver causes the inkjet head to perform the first direction scanning corresponding to a plurality of preset number of passes with respect to individual positions of the layer of ink in the operation of forming the layer of ink. The second direction scanning driver causes the inkjet head to move relative to the platform in the second direction by an amount of a pass width that is a width obtained by dividing a length of the array of nozzles in the second direction by the number of passes, whenever a preset number of times of the first direction scanning are performed in the operation of forming the layer of ink. The first direction scanning driver causes the inkjet head to perform the first direction scanning for a second time on each position of the layer of ink after the first direction scanning for a first time is carried out over the entirety of a region over which the layer of ink needs to be formed.

With this configuration, it is possible to cause the inkjet head to appropriately perform the main scanning operation by, for example, a method in which the first direction is the main scanning direction, and the main scanning operations on an identical time are carried out sequentially over a full surface of a layer of ink (a full-surface sequential pass method). Consequently, for example, compared with the case of performing formation by the large pitch pass method, the number of times of the necessary main scanning operations can be decreased to reduce formation time.

In this configuration, the second direction scanning driver preferably changes the direction of movement of the inkjet head, for example, whenever the first direction scanning on an identical time are carried out on a full surface of a region over which a layer of ink needs to be formed (on a pass-by-pass basis). With this configuration, for example, the direction of relative movement of the inkjet head in the second direction is appropriately changeable.

The distance over which the inkjet head is moved in the second direction may be a distance substantially equal to the length of the array of nozzles in the second direction. When the number of passes is three or more, the first direction scanning (the main scanning operation) on each of the third and subsequent times is preferably carried out after the preceding first direction scanning is carried out over the entirety of the layer of ink. With this configuration, the formation by the full-surface sequential pass method is more appropriately performable.

In association with the operation of the second direction scanning driver, the phrase “the inkjet head is moved whenever the main scanning operation in the first direction scanning is carried out once” denotes that during the operation in which the first direction scanning on an identical time (for example, the first direction scanning for the first time or the first direction scanning for the second time) are performed on individual positions, the inkjet head is moved whenever the first direction scanning in that time is carried out. Therefore, in timing that the first direction scanning for a certain time (for example, for the first time) are carried out on the entirety of the region, and then the first direction scanning for the subsequent time (for example, for the second time) is started, it is also conceivable to cause, therebetween, no movement of the inkjet head in the second direction.

(Configuration 10) A forming method for forming a three-dimensional object by additive manufacturing uses an inkjet head configured to eject ink droplets by inkjet scheme, and a platform being a table-shaped member to support the three-dimensional object in a middle of formation and being configured to be disposed at a position opposed to the inkjet head. The forming method includes: causing the inkjet head to perform a first direction scanning including movement relative to the platform in a preset first direction while ejecting ink droplets; causing the inkjet head to move relative to the platform in a second direction orthogonal to the first direction; changing a distance between the inkjet head and the platform by causing at least one of the platform and the inkjet head to move in a deposition direction being orthogonal to the first direction and being a direction in which a plurality of layers are deposited in additive manufacturing; causing the inkjet head to move relative to the platform in one direction in the second direction, subsequently to part of the first direction scanning, and causing the inkjet head to move relative to the platform in another direction in the second direction, subsequently to at least another part of the first direction scanning.

With this configuration, it is possible to obtain, for example, the effect similar to that of Configuration 1.

### Effects of the Invention

With the present invention, it is, for example, possible to more appropriately flatten the layer of ink when forming a three-dimensional object.

With the present invention, it is, for example, also possible to appropriately reduce formation time for the three-dimensional object.

### BRIEF DESCRIPTION OF THE DRAWINGS

FIG. 1 is a diagram that shows an embodiment of a forming apparatus 10 according to an embodiment of the present invention. More specifically, FIG. 1(a) shows an embodiment of a configuration of a main part of the forming apparatus 10. FIG. 1(b) shows an embodiment of a more detailed configuration of an ejection unit 12.

FIG. 2 is a diagram that shows an embodiment of an operation of forming a three-dimensional object 50 in this embodiment. More specifically, FIG. 2(a) shows an embodiment of an operation of forming a layer of ink constituting the three-dimensional object 50. FIG. 2(b) shows an embodiment of arrangement of dots of ink formed by an individual main scanning operation with respect to an identical region.

FIG. 3 is a diagram that describes scanning in a deposition direction which has been carried out in a forming apparatus having a conventional configuration. More specifically, FIG. 3(a) shows an embodiment of the scanning in the deposition direction. FIG. 3(b) shows another embodiment of the scanning in the deposition direction.

FIG. 4 is a diagram that describes a problem generated by an operation of flattening. More specifically, FIG. 4(a) shows, in simplified form, a situation during flattening of an (n+1)th layer of ink ((n+1)th layer). FIG. 4(b) is a diagram that describes influences of various variations.

FIG. 5 is a diagram that describes scanning in the deposition direction which is carried out in the forming apparatus 10 of this embodiment. More specifically. FIG. 5(a) shows an embodiment of the scanning in the deposition direction. FIG. 5(b) shows another embodiment of the scanning in the deposition direction.

FIG. 6 is a diagram that shows an embodiment of an operation of forming a layer of ink. More specifically, FIGS. 6(a) to 6(d) show, in simplified form, a situation during first to fourth main scanning operations (1-pass printing to 4-pass printing) performed on an identical position in an operation of forming the (n+1)th layer.

FIG. 7 is a diagram that describes a state of a dot of ink formed in this embodiment. More specifically, FIG. 7(a) shows an example of a state of a dot of ink when a layer of ink is formed with a conventional method. FIG. 7(b) is an example of a state of a dot of ink when a layer of ink is formed with the configuration of this embodiment.

FIG. 8 shows an embodiment of a more specific configuration of a flattening roller unit 222. More specifically, FIG. 8(a) shows an embodiment of the configuration of the flattening roller unit 222. FIG. 8(b) shows another embodiment of the configuration of the flattening roller unit 222. FIG. 8(c) shows still another embodiment of the configuration of the flattening roller unit 222.

FIG. 9 is a diagram that describes a modification of the configuration and operation of the forming apparatus 10. More specifically, FIG. 9(a) shows an embodiment of an operation in the case where flattening is carried out during the main scanning operation in one direction and another direction. FIG. 9(b) shows an embodiment of the configuration of the ejection unit 12 used in this case.

FIG. 10 is a diagram that describes a variety of methods for performing an operation of a multi-pass method. More specifically; FIG. 10(a) shows an embodiment of a configuration of an inkjet head 200 used for forming an object. FIG. 10(b) shows an embodiment of an operation of forming a layer of ink by a multi-pass method of a large pitch pass method.

FIG. 11 is a diagram that describes a variety of methods for performing an operation of a multi-pass method. More specifically; FIG. 11(a) shows an embodiment of an operation of forming a layer of ink by the multi-pass method that is a small-pitch pass method. FIG. 11(b) shows an embodiment of an operation of forming a layer of ink by the multi-pass method that is a full-surface sequential pass method.

FIG. 12 is a diagram that describes another modification of the configuration and operation of the forming apparatus 10. More specifically, FIG. 12(a) shows an embodiment of the configuration of the inkjet head 200 and an embodiment of the configuration of a three-dimensional object 50 to be formed. FIG. 12(b) shows a direction of movement of the inkjet head 200 in a sub-scanning operation performed after the main scanning operations on each time when forming a layer of ink by the large-pitch pass method.

FIG. 13 is a diagram that describes still another modification of the configuration and operation of the forming apparatus 10. More specifically, FIGS. 13(a) and 13(b) respectively show a direction of movement of the inkjet head 200 in the sub-scanning operation performed after the individual main scanning operations in the case of forming a layer of ink by each of the large-pitch pass method, the small-pitch pass method, and the full-surface sequential pass method.

FIG. 14 is a diagram that describes the operation of the small-pitch pass method in more detail. More specifically, FIG. 14(a) is a diagram that shows an embodiment of the configuration of the inkjet head 200. FIG. 14(b) shows an embodiment of a situation of dots of ink formed by the main scanning operation, and an embodiment of the sub-scanning operation (X scanning) performed between the main scanning operations, in the operation by the small-pitch pass method.

FIG. 15 is a diagram that describes the operation of the small-pitch pass method in more detail.

FIG. 16 shows an embodiment of a situation of dots of ink formed by the main scanning operation performed on individual positions in order to form a layer of ink, and an embodiment of the sub-scanning operation (X scanning) performed between the main scanning operations, in the operation of the full-surface sequential pass method.

FIG. 17 shows an embodiment of a situation of dots of ink formed by the main scanning operation performed on individual positions in order to form a layer of ink, and an embodiment of the sub-scanning operation (X scanning) performed between the main scanning operations, in the operation of the full-surface sequential pass method.

### MODE FOR CARRYING OUT THE INVENTION

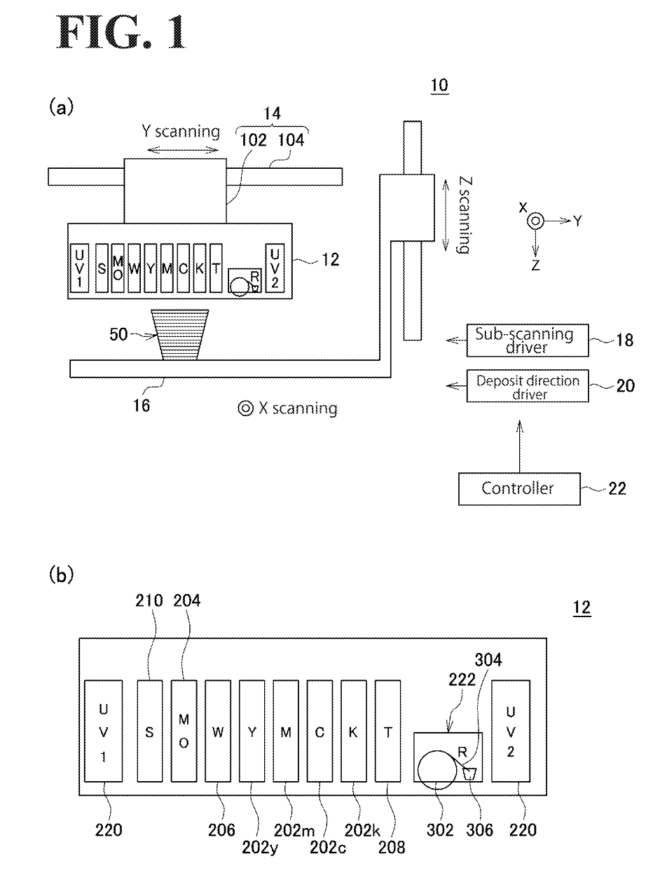

Embodiments according to the present invention are described below while referring to the drawings. FIG. 1 shows an embodiment of a forming apparatus 10 according to an embodiment of the present invention. FIG. 1(a) shows an embodiment of a configuration of a main part of the forming apparatus 10.

In this embodiment, the forming apparatus 10 is an apparatus that forms a three-dimensional object 50 (a three-dimensional forming apparatus) by additive manufacturing. Here, the additive manufacturing is a method of forming the three-dimensional object 50 by, for example, depositing a plurality of layers one upon another. The three-dimensional object 50 denotes, for example, a three-dimensional shaped body.

The forming apparatus 10 may have a configuration identical or similar to that of a well-known forming apparatus, except for points described below.

Alternatively, the forming apparatus 10 may be an apparatus obtainable by changing, for example, a part of the configuration of a well-known inkjet printer. For example, the forming apparatus 10 may be an apparatus obtainable by changing a part of an inkjet printer for two-dimensional image printing using ultraviolet curable ink (UV ink).

Still alternatively, the forming apparatus 10 may further include, besides the illustrated configuration, for example, a variety of configurations necessary for forming, coloring, or the like of the three-dimensional object 50.

In this embodiment, the forming apparatus 10 includes an ejection unit 12, a main scanning driver 14, a platform 16, a sub-scanning driver 18, a deposition direction driver 20, and a controller 22. The ejection unit 12 is a part that ejects liquid droplets (ink droplets) serving as a material of the three-dimensional object 50. A layer of ink is formed by ejection of the ink droplets of ink curable according to a predetermined condition and then curing the ink ejected from the ejection unit 12. The three-dimensional object 50 is formed by depositing a plurality of the layers one upon another.

In this embodiment, for example, UV curable ink, which is curable by irradiation of ultraviolet, is used as ink.

As used herein, the term “ink” refers to, for example, a liquid ejected from the inkjet head.

The inkjet head is, for example, an ejection head that ejects liquid droplets by inkjet scheme.

The ejection unit 12 includes an ultraviolet (UV) light source. By irradiating ultraviolet rays toward the ink from the UV light source, the ink is cured to form the layer of ink.

When forming the three-dimensional object 50, the ejection unit 12 may form a support layer around the three-dimensional object 50. As used herein, the term “support layer” refers to, for example, an additive manufacturing object which supports the three-dimensional object 50 by surrounding an outer periphery of the three-dimensional object 50 in the middle of formation, and which is dissolved and removed with, for example, water after completion of the formation of the three-dimensional object 50. More specific configuration and operation of the ejection unit 12 is described in more detail later.

The main scanning driver 14 is a driver that causes the ejection unit 12 to perform the main scanning operation (Y scanning).

As used herein, the phrase “causing the ejection unit 12 to perform the main scanning operation” refers to, for example, causing the inkjet heads of the ejection unit 12 to perform the main scanning operation.

As used herein, the term “main scanning operation” refers to, for example, an operation of ejecting ink droplets while moving in a preset main scanning direction (Y direction in the diagram).

Also in this embodiment, the main scanning driver 14 is an embodiment of a first direction scanning driver.

As used herein, the term “first scanning driver” refers to, for example, a driver that causes the inkjet head 200 to perform a first direction scanning that includes movement relative to the platform 16 in a preset first direction while ejecting the ink droplets.

In this embodiment, the main scanning driver 14 includes a carriage 102 and a guide rail 104. The carriage 102 is a holder that holds the ejection unit 12 in opposition to the platform 16.

As used herein, the phrase “holding the ejection unit 12 in opposition to the platform 16” refers to, for example, holding the ejection unit 12 so that an ejection direction of the ink droplets is directed toward the platform 16.

During the main scanning operation, the carriage 102 moves along the guide rail 104 while holding the ejection unit 12. The guide rail 104 is a rail-shape member to guide movement of the carriage 102, and causes the carriage 102 to move according to an instruction from the controller 22 during the main scanning operation.

The movement of the ejection unit 12 in the main scanning operation may be relative movement with respect to the three-dimensional object 50. Therefore, in a modification of the configuration of the forming apparatus 10, for example, the position of the ejection unit 12 may be secured, while the three-dimensional object 50 may be moved by, for example, moving the platform 16.

The platform 16 is a table-shaped member to support the three-dimensional object 50 in the middle of formation. The platform 16 is disposed at a position opposed to the inkjet head in the ejection unit 12, and is configured to mount the three-dimensional object 50 on an upper surface of the platform 16.

In this embodiment, the platform 16 has such a configuration that at least the upper surface is movable in a vertical direction (Z direction in the diagram), and the upper surface is moved vertically along with the progress of forming of the three-dimensional object 50 by being driven by the deposition direction driver 20.

This suitably changes a head-to-platform distance that is a distance between the inkjet head and the platform 16 in the ejection unit 12, thereby adjusting a distance (gap) between a target surface in the three-dimensional object 50 in the middle of formation and the ejection unit 12.

As used herein, the term “head-to-platform distance” may be more specifically, for example, a distance between a nozzle surface provided with a nozzle hole in the inkjet head, and the upper surface of the platform 16.

As used herein, the term “target surface of the three-dimensional object 50” refers to, for example, a surface on which a subsequent layer of ink is formed by ink ejected from the ejection unit 12.

The sub-scanning driver 18 is a driver that causes the ejection unit 12 to perform the sub-scanning operation (X scanning).

As used herein, the phrase “causing the ejection unit 12 to perform the sub-scanning operation” refers to, for example, causing the inkjet head of the ejection unit 12 to perform the sub-scanning operation.

Also as used herein, the term “sub-scanning operation” refers to, for example, an operation of moving relative to the platform 16 in the sub-scanning direction (X direction in the diagram).

In this embodiment, the sub-scanning driver 18 is an embodiment of a second direction scanning driver.

As used herein, the term “second direction scanning driver” refers to, for example, a driver that causes the inkjet head to move relative to the platform 16 in a second direction orthogonal to the first direction.

More specifically, the sub-scanning driver 18 causes the inkjet head to perform the sub-scanning operation by, for example, causing the platform 16 to move while securing the position of the ejection unit 12 in the sub-scanning direction.

Alternatively, the sub-scanning driver 18 may cause the inkjet head to perform the sub-scanning operation by causing the ejection unit 12 to move while securing the position of the platform 16 in the sub-scanning direction.

The deposition direction driver 20 is a driver that causes at least one of the ejection unit 12 and the platform 16 to move in the deposition direction (Z direction in the diagram) being orthogonal to the main scanning direction and the sub-scanning direction. As used herein, the term “deposition direction” refers to, for example, a direction in which a plurality of layers are deposited one upon another in the additive manufacturing. The phrase “causing the ejection unit 12 to move in the deposition direction” refers to, for example, causing the inkjet head of the ejection unit 12 to move in the deposition direction.

The phrase “causing the platform 16 in the deposition direction” refers to, for example, causing the position of at least the upper surface of the platform 16 to move.

The deposition direction driver 20 causes the inkjet head to perform scanning in Z direction (Z scanning) by causing at least one of the ejection unit 12 and the platform 16 to move in the deposition direction, thereby changing the head-to-platform distance.

More specifically, in the configuration shown in the diagram, the deposition direction driver 20 causes, for example, the platform 16 to move while securing the position of the ejection unit 12 in the deposition direction.

Alternatively, the deposition direction driver 20 may cause the ejection unit 12 to move while securing the position of the platform 16 in the deposition direction.

The controller 22 is, for example, a CPU (Central Processing Unit) of the forming apparatus 10. The controller 22 controls the operation of forming the three-dimensional object 50 by controlling individual components of the forming apparatus 10.

The controller 22 preferably controls the components of the forming apparatus 10 based on, for example, shape information and color image information associated with the three-dimensional object 50 to be formed.

Specific operations of forming the three-dimensional object 50 are described in more detail later.

More specific configuration and operation of the ejection unit 12 are described below.

FIG. 1(b) shows an embodiment of the more specific configuration of the ejection unit 12.

In this embodiment, the ejection unit 12 includes a plurality of color ink heads 202y, 202m, 202c, and 202k (hereinafter referred to as color ink heads 202y to 202k), a build material head 204, a white ink head 206, a clear ink head 208, a support material head 210, a plurality of UV light sources 220, and a flattening roller unit 222.

The color ink heads 202y to 202k, the build material head 204, the white ink head 206, the clear ink head 208, and the support material head 210 are inkjet heads that eject ink droplets by the inkjet scheme.

Also in this embodiment, the color ink heads 202y to 202k, the build material head 204, the white ink head 206, the clear ink head 208, and the support material head 210 are inkjet heads that eject, for example, ink droplets of UV curable ink, and are disposed side by side in the main scanning direction (Y direction) while being aligned in the sub-scanning direction (X direction).

As the color ink heads 202y to 202k, the build material head 204, the white ink head 206, the clear ink head 208, and the support material head 210, for example, well-known inkjet heads are suitably usable.

Each of these inkjet heads has, on a surface thereof opposed to the platform 16, an array of nozzles having a plurality of nozzle holes arranged in the sub-scanning direction.

Thus, each of the inkjet heads is configured to eject ink droplets from the nozzle holes toward the platform 16.

The direction of the array of nozzles having the nozzle holes arranged side by side is a direction orthogonal to the main scanning direction.

In a modification of the configuration of the inkjet heads, it is conceivable to employ, for example, such a configuration that the main scanning direction and the direction of the array of nozzles cross at an angle other than right angles.

Arrangement of the color ink heads 202y to 202k, the build material head 204, the white ink head 206, the clear ink head 208, and the support material head 210 is not limited to the illustrated configuration, and may be changed variously.

For example, some of the inkjet heads may be displacedly arranged in the sub-scanning direction with respect to other inkjet heads.

The ejection unit 12 may further include, for example, inkjet heads for lighter variations of the above colors and inkjet heads for R (red), G (green), B (blue), and orange.

The color ink heads 202y to 202k are inkjet heads that respectively eject ink droplets of color inks being different in color.

In this embodiment, the color ink heads 202y to 202k eject ink droplets of UV curable inks respectively having colors of Y (Yellow), M (Magenta), C (Cyan), and K (Black).

The build material head 204 is an inkjet head to eject ink droplet of ink used for forming an interior of the three-dimensional object 50.

In this embodiment, the build material head 204 ejects ink droplets of a forming ink (model material MO) of a predetermined color.

The forming ink may be, for example, an ink intended for formation. In this embodiment, the forming ink is an ink whose color is different from each of the CMYK inks.

It is also conceivable to use, for example, a white ink or clear ink, as the forming ink.

The white ink head 206 is an inkjet head to eject ink droplets of a white (W) ink.

The clear ink head 208 is an inkjet head to eject ink droplets of a clear ink. As used herein, the term “clear ink” refers to an ink of a clear color that is a transparent color (T).

The support material head 210 is an inkjet head to eject ink droplets containing a material of the support layer.

In this embodiment, it is preferable to use, as a material of the support layer, a water-soluble material that is soluble in water after forming the three-dimensional object 50.

Also in this case, because the material is one which is removed after the formation, it is preferable to use an easily decomposable material whose curing degree due to UV light is lower than that of the materials constituting the three-dimensional object 50.

Alternatively, for example, a well-known material for a support layer is suitably usable as a material of the support layer.

The plurality of UV light sources 220 are an embodiment of a UV irradiation part, and generate ultraviolet light that causes the UV curable ink to be cured. As the UV light source 220, for example, UVLEDs (Ultra Violet Light-Emitting Diodes are suitable usable. It is also conceivable to use, for example, metal halide lamps or mercury lamps as the UV light sources 220.

Also in this embodiment, the UV light sources 220 are respectively disposed at one end and another end of the ejection unit 12 in the main scanning direction so as to interpose therebetween the color ink heads 202y to 202k, the build material head 204, the white ink head 206, the clear ink head 208, and the support material head 210.

More specifically, for example, one of the UV light sources 220 is disposed at one end of the ejection unit 12 as indicated with an alphanumeric character UV1 in the diagram.

One of the UV light sources 220, which is indicated with an alphanumeric character UV2 in the diagram, is also disposed at another end of the ejection unit 12.

The flattening roller unit 222 is a configuration for flattening a layer of the UV curable ink to be formed during formation of the three-dimensional object 50.

In this embodiment, the flattening roller unit 222 is disposed between the UV light source 220 (UV2) on the another end and the array of the color ink heads 202y to 202k, the build material head 204, the white ink head 206, the clear ink head 208, and the support material head 210.

Thus, the flattening roller units 222 are arranged side by side in the main scanning direction while being aligned in the sub-scanning direction with respect to the array of the color ink heads 202y to 202k, the build material head 204, the white ink head 206, the clear ink head 208, and the support material head 210.

Also in this embodiment, the flattening roller unit 222 includes a flattening roller 302, a blade 304, and an ink recovery part 306.

The flattening roller 302 is one embodiment of flattening means for flattening a layer of ink formed by the inkjet heads. For example, the flattening roller 302 flattens the layer of ink by, for example, a contact between an outer peripheral surface of the flattening roller 302 and the surface of the layer of ink during the main scanning operation.

The blade 304 is a blade member that tears off the ink scraped off by the flattening roller 302 from the flattening roller 302.

The ink recovery part 306 is a recovery part that recovers the ink torn off from the flattening roller 302 by the blade 304.

With the foregoing configurations, the ejection unit 12 performs the operation of forming the three-dimensional object 50 according to an instruction from the controller 22. The flattening roller unit 222 flattens the layer of ink during the operation of formation.

The operation of flattening the layer of ink and a more specific configuration of the flattening roller unit 222 are described in more detail later.

Subsequently, a more specific operation of forming the three-dimensional object 50, the operation of flattening the layer of ink, and the like are described in more detail below.

Firstly, an embodiment of the more specific operation of forming the three-dimensional object 50 is described.

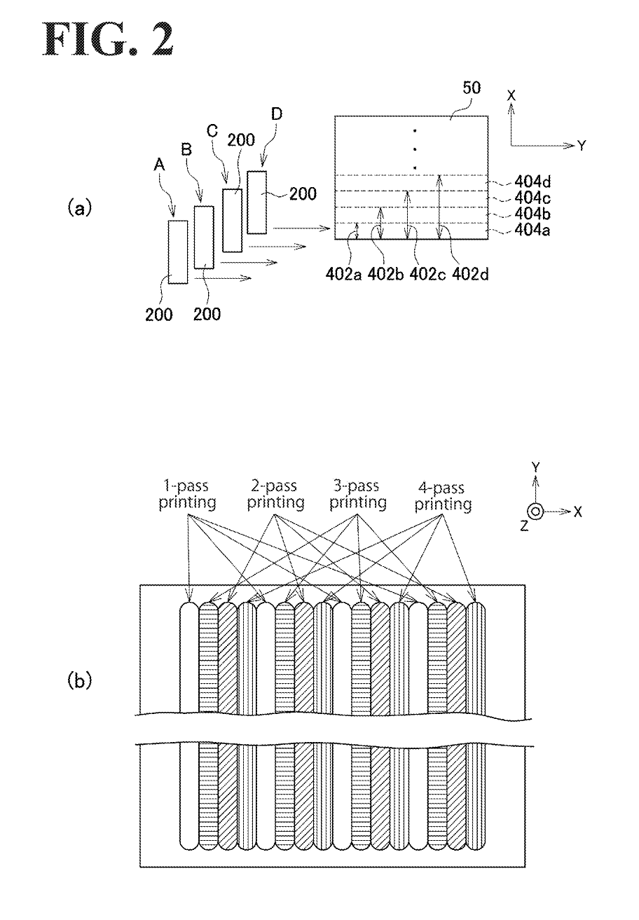

FIG. 2 shows an embodiment of the operation of forming the three-dimensional object 50 in this embodiment. In this embodiment, the forming apparatus 10 performs formation of the three-dimensional object 50 by the multi-pass method. As used herein, the phrase “performs formation by the multi-pass method” refers to, for example, performing formation of individual layers of ink constituting the three-dimensional object 50 by the multi-pass method. The phrase “forming the individual layers of ink by the multi-pass method” refers to, for example, causing the inkjet heads to perform the main scanning operation a plurality of times with respect to an identical position of the three-dimensional object 50 in the middle of formation in the operation of forming a layer of ink.

The phrase “the inkjet heads to perform the main scanning operation a plurality of times with respect to an identical position of the three-dimensional object 50 in the middle of formation” refers to, for example, causing the inkjet heads to perform the main scanning operation a plurality of times by interposing therebetween the sub-scanning operation.

More specifically, as a method of forming a layer of ink by the multi-pass method, it is conceivable to perform in an identical or similar manner when printing is carried out by the multi-pass method in a printing apparatus (2D printer) that prints two-dimensional images.

When forming a three-dimensional object by the forming apparatus 10, a variety of other methods seem to be usable as a specific method of forming a layer of ink by the multi-pass method.

For convenience of description, firstly, when the operation of multi-pass method is carried out by a method in which a feed rate in the sub-scanning operation is set to a predetermined pass width (a large pitch pass method) is described below.

As used herein, the term “feed rate in the sub-scanning operation” refers to an amount of relative movement of the inkjet heads (the color ink heads 202y to 202k, and the like) with respect to the platform 16 (refer to FIG. 1) in the single sub-scanning operation.

The operation of the multi-pass method other than the large pitch pass method is described in detail later.

FIG. 2(a) shows an embodiment of the operation of forming the layers of ink constituting the three-dimensional object 50.

In FIG. 2(a), for convenience of illustration, the inkjet head corresponding to any one of the plurality of inkjet heads (the color ink heads 202y to 202k, the build material head 204, the white ink head 206, the clear ink head 208, and the support material head 210) in the ejection unit 12 (refer to FIG. 1) is illustrated as the inkjet head 200.

Although not illustrated, the other inkjet heads in the ejection unit 12 perform the main scanning operation, the sub-scanning operation, and the like by moving relative to the platform 16 together with the inkjet head illustrated as the inkjet head 200.

When forming the layers of ink by the large pitch pass method, in the operation of forming a layer of ink, the main scanning driver 14 (refer to FIG. 1) causes the inkjet head 200 to perform the main scanning operation corresponding to a plurality of preset number of passes with respect to individual positions of the layer of ink.

The sub-scanning driver 18 (refer to FIG. 1) causes the inkjet head 200 to move relative to the platform 16 by an amount of a predetermined pass width whenever a preset number of times of the main scanning operations are performed.

In this case, the pass width is set to a width obtainable by dividing the length of the array of nozzles in the sub-scanning direction by the number of passes.

As used herein, the term “length of the array of nozzles” refers to, for example, the length of the array of nozzles in the inkjet head 200 that performs the sub-scanning operation.

FIG. 2(a) shows an embodiment of the operation of the inkjet head 200 when a layer of ink is formed by the large pitch pass method by setting the number of passes to 4.

In order to further simplify description, illustration is given of the case where only the main scanning operation toward one direction of the main scanning direction (rightward in the diagram) is carried out, and the sub-scanning operation is carried out whenever the single main scanning operation is performed.

In this case, after performing the main scanning operations on each time, the inkjet head 200 is restored to its original position by causing the inkjet head 200 to move in a direction opposite to that during the main scanning operation in the main scanning direction at least before performing the subsequent main scanning operation.

More specifically, in this case, for example, after the position of the inkjet head 200 in the sub-scanning direction is moved to the position indicated by the alphabetic character A, the main scanning operation is carried out on a range indicated by the arrow 402a in the three-dimensional object 50, so that the first main scanning operation is carried out on a region 404a in the diagram.

Subsequently, after the sub-scanning operation is carried out and the position of the inkjet head 200 in the sub-scanning direction is moved to a position indicated by the alphabetic character B, the main-scanning operation is carried out on a region indicated by the arrow 402b in the three-dimensional object 50, so that the second main scanning operation on a region 404a in the diagram and the first main scanning operation on the region 404b are carried out.

Subsequently, after the sub-scanning operation is carried out and the position of the inkjet head 200 in the sub-scanning direction is moved to a position indicated by the alphabetic character C, the main scanning operation is carried out on a region indicated by the arrow 402c in the three-dimensional object 50, so that the third main scanning operation on the region 404a, the second main scanning operation on the region 404b, and the first main scanning operation on a region 404c are carried out.

Subsequently, after the position of the inkjet head 200 in the sub-scanning direction is moved to a position indicated by the alphabetic character D, the main scanning operation is carried out on a range indicated by the arrow 402d in the three-dimensional object 50, so that the fourth main scanning operation on the region 404a, the third main scanning operation on the region 404b, the second main scanning operation on the region 404c, the second main scanning operation on the region 404c, and the first main scanning operation on a region 404d are carried out.

The four main scanning operations on the region 404a are completed to form a layer of ink having a preset thickness by the foregoing operations. A layer of ink having the same thickness is formable in each of the other regions by repeating the subsequent main scanning operation and sub-scanning operation in the same manner.

With the above configuration, it is possible to, for example, appropriately perform formation of the three-dimensional object 50 by the multi-pass method. In this case, for example, even when the width of the three-dimensional object 50 in the sub-scanning direction is larger than the length of the array of nozzles, the three-dimensional object 50 is appropriately formable by driving the inkjet head 200 in serial mode.

In this configuration, the pass width is not limited to the case where the pass width is strictly the same as the width obtained by dividing the length of the array of nozzles by the number of passes, and the pass width may be a width substantially equal to the width obtained by dividing the length of the array of nozzles by the number of passes.

As used herein, the term “be a width substantially equal to” refers to, for example, that the pass width is equal to the width obtained by dividing the length of the array of nozzles by the number of passes, except for adjustment set by taking into consideration operational convenience, a variety of design intents, and the like, as well as an allowable error.

More specifically, for example, when landing positions of ink droplets in the sub-scanning direction are shifted within a range of less than a nozzle pitch in association with the main scanning operations on each time with respect to the identical position of the three-dimensional object 50 in the middle of formation, it is conceivable to set both equal to each other, except for the amount of the shift.

FIG. 2(b) is a diagram that shows an embodiment of an array of dots of ink formed by the main scanning operations on each time with respect to a region (for example, the region 404a), and shows an embodiment of an array of dots of ink when the landing positions of ink droplets in the sub-scanning direction are shifted within the range of less than the nozzle pitch by the main scanning operations on each time.

In the diagram, lines indicated as 1-pass printing denote dots of ink formed side by side in the main scanning direction by the first main scanning operation.

Lines indicated as 2-pass printing denote dots of ink formed side by side in the main scanning direction by the second main scanning operation.

Lines indicated as 3-pass printing denote dots of ink formed side by side in the main scanning direction by the third main scanning operation.

Lines indicated as 4-pass printing denote dots of ink formed side by side in the main scanning direction by the fourth main scanning operation.

With this configuration, for example, a resolution of formation in the sub-scanning direction is settable to a high resolution corresponding to a distance smaller than intervals between nozzle holes (nozzle pitch) in an array of nozzles. This also makes it possible to appropriately perform the formation at the high resolution.

As described earlier with reference to FIG. 1, in this embodiment, the forming apparatus 10 performs scanning in the deposition direction (Z direction) of a layer of ink, besides the main scanning operation and the sub-scanning operation.

More specifically, as scanning in the deposition direction, the deposition direction driver 20 (refer to FIG. 1) changes the position of the upper surface of the platform 16 along the progress of formation of the three-dimensional object 50. The scanning in the deposition direction carried out in this embodiment is described in more detail below.

For convenience of description, the scanning in the deposition direction which has been carried out in a forming apparatus with a conventional configuration is described firstly.

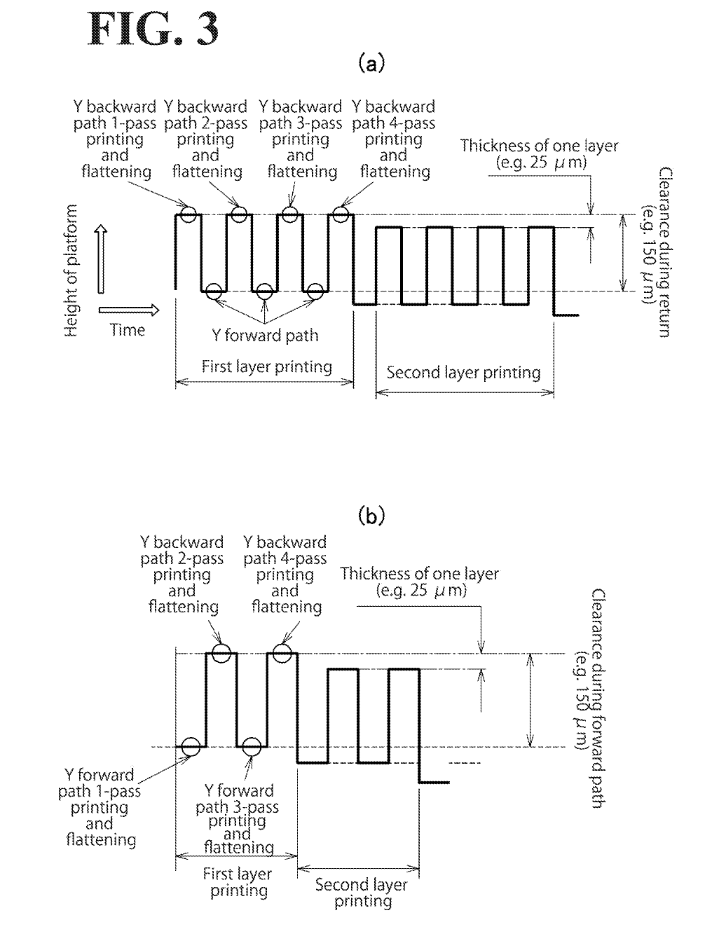

FIG. 3 is a diagram that describes the scanning in the deposition direction which has been carried out in the forming apparatus with the conventional configuration. FIG. 3(a) shows an embodiment of the scanning in the deposition direction.

In the case shown in FIG. 3(a), the main scanning operation is carried out only in one direction in the main scanning direction in the same manner as with the case described with reference to FIG. 2.

More specifically, the main scanning operation is carried out by ejection of ink droplets only on a backward path (Y backward path) in reciprocating movement of the inkjet head 200 in the main scanning direction.

Whereas on a forward path (Y forward path), only movement is carried out without the ejection of ink droplets.

Also in the case of performing scanning in the deposition direction with the conventional method, it is conceivable to use the ejection unit 12 having an identical or similar configuration to that described with reference to FIG. 1.

In this case, as described with reference to FIG. 1, the layer of ink is flattened during the main scanning operation by the flattening roller unit 222 in the ejection unit 12 (refer to FIG. 1).

More specifically, in the case shown in FIG. 3(a), the flattening by the flattening roller unit 222 is carried out at the same time as the operation of the main scanning operations (1-pass printing to 4-pass printing) on each time.

The height of the platform 16 during the main scanning operations on each time is set to the same height in the operation of forming a layer of ink.

As used herein, the term “height of the platform 16” denotes the position of the platform 16 relative to the inkjet head 200 in the deposition direction. Therefore, in this case, the main scanning operation and the flattening of the layer of ink are carried out in a state in which the distance between the inkjet head 200 and the platform 16 remains the same.

In this case, in timing of causing the inkjet head 200 to move without the ejection of ink droplets (Y forward path), the inkjet head 200 is moved in a state in which the distance between the inkjet head 200 and the platform 16 is enlarged (in a state of clearance during return).

With this configuration, it is possible to appropriately avoid any unnecessary contact between the inkjet head 200 and the three-dimensional object 50 in the middle of formation.

In this case, it is also conceivable to form a layer of ink having a thickness of approximately 30 μm by, for example, setting the number of passes to four so as to perform the main scanning operation four times, followed by flattening. In this case, when the thickness of one layer of ink after flattening is set to approximately 25 μm the above-mentioned contact or the like is avoidable by setting an escape distance during return to, for example, approximately 150 μm.

Further in this case, after the formation of the layer of ink is completed (for example, after performing the operation indicated as a first layer printing in the diagram), the platform 16 is descended by an amount of a thickness of the layer of ink after flattening so as to increase the distance between the inkjet head 200 and the platform 16.

Thereafter, the subsequent layer of ink is formed (for example, the operation indicated as a second layer printing in the diagram is carried out).

As a direction of the main scanning operation, it is also conceivable to employ two directions (both directions) on the forward path and the backward path. In this case, it is conceivable that, for example, the scanning in the deposition direction is carried out according to a direction in which the main scanning operation is carried out.

FIG. 3(b) is a diagram that shows another embodiment of the scanning in the deposition direction, and shows an embodiment of scanning in the deposition direction when performing the main scanning operation in the two directions (both directions).

In this case, formation time is reducible by performing the main scanning operation in the two directions (both directions) than performing the main scanning operation, for example, only on one of the forward path and the backward path.

Also in this case, it is conceivable to perform the operation of flattening on only one of the forward path and the backward path.

For example, when the flattening roller unit is disposed on only one side in the main scanning direction as in the configuration of the ejection unit 12 described with reference to FIG. 1, flattening is preferably carried out only when the main scanning operation is carried out in a direction in which the flattening roller unit is located rearward. For example, in the case shown in FIG. 3(b), the main scanning operation and flattening are carried out only during the main scanning operation on the backward path of reciprocating movement in the main scanning direction. No flattening is carried out and the main scanning operation is carried out in the main scanning operation on the forward path.

Therefore, during the main scanning operation on the backward path, the main scanning operation and the flattening of the layer of ink are carried out in the state in which the distance between the inkjet head 200 and the platform 16 remains the same, in an identical or similar manner as during the main scanning operation on the backward path in the case described with reference to FIG. 3(a)

During the main scanning operation on the forward path, the main scanning operation is carried out in the state in which the distance between the inkjet head 200 and the platform 16 is enlarged (in a state of clearance while being on the forward path) in a similar manner to that on the forward path in the case described with reference to FIG. 3(a).

However, when the main scanning operation and flattening are carried out with the conventional configuration as described with reference to FIGS. 3(a) and 3(b), a new problem may occur due to the operation of flattening. Subsequently, this problem is described below.

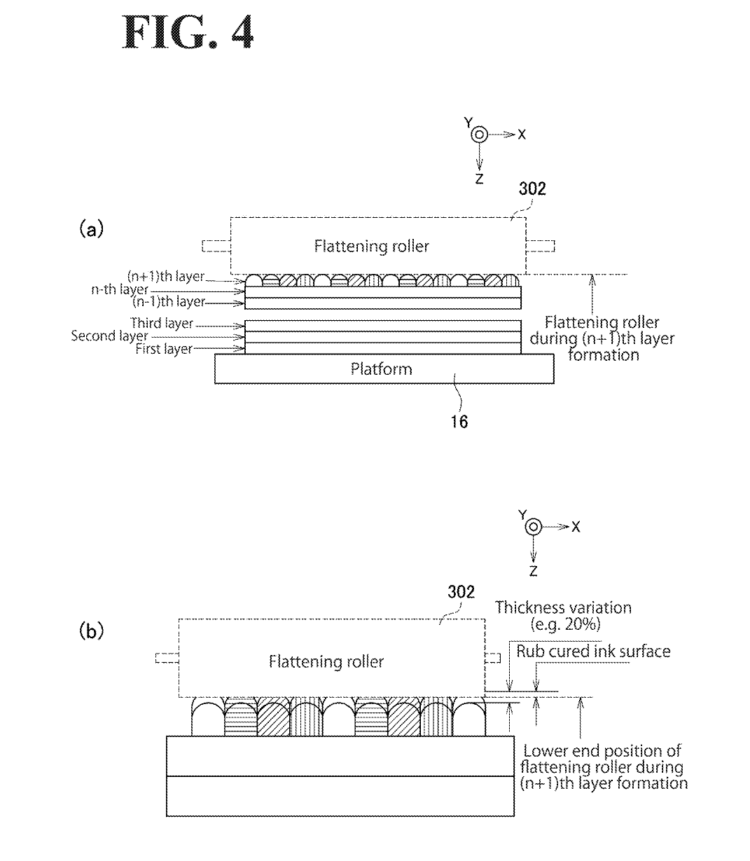

FIG. 4 is a diagram that describes the problem generated by the operation of flattening.

FIG. 4(a) shows, in simplified form, a situation during flattening of an (n+1)th layer of ink (the (n+1)th layer).

In this case, the (n+1)th layer is a layer of ink that is the (n+1)th (n is an integer of 1 or more) from the bottom in layers of ink deposited on the platform 16, and is formed on the n-th layer of ink (the n-th layer) from the bottom by the multi-pass method.

when forming a layer of ink by the multi-pass method, during a subsequent main scanning operation of a plurality of times of the main scanning operations on an identical position of the three-dimensional object 50 in the middle of formation, the main scanning operation and flattening are carried out on a region over which dots of ink are already formed by a preceding main scanning operation.

In this case, the dots of ink that are already formed are usually already cured by irradiation of UV light, or the like.

As described with reference to FIG. 3, when the main scanning operation and flattening are carried out with the conventional configuration, the height of the platform 16 during the main scanning operation that performs the flattening remains the same when forming the (n+1)th layer.

This therefore leads to the fact that the flattening roller 302 in the flattening roller unit 222 (refer to FIG. 1) performing flattening is easy to come into contact with an ink surface made up of the already cured dots of ink.

However, upon occurrence of the contact, for example, the flattening roller 302 moving in the main scanning direction can jump and unnecessary vibration (chatter) or the like can occur. Consequently, for example, unnecessary irregularities (such as chatter marks) can occur on the surface of ink after flattening, thus affecting the result of the flattening. More specifically, for example, this case fails to perform elaborated deposition, and stripe unevenness or the like can occur on the surface of a three-dimensional object 50 to be formed. This can degrade the quality of the three-dimensional object 50.

A further problem may occur due to a variety of variation factors. FIG. 4(b) is a diagram that describes influence of the variety of variations.

When ejecting the ink droplets by the inkjet scheme, it is unavoidable that a certain degree of variations occurs in ejecting position and landing position of the ink droplets in the principle of the inkjet head.

Also in this case, due to the influence of the variations of these positions, a difference can occur in deposited state of dots of ink adjacent to each other, so that variations can occur in thickness (height) of a layer of ink.

More specifically, for example, when a layer of ink is formed so that a layer has a thickness of approximately 25 nm, due to the above factors, variations of approximately 5 μm can occur in thickness of the layer of ink.

Due to variations in precision of the flattening roller 302 (circumferential surface runout), variations of approximately 5 μm may also occur in thickness (height) of a layer of ink to be flattened by the flattening roller 302.

Besides that, a difference can occur in thickness (height) of the layer of ink after flattening due to a difference in wettability with respect to the flattening roller 302, which can occur between a plurality of kinds of inks used for formation.

Taking these various factors into consideration, variations of approximately 20% of the thickness of the layer of ink can occur in height of dots of ink after flattening.

As used herein, the term “height of dots of ink after flattening” refers to, for example, an actual height of individual dots of ink constituting the layer of ink.

Additionally, the term “thickness of the layer of ink” denotes a design value previously set as a thickness of a layer of ink.

Upon occurrence of these variations, for example, during the operation of flattening, the position of a lower end of the flattening roller 302 underlies a top position of cured dots of ink, thus making it easier to cause a situation of being in contact with the cured dots of ink, namely, a situation where the flattening roller 302 rubs the cured ink surface.

Upon occurrence of the contact, the cured dots may be rubbed, resulting in occurrence of excessive residue (for example, flaky ink residue).

When the residue occurs during flattening, the operation of the flattening can be troubled. More specifically, for example, when the flattening is carried out by a configuration such as that of the flattening roller unit 222 of this embodiment, the flattening roller 302 scrapes ink containing excessive residue, and the residue may remain, for example, on the blade 304 (refer to FIG. 1), so that the operation of the flattening roller unit 222 can be troubled.

On the other hand, the inventor of this application has conducted earnest study to find a configuration capable of appropriately preventing the occurrence of the residue, or the like. As a specific configuration thereof, the inventor has conceived the configuration of the forming apparatus 10 of this embodiment. The operation of the forming apparatus 10 of this embodiment is described in more detail below.

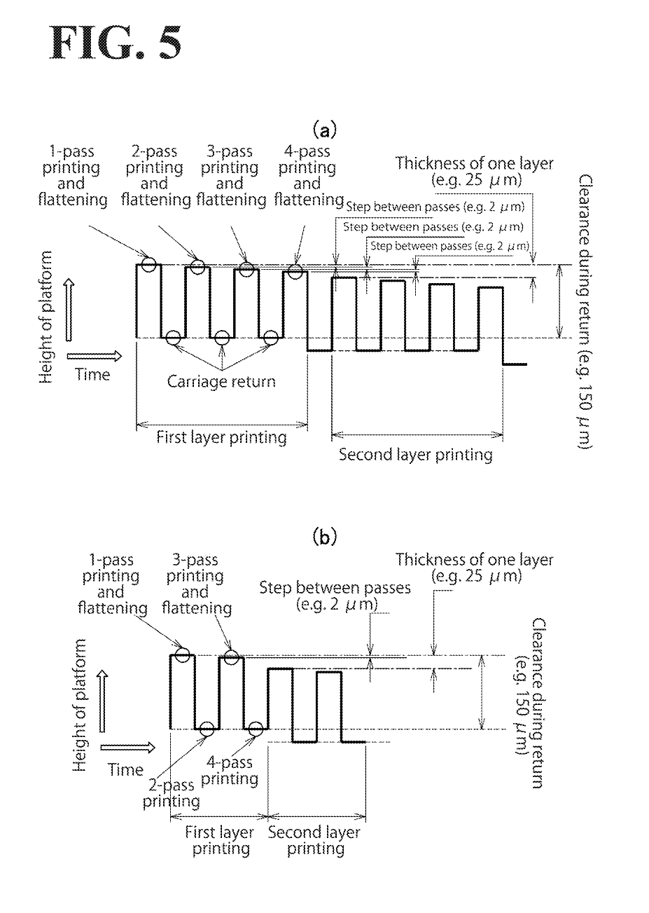

FIG. 5 is a diagram that describes scanning in a deposition direction carried out in the forming apparatus 10 of this embodiment.

The scanning in the deposition direction carried out in this embodiment is identical or similar to, for example, the operation with the conventional configuration described with reference to FIG. 3 and the like, except for points described below.

FIG. 5(a) shows an embodiment of the scanning in the deposition direction. The embodiment shown in FIG. 5(a) performs the main scanning operation only in one direction in the main scanning direction in the same manner as in the case described with reference to FIG. 3(a). More specifically, in this case, ink droplets are ejected to perform the main scanning operation only on the backward path in the reciprocating movement of the inkjet head 200 in the main scanning direction. Only movement is carried out without the ejection of ink droplets on the forward path.

The flattening by the flattening roller unit 222 (refer to FIG. 1) is carried out at the same time as the operation of the main scanning operations (1-pass printing to 4-pass printing) on each time.

Thus in the main scanning operation, the main scanning driver 14 causes the inkjet head 200 to move at least in one direction in the main scanning direction.

Also in the operation of forming a layer of ink, a plurality of times of the main scanning operations of causing the inkjet head 200 to move in the one direction are applied to an identical position of the three-dimensional object in the middle of formation.

The flattening roller 302 in the flattening roller unit 222 also flattens the layer of ink by moving together with the inkjet head 200 in the main scanning operation in the one direction.

Whenever a layer of ink is formed, the deposition direction driver 20 lowers the platform 16 by an amount of a thickness of a layer of ink.

Consequently, the deposition direction driver 20 increases the head-to-platform distance, which is a distance between the inkjet head 200 and the platform 16 in the ejection unit 12, by the amount of the thickness of a layer of ink, than that before starting the formation of the layer of ink.

Whereas setting of the height of the platform 16 during the main scanning operation is different from that described with reference to FIG. 3(a). More specifically, in this case, the height of the platform 16 during the main scanning operation does not remain the same, but an operation of slightly lowering the platform 16 is carried out whenever a preset number of times of the main scanning operations are carried out (an inter-pass level difference mode operation) in the operation of forming a layer of ink.

Thus, in each of the plurality of times of the main scanning operations in the one direction carried out during the operation of forming a layer of ink, the heat-to-platform distance during the subsequent main scanning operation is made larger than the head-to-platform distance during the preceding main scanning operation.

In other words, in this embodiment, the head-to-platform distance is increased stepwise during the plurality of times of the main canning operations for forming a layer of ink.

In this case, the amount of movement when slightly lowering the platform 16 is preferably made smaller than the thickness of a layer of ink. That is, the deposition direction driver 20 preferably differentiate the head-to-platform distance by a distance smaller than the thickness of a layer of ink among the plurality of times of the main scanning operations in the one direction carried out during the operation of forming a layer of ink. More specifically, in the case shown in FIG. 5(a), the deposition direction driver 20 increases the subsequent head-to-platform distance by 2 μm whenever the main scanning operation is carried out once.

With this configuration, it is possible to stepwise change the head-to-platform distance. Consequently, the head-to-platform distance is more appropriately changeable in a possible range for flattening.

When the configuration of this embodiment is viewed in a more generalized manner, this can also be viewed, for example, as such a configuration that in the main scanning operation that performs flattening, the position of the platform 16 is changed at least during the successive main scanning operations.

Also in this embodiment, during the operation of returning the inkjet head 200 without the ejection of ink droplets (timing indicated as a carriage return in the diagram), the inkjet head 200 is moved in a state in which the distance between the inkjet head 200 and the platform 16 is enlarged (a state of clearance during return) in the same manner as that described with reference to FIG. 3(a).

In this case, it is conceivable to set a distance of clearance during return to, for example, approximately 150 μm.

After the formation of a layer of ink is completed, the platform 16 is lowered by an amount of the thickness of a layer of ink (for example, 25 μm), and the head-to-platform distance is adjusted according to the operation of forming the subsequent layer of ink.

As used herein, the phrase “the platform 16 is lowered by an amount of the thickness of a layer of ink” refers to, for example, the height of the platform 16 when the first main scanning operation (1-pass printing) is performed in the formation of each layer as shown in the diagram, is changed by the amount of the thickness of a layer of ink.

With this configuration, for example, the head-to-platform distance during the main scanning operation for forming a layer of ink can be stepwise increased, for example, whenever the main scanning operation is carried out.

Therefore, with this embodiment, it is possible to appropriately prevent that dots of ink formed during the preceding main scanning operation come into contact with the flattening roller 302 in the operation of flattening. It is consequently possible to prevent the occurrence of excessive residue or the like, leading to more appropriate flattening.

An amount of change of the head-to-platform distance to be changed whenever the main scanning operation is carried out is, without being limited to 2 μm, preferably appropriately set according to necessary precision and the configuration of the apparatus.

The amount of change is preferably set according to, for example, the thickness of a layer of ink, and the kind of ink used for simultaneously performing layer formation within the single layer.

For preventing the contact between the flattening roller 302 and the cured dots of ink, as well as for appropriately performing flattening, the amount of change of the head-to-platform distance to be changed whenever the main scanning operation is carried out is preferably, for example, approximately 0.5-5 μm.

The operation of increasing the head-to-platform distance is not necessarily needed whenever the main scanning operations on each time are carried out. In this case, it is conceivable to increase the head-to platform distance, for example, whenever a preset main scanning operation is carried out. For example, it is conceivable that the head-to-platform distance during the succeeding main scanning operation is set larger than the head-to-platform distance during the preceding one, in association with at least part of the main scanning operations of a plurality of times of the main scanning operations that performs flattening. More specifically, for example, when the number of passes is set to four in the same manner as the case described with reference to FIG. 5(a), the head-to-platform distance may be changed only after performing the second main scanning operation (2-pass printing).

In this case, the head-to-platform distance remains the same during the first and second main scanning operations.

The head-to-platform distance remains the same during the third and fourth main scanning operations.

In this case, the head-to-platform distance is preferably set to, for example, approximately 5 μm.

Also in the forming apparatus 10 of this embodiment, the direction of the main scanning operation may be two directions (both directions) on the forward path and the backward path, instead of being only one direction in the main scanning direction. In this case, the scanning in the deposition direction or the like may also be carried out according to a direction in which the main scanning is carried out.

FIG. 5(b) is a diagram that shows another embodiment of scanning in a deposition direction, and shows the embodiment of the scanning in the deposition direction when performing the main scanning operation in two directions (both directions).

The scanning in the deposition direction as shown in FIG. 5(b) is identical or similar to the operation with the conventional configuration described with reference to FIG. 3 and the like, except for points described below.

In this case, the setting of the height of the platform 16 during the main scanning operation is different from that described with reference to FIG. 3(b). More specifically, in this case, the height of the platform 16 does not remain the same, and the operation of slightly lowering the platform 16 is performed whenever the main scanning operation is carried out, in association with a plurality of times of the main scanning operations in one direction (for example, the main scanning operations corresponding to 1-pass printing and 3-pass printing) in the operation of forming a layer of ink.

As used herein, the term “the plurality of times of the main scanning operations in one direction” refers to, for example, the main scanning operation that performs flattening by the flattening roller 302 of the flattening roller unit 222.

Also in this case, in association with a plurality of times of the main scanning operations in another direction (for example, the main scanning operations corresponding to 2-pass printing and 4-pass printing), the main scanning operations may be carried out at the same height in a state in which the platform is lowered by the amount of clearance during return.

With this configuration, the formation of the three-dimensional object is performable in a shorter time by, for example, performing the main scanning operation in two directions (both directions).

Even when so configured, the head-to-platform distance during the main scanning operation in one direction for forming a layer of ink can be increased stepwise, for example, whenever the main scanning operation is carried out.

Therefore, with this configuration, it is possible to appropriately prevent, for example, that dots of ink formed during the preceding main scanning operation come into contact with the flattening roller 302 in the operation of flattening.

This makes it possible to appropriately and sufficiently flatten the layer of ink.

Furthermore, in this case, for example, the configuration and control of the forming apparatus 10 can be appropriately simplified by performing no flattening during the main scanning operation in another direction and by setting the head-to-platform distance to an identical distance.

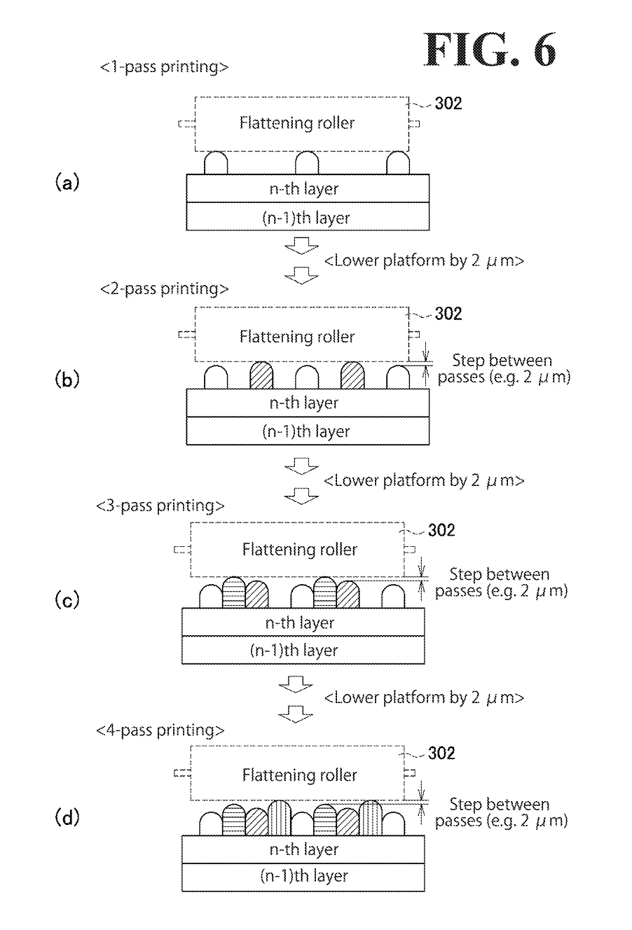

The operation of forming a layer of ink is this embodiment is described in more detail below. FIG. 6 is a diagram that shows an embodiment of the operation of forming a layer of ink. The plurality of times of the main scanning operations and the operation of flattening described with reference to FIG. 5(a) are more specifically described below.

FIGS. 6(a) to 6(d) show in simplified form a situation during first to fourth main scanning operations (I-pass printing to 4-pass printing) carried on an identical position in association with the operation of forming the (n+1)th layer.

FIG. 6(a) shows an embodiment of the situation during the first main scanning operation (1-pass printing).

During the first main scanning operation, dots of ink are formed on the n-th layer being already formed, in a state in which the height of the platform 16 is adjusted according to a height at which the (n+1)th layer needs be formed.

Flattening is carried out by the flattening roller 302 before the formed dots of ink are cured.

The dots of ink are cured after the flattening by applying UV light thereto.

Thereafter, the platform 16 is lowered 2 μm, followed by the second main scanning operation (2-pass printing).

FIG. 6(b) shows an embodiment of a situation during the second main scanning operation (2-pass printing). During the second main scanning operation, dots of ink are further formed in the vicinity of the dots of ink cured after the flattening in the first main scanning operation on the n-th layer being already formed.

Flattening is carried out by the flattening roller 302 before the formed dots of ink are cured. After the flattening, the dots of ink are cured by applying UV light thereto.

Subsequently, the platform 16 is lowered another 2 nm, followed by the third main scanning operation (3-pass printing).

FIG. 6(c) shows an embodiment of a situation during the third main scanning operation (3-pass printing). During the third main scanning operation, dots of ink are further formed in the vicinity of the dots of ink cured after the flattening in the first and second main scanning operations on the n-th layer being already formed.

Flattening is carried out by the flattening roller 302 before the formed dots of ink are cured. After the flattening, the dots of ink are cured by applying UV light thereto.

Subsequently, the platform 16 is lowered still another 2 μm, followed by the fourth main scanning operation (4-pass printing).

FIG. 6(d) shows an embodiment of a situation during the fourth main scanning operation (4-pass printing). During the fourth main scanning operation, dots of ink are further formed in the vicinity of the dots of ink cured after the flattening in the first to third main scanning operations on the n-th layer being already formed.

Flattening is carried out by the flattening roller 302 before the formed dots of ink are cured. After the flattening, the dots of ink are cured by applying UV light thereto.

With the above configuration, it is possible to appropriately prevent, for example, that the dots of ink formed during the preceding main scanning operation come into contact with the flattening roller 302 in the operation of the flattening, as described in association with FIG. 5. This prevents, for example, the occurrence of excessive residue, leading to more appropriate flattening.

In this case, attachment of the residue to each component of the flattening roller unit 222 is appropriately preventable by preventing the occurrence of the residue or the like. More specifically, for example, with the configuration that the blade 304 removes the ink scraped up by the flattening roller 302 as in this embodiment, the attachment of the residue to the flattening roller 302 and the blade 304 are more appropriately preventable. It is consequently possible to, for example, stabilize processing of the ink without deteriorating a flow of excessive ink recovered by the flattening roller unit 222. It is also possible to appropriately prevent, for example, ink clogging in a recovery channel.

Also in this case, by preventing the contact between the cured dots of ink and the flattening roller 302, for example, it is also possible to appropriately prevent, for example, that unnecessary vibration (chatter vibration) or the like occurs in the flattening roller 302. It is consequently also possible to prevent, for example, that unintended irregularities (such as chatter marks) are formed on the surface of the layer of ink.

Thus, with this embodiment, the formation with the multi-pass method is appropriately performable while appropriately performing flattening by, for example, increasing the head-to-platform distance whenever the main scanning operation is carried out in the plurality of times of the main scanning operations including flattening. It is consequently possible to, for example, more appropriately form a three-dimensional object with high precision.

Also in this case, for example, the surface of the three-dimensional object to be formed can be made smooth by gradually changing the head-to-platform distance for each of the main scanning operations. More specifically, even when the surface of the three-dimensional object has a gentle slope shape, for example, occurrence of outstanding steps in the form of contours is preventable, and it is therefore possible to more appropriately perform the formation that ensures a smooth surface.

Here, it is conceivable that when a layer of ink is formed by the configuration of this embodiment, dots of ink constituting a layer of ink are brought into a different state from that in the formation with the conventional method. This point is therefore briefly described below.

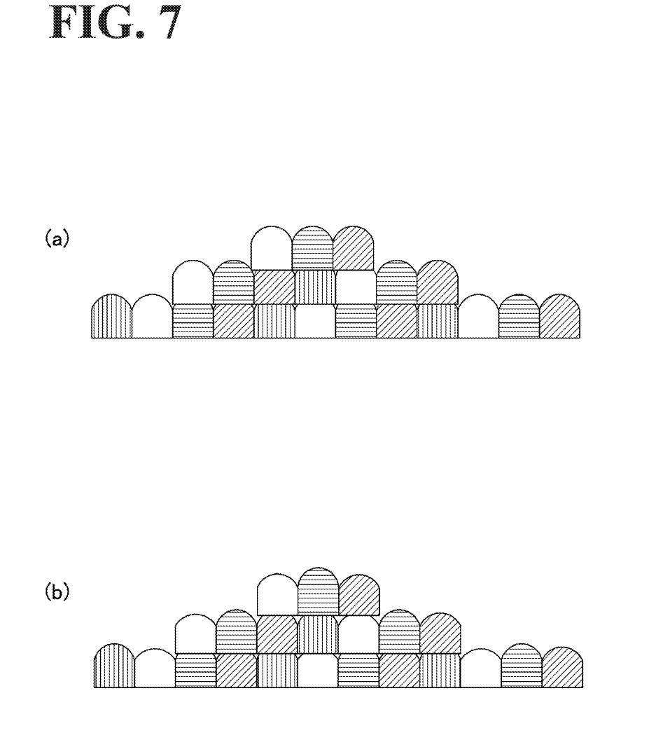

FIG. 7 is a diagram that describes a state of dots of ink formed in this embodiment.

In FIG. 7, dots of ink formed by the main scanning operations on each time are indicated by applying the same hatching pattern as that to the dots of ink formed by the main scanning operations on each time in the diagram that describes the 1-pass printing to the 4-pass printing in FIG. 6.

FIG. 7(a) shows an embodiment of a state of dots of ink when a layer of ink is formed by a conventional method. The phrase “when a layer of ink is formed by a conventional method” refers to, for example, when a layer of ink is formed without performing the operation of lowering the platform 16 whenever the main scanning operation is carried out.

In this case, the height of the platform 16 during the main scanning operation that performs flattening is constant in the formation of a layer of ink. In this case, the dots of ink formed by the main scanning operations on each time are therefore flattened at the same height.

Consequently, the height of dots of ink after being cured does not differ depending on which one of the main scanning operations perform formation.

FIG. 7(b) shows an embodiment of a state of dots of ink when a layer of ink is formed by the configuration of this embodiment. FIG. 7(b) shows an embodiment of a state of dots when a layer of ink is formed by the method described with reference to FIG. 5(a) and FIG. 6, as an embodiment of a state of dots when a layer of ink is formed by the configuration of this embodiment.

In this case, because the platform 16 is lowered whenever the main scanning operation is carried out, the height of the platform 16 during the main scanning operation that performs flattening is different for each of the main scanning operations.

Dots of ink formed by the individual main scanning operations on each time are therefore subjected to flattening at heights different from each other.

Consequently, as shown in the diagram, the height of dots of ink after being cured differs depending on which one of the main scanning operations performs formation.

It is therefore conceivable that when the layer of ink is formed by the configuration of this embodiment, the state of dots of ink are brought into a different state from that when formed with the conventional method.

A contact manner between the dots of ink formed by the main scanning operations on each time and the flattening roller 302 in the flattening roller unit 222 seems to be different depending on a specific configuration of the apparatus.

For example, it is conceivable that when the number of passes is approximately four, depending on the configuration of the apparatus, only dots of ink formed by approximately the latter two main scanning operations of the four main scanning operations performed on an identical position come into contact with the flattening roller 302.

It is also conceivable that only dots of ink formed by the last main scanning operation of the main scanning operations performed on the identical position come into contact with the flattening roller 302.

Besides those shown in the diagram, the specific shape of the dots seems to change differently depending on the specific configuration of the apparatus.

A specific configuration of the flattening roller unit 222 is described in more detail below.

As described earlier with reference to FIG. 1, in this embodiment, the flattening roller unit 222 includes the flattening roller 302, the blade 304, and the ink recovery part 306.

In this case, the flattening roller 302 is, for example, a roller that scraps off uncured ink, specifically comes into contact with the surface of a layer of ink during the main scanning operation so as to remove a part of the uncured ink, thereby flattening the layer of the ink. Thus, the flattening roller 302 flattens the surface of ink during the operation of forming a layer of the ink.

As used herein, the term “flattening a layer of ink” may denote, for example, removing ink corresponding to a portion exceeding a thickness being preset as a thickness of a layer of ink.

It is also conceivable to further employ a configuration other than the above in a more specific configuration of the flattening roller unit 222.

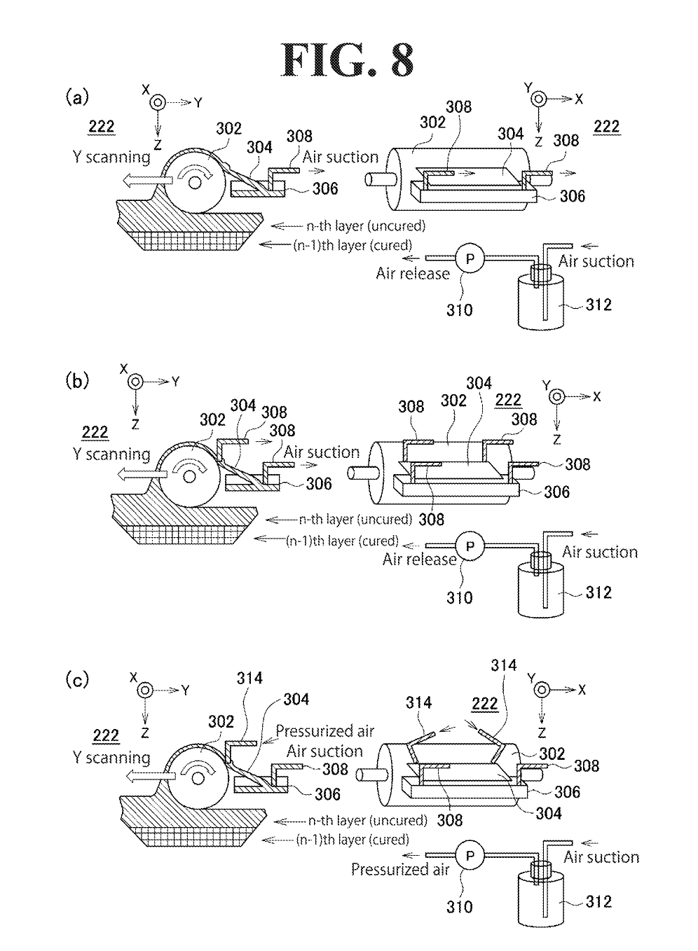

FIG. 8 shows an embodiment of the more specific configuration of the flattening roller unit 222.

FIG. 8(a) shows an embodiment of the configuration of the flattening roller unit 222.

In FIG. 8(a), a diagram on the left is a sectional view of the flattening roller unit 222. A diagram on the right is a perspective view of the flattening roller unit 222.

FIG. 8(a) shows, in simplified form, a situation where a layer of uncured ink is flattened when an n-th layer of ink is formed on a cured (n−1)th layer.

In the case shown in FIG. 8(a), the flattening roller unit 222 further includes a suction part 308 besides the flattening roller 302, the blade 304, and the ink recovery part 306.

The suction part 308 is a configuration for sucking ink removed by the flattening roller 302. The ink recovered by the ink recovery part 306 is moved to an exhaust ink tank 312 by, for example, being sucked by a pump 310.

In this case, the pump 310 performs, for example, air release of air sucked from the exhaust ink tank 312.

Thereby, a suction of air (air suction) via the exhaust ink tank 312 and the suction part 308 is carried out to move the ink together with the air to the exhaust ink tank 312.

Alternatively, the pump 310 and the exhaust ink tank 312 may be disposed outside the ejection unit 12 (refer to FIG. 1).

With this configuration, it is possible to appropriately prevent, for example, that excessive ink removed by the flattening roller 302 remains in the flattening roller unit 222. This makes it possible to more appropriately perform flattening even when formation is carried out continuously over a long period of time.

FIG. 8(b) shows another embodiment of the configuration of the flattening roller unit 222.

The configurations shown in FIG. 8(b) that bear the same reference numerals as those in FIG. 8(a) are identical or similar to the configurations in FIG. 8(a), except for points described below. Similarly to FIG. 8(a), FIG. 8(b) shows a sectional view and a perspective view.

In the case shown in FIG. 8(b), the flattening roller unit 222 further includes a larger number of the suction part 308 than the case shown in FIG. 8(a).

The suction part 308, which is an additional one as compared with the configuration in FIG. 8(a) sucks ink, for example, on the blade 304 before the ink scraped up by the flattening roller 302 reaches the ink recovery part 306.

With this configuration, it is possible to more appropriately prevent, for example, that excessive ink removed by the flattening roller 302 remains in the flattening roller unit 222.

FIG. 8(c) shows still another embodiment of the configuration of the flattening roller unit 222.

The configurations shown in FIG. 8(c) that bear the same reference numerals as those in FIG. 8(a) are identical or similar to the configurations in FIG. 8(a), except for points described below. Similarly to FIG. 8(a), FIG. 8(c) shows a sectional view and a perspective view.

In the case shown in FIG. 8(c), the flattening roller unit 222 further includes a pressurized air discharge part 314 as compared with the case shown in FIG. 8(a).

The pressurized air discharge part 314 is a configuration that applies pressurized air to the ink scraped up by the flattening roller 302, and applies the air to the ink, for example, on the blade 304 before the ink scraped up by the flattening roller 302 reaches the ink recovery part 306.

In this case, it is also conceivable to apply the air to the ink scraped off from the flattening roller 302 by the blade 304 so as to be moved to the ink recovery part 306.

Also in this case, the pump 310 feeds air sucked from the exhaust ink tank 312 to the pressurized air discharge part 314.

Thereby, the pressurized air discharge part 314 applies the pressurized air to the ink.

Additionally, air suction via the exhaust ink tank 312 and the suction part 308 is carried out to move the ink to the exhaust ink tank 312 together with the air.

With this configuration, it is possible to more appropriately prevent, for example, that the ink remains on the blade 304.

This makes it possible to more appropriately prevent, for example, that excessive ink removed by the flattening roller 302 remains in the flattening roller unit 222.

Modifications of configuration and operation of the forming apparatus 10 are described below.

The configuration that the flattening is carried out only during the main scanning operation in one direction is mainly described above. For example, in the configuration described with reference to FIG. 5(a), only the main scanning operation in one direction is carried out, and the flattening is carried out during this main scanning operation.

In the configuration described with reference to FIG. 5(b), the main scanning operation in two directions (both directions) is carried out, and the flattening is carried out only during the main scanning operation in one direction.

More specifically, in this case, the main scanning driver 14 in the forming apparatus 10 (refer to FIG. 1) causes the inkjet head 200 in the ejection unit 12 (refer to FIG. 1) to perform the main scanning operation in one direction in the main scanning direction, and the main scanning operation in another direction in the main scanning direction.

The flattening roller 302 in the flattening roller unit 222 (refer to FIG. 1) flattens a layer of ink only during the main scanning operation in one direction of the main scanning operations in one direction and another direction.

Further in this case, the deposition direction driver 20 (refer to FIG. 1) increases stepwise the head-to-platform distance whenever the main scanning operation in one direction performed in the operation of forming a layer of ink is carried out.

Furthermore, the head-to-platform distance is set to an identical distance in each of a plurality of times of the main scanning operations in another direction.

However, in the modification of the configuration and operation of the forming apparatus 10, for example, the main scanning operation in two directions (both directions) may be carried out, and the flattening may be carried out not only during the main scanning operation in one direction but also during the main scanning operation in another direction.

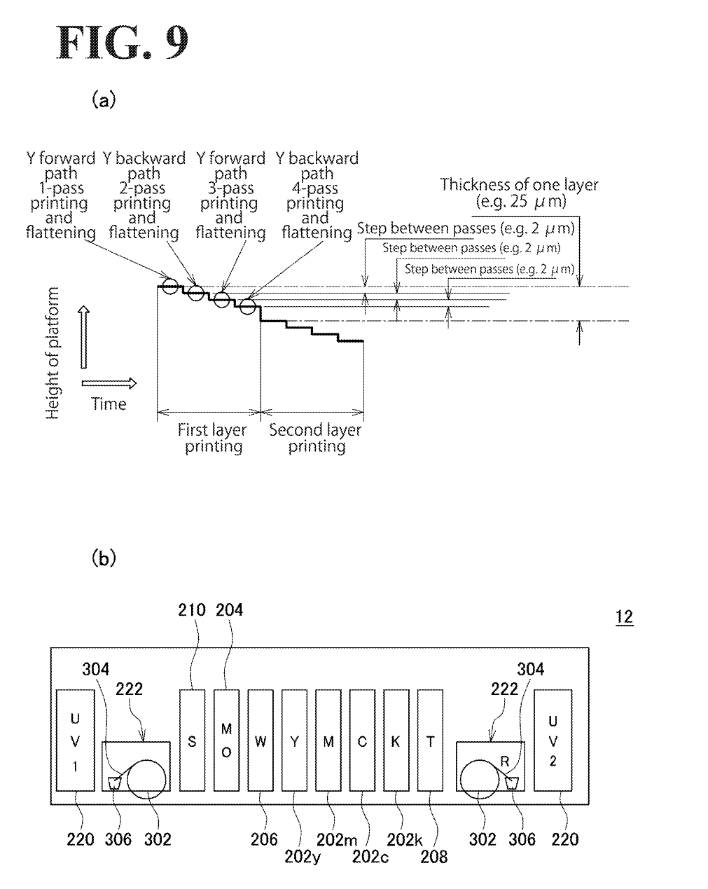

FIG. 9 is a diagram that describes modifications of the configuration and operation of the forming apparatus 10.

FIG. 9(a) shows an embodiment of the operation when flattening is carried out during the main scanning operation in one direction and another direction.

FIG. 9(b) shows an embodiment of the configuration of the ejection unit 12 employed for the above case. The operation shown in FIG. 9 is identical or similar to the operation described with reference to FIGS. 1 to 8.

In this case, it is conceivable to increase stepwise the head-to-platform distance by lowering the platform 16 (refer to FIG. 1) whenever the main scanning operation is carried out, irrespective of the direction in which the inkjet head 200 is moved during the main scanning operation.

For example, the illustrated case shows an embodiment where the platform 16 is lowered 2 μm whenever the main scanning operation is carried out in the formation of a layer of ink in which a layer has a thickness of 25 μm.

Also in this case, it is conceivable to use, for example, the ejection unit 12 having the flattening roller unit 222 on one side and another side in the main scanning direction as shown in FIG. 9(b) so that flattening is carried out by the flattening roller 302 of the flattening roller unit 222 (refer to FIG. 1) lying rearward during the main scanning operation.

In other words, in this case, the main scanning driver 14 (refer to FIG. 1) causes the inkjet head 200 to perform the main scanning operation in one direction in the main scanning direction, and the main scanning operation in another direction in the main scanning direction.

In this case, the ejection unit 12 in the forming apparatus 10 includes, as flattening means, the first flattening roller 302 that flattens a layer of ink during the main scanning operation in one direction, and the second flattening roller 302 that flattens the layer of ink during the main scanning operation in another direction.

More specifically, as compared with the ejection unit 12 shown in FIG. 1(b), the ejection unit 12 in this case further includes a flattening roller unit 222 also between the UV light source 220 indicated with an alphanumeric character UV1, and the array of the inkjet head 200 (such as the support material head 210).

In this case, the flattening rollers 302 respectively in the two flattening roller units 222 are rotated in opposite directions.

For example, the flattening roller 302 in the flattening roller unit 222 of the two flattening roller unit 222, which is disposed on the right side in the diagram, is rotated in a clockwise direction in the diagram.

The flattening roller 302 in the flattening roller unit 222 disposed on the left side in the diagram is rotated in a counterclockwise direction in the diagram.

In this case, the flattening is carried out by the left flattening roller unit 222 during the main scanning operation that causes the ejection unit 12 to move from the left to the right in the diagram.

The flattening is carried out by the right flattening roller unit 222 during the main scanning operation that causes the ejection unit 12 to move from the right to the left in the diagram.

Therefore, in this case, the ejection unit 12 preferably further includes a mechanism for enabling only one of the flattening roller units 222 according to the direction of the main scanning operation.

For example, it is conceivable to employ, as this mechanism, a configuration that selects and lowers only the flattening roller unit 222 to be enabled, while holding the flattening roller units 222 so as to be movable in Z direction.

Also in this case, the deposition direction driver 20 (refer to FIG. 1) increases the heat-to-platform distance during a subsequent main scanning operation than the head-to-platform distance during a preceding main scanning operation in each of a plurality of times of the main scanning operations carried out in the operation of forming a layer of ink.

Thereby, the head-to-platform distance is increased stepwise whenever the main scanning operation is carried out, not only in the main scanning operation in one direction but also in the main scanning operation in another direction.

Even with this configuration, the formation of a three-dimensional object is performable in a shorter time by performing the main scanning operation in two directions (both directions).

Further in this case, the flattening is appropriately performable in the main scanning operation in either direction by using the plurality of flattening rollers 302 according to the direction of the main scanning operation.

Furthermore, it is possible to appropriately prevent that dots of ink formed during a preceding main scanning operation come into contact with the flattening roller 302 by increasing stepwise the head-to-platform distance whenever the main scanning operation is carried out. This prevents, for example, the occurrence of excessive residue, thereby making it possible to more appropriately perform the flattening.

A modification of the operation of the multi-pass method is described below.

As an embodiment of the operation of the multi-pass method, the large pitch pass method, which is a method of setting a feed in the sub-scanning operation to a predetermined pass width, has been mainly described above.

It is, however, also conceivable to use a method other than the large pitch pass method as an operation of the multi-pass method.

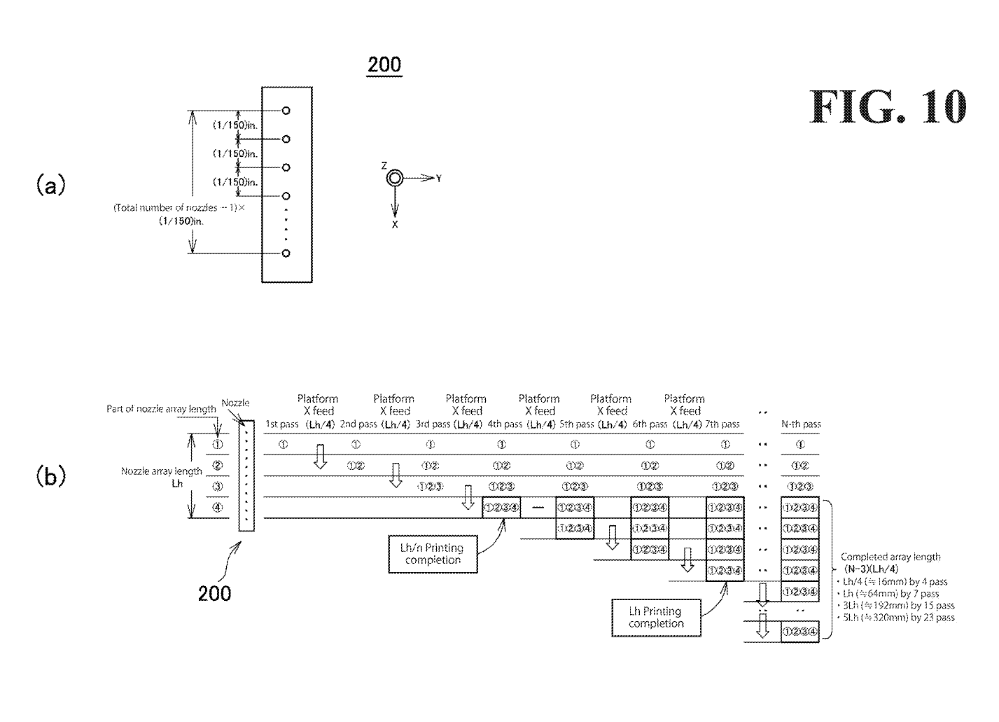

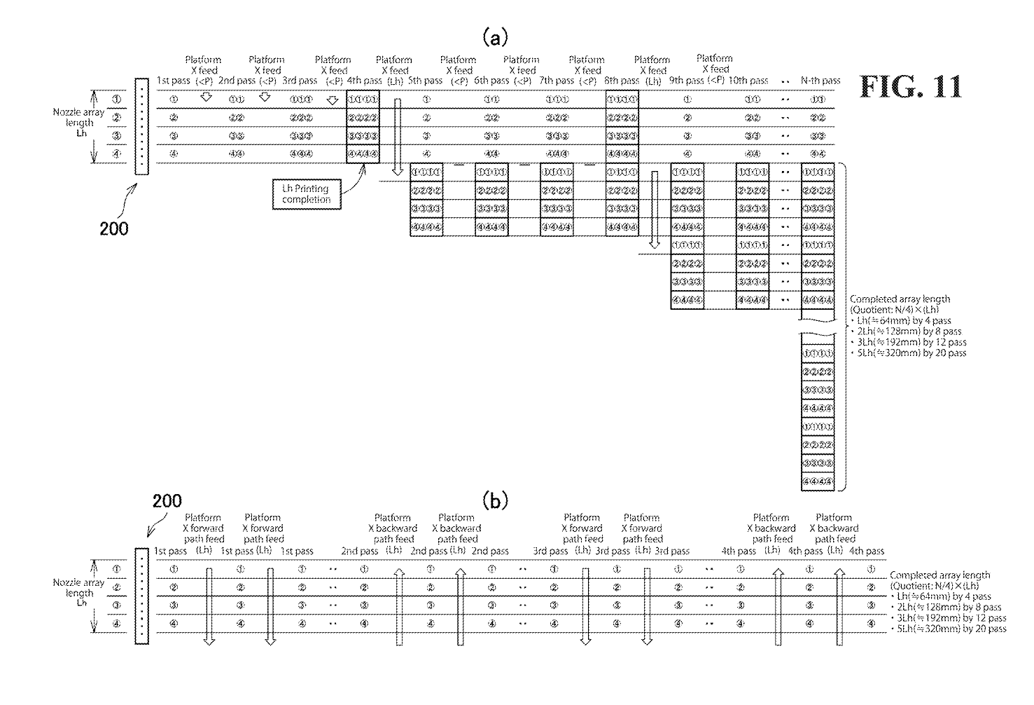

FIGS. 10 and 11 are diagrams that describe a variety of methods for performing the operation of the multi-pass method, and show an embodiment of the operation when a layer of ink is formed at a resolution (density) of 600 dpi by setting the number of passes to 4 with the use of the inkjet head 200 whose array of nozzle has a resolution of 150 dpi (dots per inch).

The configuration and operation of the forming apparatus 10 are identical or similar to those in the case described with reference to FIGS. 1 to 9, except for points described below.

Similarly to the case described with reference to FIGS. 1 to 9, the head-to-platform distance is preferably increased whenever a preset number of times of the main scanning operations are carried out, for example, in each of operations described below. In this case, it is preferable to increase the head-to-platform distance by an amount of a predetermined distance, for example, whenever the main scanning operation that performs the flattening is carried out once.

FIG. 10(a) shows an embodiment of the configuration of the inkjet head 200 used for formation.

In the illustrated configuration, the inkjet head 200 includes an array of nozzles in which a plurality of nozzle holes are arranged side by side in a nozzle array direction parallel to the sub-scanning direction.

These nozzle holes are arranged at constant intervals (nozzle pitch P) of 1/150 inch (0.169 mm). Accordingly, a length (Lh) of the array of nozzles is (total number of nozzles−1)×0.169 mm.

FIG. 10(b) is a diagram that shows an embodiment of an operation of forming a layer of ink by the multi-pass method that is the large pitch pass method. As described above, the large pitch pass method is a method of setting the feed in the sub-scanning operation to 1/n of the length (Lh) of the array of nozzles (=Lh/n) when the number of passes is n.

FIG. 10(b) illustrates the case where the number of passes is 4. Therefore, in this case, the feed in the sub-scanning operation is ¼ of the length of the array of nozzles (=Lh/4).

In this diagram, encircled figures next to individual regions obtained by dividing the array of nozzles of the inkjet heads 200 into four portions are figures for distinguishing the individual regions in the array of nozzles.

A diagram shown on the right side of the inkjet head 200 is a diagram that shows an embodiment of the operation of repeating the main scanning operation and the sub-scanning operation, and shows a relationship between individual regions of a three-dimensional object in the middle of formation, and regions in the array of nozzles that eject ink droplets on the individual regions in the first main scanning operation (1st Pass) to an N-th main scanning operation (N-th Pass).

As used herein, the term “regions in the array of nozzles” denote the regions distinguishably indicated by the encircled figures. Descriptions on the upper side of the diagram indicate operations during each of the main scanning operations and operations performed before and after that. A relationship between the number of the main scanning operations and a length of a region where the formation of a layer of ink is already completed is shown on the right side of the diagram.

A layer of ink is appropriately formable by the multi-pass method that is the large pitch pass method by performing the operations as shown in the diagram. A three-dimensional object is appropriately formable by forming a plurality of layers by deposition.

FIG. 11(a) is a diagram that shows an embodiment of an operation of forming a layer of ink by the multi-pass method that is a small pitch pass method.

The term “small pitch pass method” is a method of setting the feed in the sub-scanning operation to be smaller than 1/n of the length (Lh) of the array of nozzles (=Lh/n) when the number of passes is n.

The small pitch pass method can be said to be not the operation of forming a layer of ink by making constant the feed of the sub-scanning operation as in the large pitch pass method, but an operation of forming a layer of ink by repeating an operation of performing the main scanning operations corresponding to a predetermined number of passes by interposing therebetween the sub-scanning operation at a smaller feed, and a subsequent sub-scanning operation at a predetermined feed rate corresponding to a length of the array of nozzles.

FIG. 11(a) shows more specifically an embodiment in which a feed rate when performing the sub-scanning operation at a smaller feed rate is smaller than a nozzle pitch P and an integral multiple of P/n.

In this diagram, symbols such as encircled figures, and characters and the like in the description indicate identical or similar matters to those in FIG. 10(b). A layer of ink is appropriately formable by the multi-pass method that is the small pitch pass method by performing operations as shown in the diagram.

A three-dimensional object is appropriately formable by forming a plurality of layers by deposition. As apparent from a comparison of lengths of completed arrays, this case is capable of forming the layer of ink by a smaller number of the main scanning operations than the case of performing formation by the large pitch pass method. This makes it possible to, for example, reduce formation time.

When the small pitch pass method is described in a more generalized manner, this method can be said to be a method of causing the sub-scanning driver 18 (refer to FIG. 1) to move the inkjet head 200 in the sub-scanning direction relative to the platform 16 by an amount of a sub-scanning direction movement distance being a smaller distance than a width obtained by dividing a length of an array of nozzles in the sub-scanning direction by the number of passes (Lh/n) whenever a preset number of times of the main scanning operations are carried out.

As used herein, the term “sub-scanning direction movement distance” can be said to be a distance obtained by adding an integer multiple of a nozzle pitch sub-scanning direction component that is a distance in the sub-scanning direction between the nozzle holes adjacent to each other in the array of nozzles, and a distance less than the nozzle pitch sub-scanning direction component.

The term “integer multiple of a nozzle pitch second direction component” refers to, for example, a product of the nozzle pitch sub-scanning direction component and an integer of zero or more.

With this configuration, for example, in terms of resolution in the sub-scanning direction, it is possible to appropriately achieve a high resolution corresponding to a distance smaller than the nozzle pitch sub-scanning direction component.

FIG. 11(a) shows, as an embodiment of the operation of the small pitch pass method, the case where a width of a three-dimensional object to be formed (a length in the sub-scanning direction) is larger than the length of an array of nozzles (Lh). Therefore, in this case, the sub-scanning operation, in which a distance equal to the length of the array of nozzles is a feed rate, is carried out whenever four main scanning operations are carried out.

When this case is shown in a more generalized manner, it is possible to say that, for example, after the main scanning operation corresponding to the number of passes are carried out on a region corresponding to the length (Lh) of the array of nozzles, the inkjet head 200 is moved relative to the platform 16 in the sub-scanning direction by a distance corresponding to the length (Lh) of the array of nozzles.

Also in this case, the main scanning operations corresponding to the number of passes are further carried out after the inkjet head 200 is moved.

With this configuration, even when a three-dimensional object has a large size, it is possible to appropriately form the three-dimensional object.

With this configuration, for example, in association with the resolution in the sub-scanning direction, it is possible to appropriately express a high resolution corresponding to a distance smaller than the nozzle pitch sub-scanning direction component.

However, for example, when a width of a three-dimensional object is smaller than the length (Lh) of the array of nozzles, it is conceivable to simultaneously eject ink droplets from the array of nozzles over a full width of the three-dimensional object without performing the sub-scanning operation over the large distance described above.

FIG. 11(b) is a diagram that shows an embodiment of an operation of forming a layer of ink by the multi-pass method that is a full-surface sequential pass method. The term “full-surface sequential pass method” refers to, for example, a method of sequentially performing the main scanning operations on an identical time. As used herein, the term “main scanning operations on an identical time” refers to, for example, the main scanning operations in an identical time of the main scanning performed a plurality of times on an identical position of a three-dimensional object in the middle of formation in the operation of forming a layer of ink.

In this diagram, symbols such as encircled figures, and characters and the like in the description indicate identical or similar matters to those in FIG. 10(b).

A layer of ink is appropriately formable by the full-surface sequential pass method by performing operations as shown in the diagram.

A three-dimensional object is appropriately formable by forming a plurality of layers by deposition.

As apparent from a comparison of lengths of completed arrays, this case is capable of forming the layer of ink by a smaller number of the main scanning operations than the case of performing formation by the large pitch pass method. This makes it possible to, for example, reduce formation time.

When the full-surface sequential pass method is described in a more generalized manner, this method can be said to be, for example, an operation of causing the sub-scanning driver 18 to move the inkjet head 200 in the sub-scanning direction relative to the platform 16 by a distance corresponding to a length of an array of nozzles in the sub-scanning direction whenever the main scanning operation is carried out once, in the operation of forming a layer of ink.

In this case, for example, after the first main scanning operation is carried out on the entirety of a region over which a layer of ink needs to be formed, the inkjet head 200 is subjected to the second main scanning operation on individual positions of the layer of ink.

In this case, a distance over which the inkjet head 200 is moved in the sub-scanning direction in the sub-scanning operation is, for example, a distance equal to the length of the array of nozzle in the sub-scanning direction.

When the number of passes is three or more, the main scanning operations in each of the third and subsequent times are carried out, for example, after the preceding main scanning operation is carried out over the entirety of the layer of ink.

With this configuration, the formation by the full-surface sequential pass method is more appropriately performable.

The case where the direction of movement of the inkjet head 200 in the sub-scanning operation is set to one direction has been mainly described above.

As used herein, the term “direction of movement of the inkjet head 200 in the sub-scanning direction” refers to, for example, a direction in which the inkjet head 200 is moved relative to the platform 16.

It is, however, conceivable that in the still another modification of the configuration and operation of the forming apparatus 10, the direction of movement of the inkjet head 200 in the sub-scanning operation is also set to two directions (both direction) of one direction and another direction.

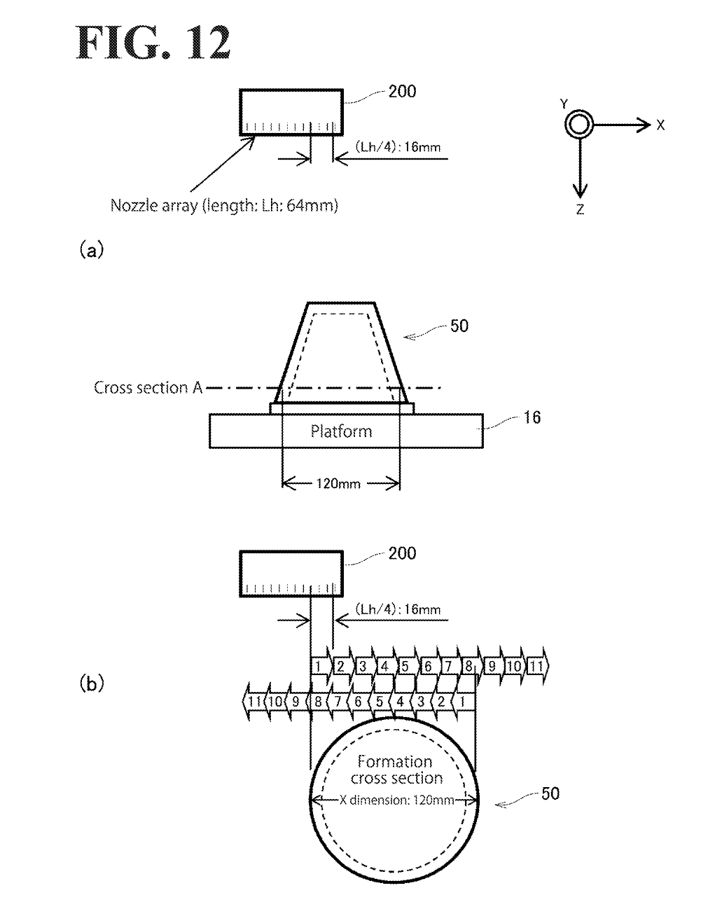

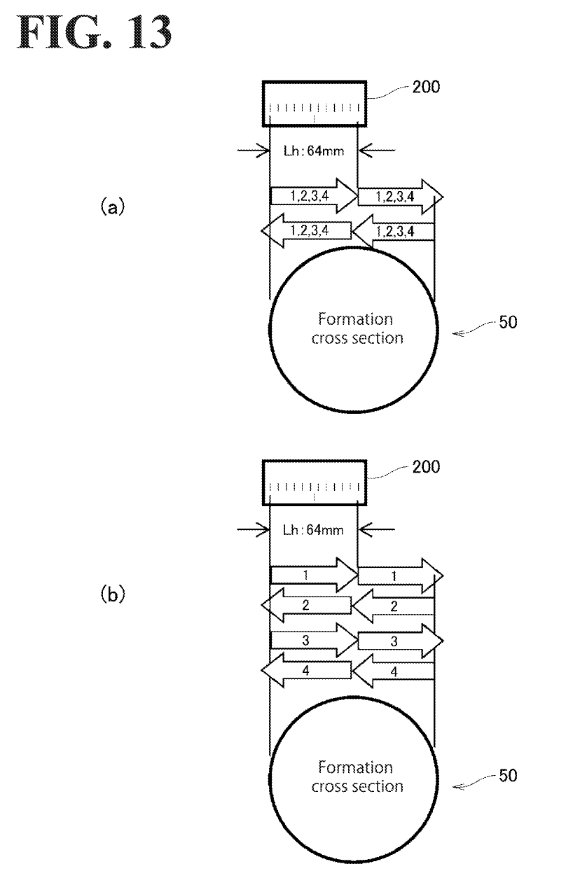

FIGS. 12 and 13 are diagrams that describe yet another embodiment of the configuration and operation of the forming apparatus 10.

FIG. 12(a) shows an embodiment of the configuration of an inkjet head 200 used in an operation described below, and an embodiment of the configuration of a three-dimensional object 50 to be formed. The inkjet head 200 may be, for example, an inkjet head being identical or similar to the inkjet head 200 used in each of the configurations described with reference to FIGS. 1 to 11.

In the illustrated case, a length of an array of nozzles (Lh) in the inkjet head 200 is 64 mm. Therefore, when the number of passes is set to 4, a length obtained by dividing the length of the array of nozzles by the number of passes (Lh/4) is 16 mm.

The three-dimensional object 50 formed in the illustrated case is an upside-down cup-shaped three-dimensional object, and is to be formed on the platform 16 in a state in which a part that becomes an opening is directed downward. In this case, a support layer is formed on a region that becomes interior of the cup.

A position indicated as a cross section A in this case is the position corresponding to a formation cross section shown in FIGS. 12(b), 13(a), and 13(b). The formation cross section is a circular shape with a diameter of 120 mm.

FIGS. 12(b), 13(a), and 13(b) are diagrams that show embodiments of the operation when the direction of movement of the inkjet head 200 in the sub-scanning operation is set to two directions (both directions), and show the direction of movement of the inkjet head 200 in the sub-scanning operation carried out after the main scanning operations on each time, in cases where a layer of ink is formed by each of the large pitch pass method, small pitch pass method, and full-surface sequential pass method.

More specifically, FIG. 12(b) shows an operation of forming continuous two layers of ink in the operation of the large pitch pass method, in which directions of the sub-scanning operations carried out between the first to eleventh main scanning operations of forming each of the layers of ink are indicated by numbered arrows.

In this case, as the operation of forming each of the layers of ink, the main scanning operation is carried out a plurality of times by aligning an end of formation data to control formation with a start position of the main scanning operation.

For example, in the formation of a layer of ink, the direction of movement of the inkjet head 200 is set to one direction (a forward path direction), and the layer of ink is formed in an identical or similar manner as the case described with reference to FIG. 10(b). For example, the main scanning operation is started from the position of the left end of the formation data in the illustrated case. The inkjet head 200 is moved in one direction in the sub-scanning direction (rightward in the diagram) by 16 mm that is a distance obtained by dividing the length of the array of nozzles by the number of passes, whenever the main scanning operations on each time are carried out. The main scanning operation and the sub-scanning operation are repeated in the same manner to perform the main scanning operation eleven times, thereby completing the first layer of ink.

Subsequently, a layer of ink is formed by setting the direction of movement of the inkjet head 200 during the sub-scanning operation to another direction (a backward path direction) and in an identical or similar manner as the case described with reference to FIG. 10(b). In this case, the main scanning operation is started from the position of the right end of the formation data.

Also in this case, the inkjet head 200 is moved by 16 mm in another direction (leftward in the diagram) in the sub-scanning direction whenever the main scanning operations on each time. Thus, the second layer of ink is completed by performing, for example, the main scanning operation eleven times.

Even when the sub-scanning operation is carried out in two directions (both directions), the head-to-platform distance is preferably changed in an identical or similar manner to the case described with reference to FIGS. 1 to 10.

The head-to-platform distance is preferably changed according to the direction of movement of the inkjet head 200 during the sub-scanning operation.

With this configuration, a contact between cured dots of ink and the flattening roller 302 (refer to FIG. 1) is appropriately preventable, for example, even when the sub-scanning operation is carried out in two directions (both directions).

When the operation of performing the sub-scanning operation in two directions (both directions) is described in a more generalized manner, this operation can be said to be as follows. The operation of the sub-scanning driver 18 (refer to FIG. 1) causes the inkjet head 200 to move relative to the platform 16 in one direction in the sub-scanning direction subsequently to a part of the main scanning operations, and causes the inkjet head 200 to move relative to the platform 16 in another direction in the sub-scanning direction subsequently to at least another part of the main scanning operations.

With this configuration, for example, the formation of the three-dimensional object 50 is performable in a shorter time by performing the sub-scanning operation in two directions (both directions).

The operation described with reference to FIG. 12(b) can be said to be, for example, an operation of reversing the direction of movement of the inkjet head 200 during the sub-scanning operation for each of layers of ink. In this case, setting is made so that the direction of movement of the inkjet head 200 during the sub-scanning operation is reversed between two continuous layers of ink.

When the setting of the direction of movement of the inkjet head 200 during the sub-scanning operation is described in a more generalized manner, this setting can be said to be a configuration that when forming a part of a layer of ink of a plurality of layers of ink deposited, the direction of movement of the inkjet head during the sub-scanning operation is set to one direction, and the direction of movement of the inkjet head 200 during the sub-scanning operation is set to another direction when forming another layer of ink.

In FIG. 13(a), in association with the operation of the small pitch pass method, the direction of the sub-scanning operation performed between the main scanning operations corresponding to the number of passes (four) to be continuously performed on a region is indicated by the numbered arrow. In this case, when forming a layer of ink, the direction of movement of the inkjet head 200 during the sub-scanning operation is set to one direction (the forward path direction), and the layer of ink is formed in an identical or similar manner to the case described with reference to FIG. 11(a).

Also in this case, the formation of individual layers of ink is carried out by aligning the end of formation data to control the formation with a start position of the main scanning operation.

More specifically, the main scanning operation is started from the position of a left end of the formation data, and the four main scanning operations corresponding to the number of passes are carried out while interposing therebetween the sub-scanning operation of the small pitch. Thereafter, the inkjet head 200 is moved in one direction (rightward in the diagram) in the sub-scanning direction by 64 mm corresponding to the length of the array of nozzles.

In the illustrated case, the layer of ink is formable in a range of 128 mm that is a region twice the length of the array of nozzles by repeating the above operation two times. Therefore, in this case, the first layer of ink is completed by performing the above operation two times.

Thereafter, a layer of ink is formed by setting the direction of movement of the inkjet head 200 during the sub-scanning operation to another direction (the backward path direction) and in an identical or similar manner to that described with reference to FIG. 11(a). In this case, the main scanning operation is started from the position of a right end of the formation data.

More specifically, in this case, the main scanning operation is started from the position of a right end of the formation data, and the four main scanning operations corresponding to the number of passes are carried out while interposing therebetween the small sub-scanning operation of the small pitch. Thereafter, the inkjet head 200 is moved in another direction (leftward in the diagram) in the sub-scanning direction by 64 mm corresponding to the length of the array of nozzles.

Similarly to the first layer, the second layer of ink is completed by performing the above operation two times. As to points other than those described above, the operation shown in FIG. 13(a) may be carried out in an identical or similar manner to the operation shown in FIG. 12(b).

In FIG. 13(b), in association with the operation of the full-surface sequential pass method, the direction of the sub-scanning operation performed between the main scanning operations corresponding to the number of passes (four) to be continuously performed on a region is indicated by the numbered arrow.

In this case, the direction of movement of the inkjet head 200 during the sub-scanning operation is changed whenever the main scanning operations on an identical time are carried out on a full surface (on a pass-by-pass basis), instead of being changed for each layer of ink. Also in this case, the formation of individual layers of ink is carried out by aligning the end of formation data to control the formation with a start position of the main scanning operation.

More specifically, the main scanning operation is started from the position of a left end of the formation data, and the first main scanning operation (first pass) on the full surface of a layer of ink in an identical or similar manner to the case described with reference to FIG. 11(b). In this case, the inkjet head 200 is moved in one direction (rightward in the diagram) in the sub-scanning direction by 64 mm corresponding to the length of the array of nozzles whenever the main scanning operation is carried out once.

In the illustrated case, the first main scanning operation is performable on a range of 128 mm that is a region twice the length of the array of nozzles by repeating the above operation two times. This leads to completion of the first main scanning operation on the full surface of the layer of ink.

Thereafter, the direction of movement of the inkjet head 200 during the sub-scanning operation is set to another direction (the backward path direction), and the second main scanning operation (second pass) on the full surface of the layer of ink is completed.

In this case, individual operations may be carried out in an identical or similar manner to that of the first pass except for the direction of movement of the inkjet head 200 during the sub-scanning operation. This leads to completion of the second main scanning operation on the full surface of the layer of ink.

Thereafter, the direction of movement of the inkjet head 200 during the sub-scanning operation is sequentially reversed, followed by an identical or similar operation as in the first pass and the second pass. This leads to completion of the third and fourth main scanning operations on the full surface of the layer of ink.

As to points other than those described above, the operation shown in FIG. 13(b) may be carried in an identical or similar manner to the operations shown in FIGS. 12(b) and 13(a).

With the above configuration, the sub-scanning operation in two directions (both directions) is appropriately performable when forming a layer of ink by each of the large pitch pass method, small pitch pass method, and full-surface sequential pass method. Thereby, the formation of the three-dimensional object 50 is appropriately performable in a shorter time.

While the present invention has been described with reference to the embodiments thereof, the technical scope of the present invention is not limited to the scope of the description of the above embodiments. It is obvious to those skilled in the art that a variety of changes or modifications are applicable to the above embodiments. It is apparent from the description of claims that embodiments so changed or modified also fall within the technical scope of the present invention.

[Formation Time Reduction]

Formation time reduction of a three-dimensional object according to this embodiment is described below.

An embodiment of the present invention is described with reference to the forming apparatus 10 in FIG. 1.

FIG. 2 shows the operation when a layer of ink is formed by the multi-pass method of the large pitch pass method as described above. In this case, the direction of relative movement of the inkjet head 200 in the sub-scanning operation is set to one direction in the sub-scanning direction in the formation of a layer of ink.

Whereas a plurality of layers of ink are deposited by additive manufacturing in this embodiment. In this case, the sub-scanning driver 18 changes the direction of the relative movement of the inkjet head 200 in the sub-scanning operation, for example, for each of layers of ink. More specifically, for example, in the formation of two continuous layers of ink, when the direction of the relative movement of the inkjet head 200 during formation of a lower layer of ink is set to one direction in the sub-scanning direction, it is conceivable that the direction of the relative movement of the inkjet head 200 during formation of an upper layer of ink is set to another direction in the sub-scanning direction.

With this configuration, the direction in which the inkjet head 200 is subjected to relative movement by the sub-scanning driver 18 is settable not only in one direction but also in two directions (both directions) of one direction and another direction. This makes it possible to, for example, eliminate wasting time needed for an operation of returning to an initial position in association with the relative movement of the inkjet head 200 in the sub-scanning direction. With this configuration, for example, time needed for formation can be reduced to appropriately reduce formation time.

Movement speed of the inkjet head 200 during the main scanning operation and during the sub-scanning operation may be approximately identical to that in the conventional configuration. It therefore seems that decrease of formation precision due to the formation time reduction is less apt to occur.

More specific control of the main scanning operation and the sub-scanning operation is preferably performed based on formation data indicating positions at which the inkjet head 200 needs to eject ink droplets. The direction of the relative movement of the inkjet head 200 during the sub-scanning operation, the above specific control, and the like are described in more detail later.

When the operation of the sub-scanning driver 18 is described in a more generalized manner, this operation can be said to be as follows. The sub-scanning driver 18 causes the inkjet head 200 to move relative to the platform 16 in one direction in the sub-scanning direction subsequently to a part of the main scanning operation, and causes the inkjet head 200 to move relative to the platform 16 in another direction in the sub-scanning direction subsequently to at least another part of the main scanning operation.

In FIG. 2(a) and the like, the case where the direction of movement of the inkjet head 200 is set to only one direction in order to describe the main scanning operation in a more specified form.

In the operation described below, however, the direction of the main scanning operation may be set to two directions (both directions) of one direction and another direction in the main scanning direction. In this case, the main scanning driver 14 causes the inkjet head 200 to perform the main scanning operation in one direction in the main scanning direction and the main scanning operation in another direction. With this configuration, it is possible to, for example, further reduce the formation time for the three-dimensional object 50.

The operation of the multi-pass method is described in more detail below.

As an embodiment of the operation of the multi-pass method, the large pitch pass method is already described above. It is however conceivable to employ a method other than the large pitch pass method as the operation of the multi-pass method.

FIG. 11(a) is the diagram that shows an embodiment of the operation of forming a layer of ink by the multi-pass method that is the small pitch pass method. The term “small pitch pass method” is a method of setting the feed in the sub-scanning operation to be smaller than 1/n of the length (Lh) of the array of nozzles (=Lh/n) when the number of passes is n.

The small pitch pass method can be said to be not the operation of forming a layer of ink by making constant the feed of the sub-scanning operation as in the large pitch pass method, but an operation of forming a layer of ink by repeating the operation of performing the main scanning operation corresponding to a predetermined number of passes by interposing therebetween the sub-scanning operation at a smaller feed, and the subsequent sub-scanning operation at a predetermined feed rate corresponding to the length of the array of nozzles.

FIG. 11(a) shows more specifically the embodiment in which the feed rate when performing the sub-scanning operation at a smaller feed rate is smaller than the nozzle pitch P and the integral multiple of P/n.

In this diagram, symbols such as encircled figures, and characters and the like in the description indicate identical or similar matters to those in FIG. 10(b). A layer of ink is appropriately formable by the multi-pass method that is the small pitch pass method by performing operations as shown in the diagram.

A three-dimensional object is appropriately formable by forming a plurality of layers by deposition. As apparent from the comparison of lengths of completed arrays, this case is capable of forming the layer of ink by a smaller number of the main scanning operations than the case of performing formation by the large pitch pass method. This makes it possible to, for example, reduce formation time.

When the small pitch pass method is described in a more generalized manner, this method can be said to be a method of causing the sub-scanning driver 18 (refer to FIG. 1) to move the inkjet head 200 in the sub-scanning direction relative to the platform 16 by the amount of the sub-scanning direction movement distance being a smaller distance than the width obtained by dividing the length of the array of nozzles in the sub-scanning direction by the number of passes (Lh/n) whenever a preset number of times of the main scanning operations are carried out.

As used herein, the term “sub-scanning direction movement distance” can be said to be a distance obtained by adding an integer multiple of a nozzle pitch sub-scanning direction component that is a distance in the sub-scanning direction between the nozzle holes adjacent to each other in the array of nozzles, and a distance less than the nozzle pitch sub-scanning direction component.

The term “integer multiple of a nozzle pitch second direction component” refers to, for example, a product of the nozzle pitch sub-scanning direction component and an integer of zero or more.

With this configuration, for example, in terms of resolution in the sub-scanning direction, it is possible to appropriately achieve a high resolution corresponding to a distance smaller than the nozzle pitch sub-scanning direction component.

FIG. 11(a) shows, as an embodiment of the operation of the small pitch pass method, the case where the width of a three-dimensional object to be formed (the length in the sub-scanning direction) is larger than the length (Lh) of the array of nozzles. Therefore, in this case, the sub-scanning operation, in which a distance equal to the length of the array of nozzles is a feed rate, is carried out whenever four main scanning operations are carried out. When this case is shown in a more generalized manner, it is possible to say that, for example, after the main scanning operation corresponding to the number of passes are carried out on a region corresponding to the length (Lh) of the array of nozzles, the inkjet head 200 is moved relative to the platform 16 in the sub-scanning direction by a distance corresponding to the length (Lh) of the array of nozzles.

Also in this case, the main scanning operations corresponding to the number of passes are further carried out after the inkjet head 200 is moved. With this configuration, even when a three-dimensional object has a large size, it is possible to appropriately form the three-dimensional object.

However, for example, when a width of a three-dimensional object is smaller than the length (Lh) of the array of nozzles, it is conceivable to simultaneously eject ink droplets from the array of nozzles over a full width of the three-dimensional object without performing the sub-scanning operation over the large distance described above.

With this configuration, the formation by the multi-pass can be appropriately carried out, for example, in the same manner as in the case of using a line-type inkjet head. This also makes it possible to form the three-dimensional object in a shorter time.

When performing the operation of the small pitch pass method, it is conceivable that the direction of relative movement of the inkjet head 200 in the sub-scanning operation is changed, for example, for each layer of ink in the same manner as in the case of the large pitch pass method. In particular, for the sub-scanning operation, whose feed rate is a distance equal to the length (Lh) of the array of nozzles, the direction of the relative movement of the inkjet head 200 is preferably changed for each layer of ink.

For example, the sub-scanning operation of a small feed rate for performing the main scanning operation corresponding to the number of passes may be carried out in two directions (both directions).

FIG. 11(b) is the diagram that shows the embodiment of the operation of forming a layer of ink by the multi-pass method that is the full-surface sequential pass method. The term “full-surface sequential pass method” refers to, for example, a method of sequentially performing the main scanning operations on an identical time. As used herein, the term “main scanning operations on an identical time” refers to, for example, the main scanning operations on an identical time of the main scanning performed a plurality of times on an identical position of a three-dimensional object in the middle of formation in the operation of forming a layer of ink.

In this diagram, the symbols such as encircled figures, and the characters and the like in the description indicate identical or similar matters to those in FIG. 10(b).

A layer of ink is appropriately formable by the full-surface sequential pass method by performing the operations as shown in the diagram.

A three-dimensional object is appropriately formable by forming a plurality of layers by deposition.

As apparent from a comparison of the lengths of completed arrays, this case is capable of forming the layer of ink by a smaller number of the main scanning operations than the case of performing formation by the large pitch pass method. This makes it possible to, for example, reduce formation time.

When the full-surface sequential pass method is described in a more generalized manner, this method can be said to be, for example, an operation of causing the sub-scanning driver 18 to move the inkjet head 200 in the sub-scanning direction relative to the platform 16 by a distance corresponding to the length of the array of nozzles in the sub-scanning direction whenever the main scanning operation is carried out once, in the operation of forming a layer of ink.

In this case, for example, after the first main scanning operation is carried out on the entirety of a region over which a layer of ink needs to be formed, the inkjet head 200 is subjected to the second main scanning operation on individual positions of the layer of ink.

In this case, the distance over which the inkjet head 200 is moved in the sub-scanning direction in the sub-scanning operation is, for example, the distance equal to the length of the array of nozzle in the sub-scanning direction. When the number of passes is 3 or more, the main scanning operations in each of the third and subsequent times are carried out, for example, after the preceding main scanning operation is carried out over the entirety of the layer of ink. With this configuration, the formation by the full-surface sequential pass method is more appropriately performable.

When a layer of ink is formed by the full-surface sequential pass method, the sub-scanning driver 18 changes the direction of the relative movement of the inkjet head 200, for example, whenever the main scanning operations on an identical time are carried on the entirety of a region over which a layer of ink needs to be formed (on a pass-by-pass basis). In this case, a distance over which the inkjet head 200 is moved in the sub-scanning direction in the sub-scanning operation may be a distance substantially equal to the length of the array of nozzles in the sub-scanning direction.

In association with the operation of the sub-scanning driver 18, the phrase “the inkjet head 200 is subjected to relative movement whenever the main scanning operation in the first main scanning operation is carried out” denotes, for example, that during the operation in which the main scanning operations in an identical time (for example, the first or second main scanning operation) are performed on individual positions, the inkjet head 200 is subjected to the relative movement whenever the main scanning operation in that time is carried out. Therefore, in timing that the main scanning operations for a certain time (for example, for the first time) are carried out on the entirety of the region, and then the main scanning operation for the subsequent time (for example, for the second time), it is also conceivable to cause, therebetween, no relative movement of the inkjet head 200 in the sub-scanning direction.

As the specific operation of the multi-pass method, a variety of methods are usable as described above. In this embodiment, the relative movement of the inkjet head 200 in the sub-scanning operation is carried out in two directions (both directions) of one direction and another direction when performing formation by any one of the multi-pass methods. Therefore, the direction of the relative movement of the inkjet head 200 during the sub-scanning operation, specific control and the like are described in more detail below.

FIGS. 12 and 13 are diagrams that describe in more detail the sub-scanning operation in two directions (both directions). As used herein, the term “sub-scanning operation in two directions (both directions)” refers to, for example, that the direction of the relative movement of the inkjet head 200 during the sub-scanning operation is set to two directions (both directions) of one direction and another direction in the sub-scanning direction.

FIG. 12(a) shows an embodiment of the configuration of an inkjet head 200 used in an operation described below, and an embodiment of the configuration of a three-dimensional object 50 to be formed. This inkjet head 200 may be an inkjet head identical or similar to the inkjet head 200 used in each of the configurations described with reference to FIGS. 1, 2, 10, and 11.

In the illustrated case, a length of an array of nozzles (Lh) in the inkjet head 200 is 64 mm. Therefore, when the number of passes is set to 4, a length obtained by dividing the length of the array of nozzles by the number of passes (Lh/4) is 16 mm.

The three-dimensional object 50 formed in the illustrated case is an upside-down cup-shaped three-dimensional object, and is to be formed on the platform 16 in a state in which a part that becomes an opening is directed downward. In this case, a support layer is formed on a region that becomes interior of the cup.

A position indicated as a cross section A in this case is the position corresponding to a formation cross section shown in FIGS. 12(b), 13(a), and 13(b). The formation cross section is a circular shape with a diameter of 120 mm.

FIGS. 12(b), 13(a), and 13(b) are diagrams that show embodiments of the operation when the direction of movement of the inkjet head 200 in the sub-scanning operation is set to two directions (both directions), and show the direction of movement of the inkjet head 200 in the sub-scanning operation carried out after the main scanning operations on each time, in cases where a layer of ink is formed by each of the large pitch pass method, small pitch pass method, and full-surface sequential pass method. In the following description, the term “direction of movement” may denote a direction of relative movement.

More specifically, FIG. 12(b) shows an operation of forming continuous two layers of ink in the operation of the large pitch pass method, in which directions of the sub-scanning operations carried out between the first to eleventh main scanning operations of forming each of the layers of ink are indicated by numbered arrows. In this case, as the operation of forming each of the layers of ink, the main scanning operation is carried out a plurality of times by aligning an end of formation data to control formation with a start position of the main scanning operation.

For example, in the formation of a layer of ink, the direction of movement of the inkjet head 200 is set to one direction (a forward path direction), and the layer of ink is formed in an identical or similar manner as the case described with reference to FIG. 10(b). For example, the main scanning operation is started from the position of a left end of the formation data in the illustrated case. The inkjet head 200 is moved in one direction in the sub-scanning direction (rightward in the diagram) by 16 mm that is a distance obtained by dividing the length of the array of nozzles by the number of passes, whenever the main scanning operations on each time are carried out. The main scanning operation and the sub-scanning operation are repeated in the same manner to perform the main scanning operation eleven times, thereby completing the first layer of ink.

Subsequently, a layer of ink is formed by setting the direction of movement of the inkjet head 200 during the sub-scanning operation to another direction (a backward path direction) and in an identical or similar manner as the case described with reference to FIG. 10(b). In this case, the main scanning operation is started from the position of the right end of the formation data. Also in this case, the inkjet head 200 is moved by 16 mm in another direction (leftward in the diagram) in the sub-scanning direction whenever the main scanning operations on each time are carried out. Thus, the second layer of ink is completed by performing, for example, the main scanning operation eleven times.

When the operation is carried out by the large pitch pass method, as described above, for example, the direction of movement of the inkjet head 200 during the sub-scanning operation is reversed for each layer of ink. Therefore, in this case, setting is made so that the direction of the movement of the inkjet head 200 during the sub-scanning operation become opposite directions between two continuous layers of ink.

In this case, instead of only performing the sub-scanning operation in two directions (both directions), by starting the main scanning operation from positions of ends of the formation data (each of a right end and a left end), a scan initial position at which the main scanning operation is started is appropriately settable so as to, for example, minimize a necessary number of the main scanning operations. This makes it possible to appropriately reduce formation time.

When the setting of the scan initial position is described in a more generalized manner, it can be said that, for example, a position in the sub-scanning direction at which the inkjet head 200 is disposed when at least the first main scanning operation of a plurality of times of the main scanning operations performed when forming a layer of ink is set according to an end of a position at which ink droplets need to be ejected for forming a layer of ink based on the formation data.

This operation can be considered as an operation of setting, for example, a position in the sub-scanning direction at which the inkjet head 200 is disposed when performing at least the first main scanning operation of a plurality of times of the main scanning operations performed while the direction of movement of the inkjet head 200 in the sub-scanning direction is set to an identical distance, according to an end of a position at which ink droplets need to be ejected for forming a layer of ink based on the formation data.

With this configuration, the number of the main scanning operation necessary for forming a layer of ink is reducible appropriately by, for example, setting a scan initial position for each layer of ink. Consequently, for example, a plurality of times of the main scanning operations are more appropriately performable according to a region over which a layer of ink need to be formed.

Therefore, with this configuration, time necessary for formation is reducible by starting a formation operation from an end portion of the formation data in the sub-scanning direction, in association with the sub-scanning operation in two directions (a forward path and a backward path). Consequently, for example, a formation speed can be increased more appropriately.

This configuration is one in which an ejection start position of ink droplets in one direction and another direction in the sub-scanning direction (for example, a print start end in each of the sub-scanning operations in a predetermined forward path direction and a predetermined backward path direction) is aligned with a start end of data corresponding to each of layers of ink (a start end of data of each of the forward path and backward path in a slice layer).

As used herein, the phase “setting the scan initial position according to the end of the position at which ink droplets need to be ejected for forming a layer of ink” refers to, for example, setting the scan initial position so that the position of the end of the position at which ink droplets need to be ejected falls within a scan range.

In this case, the scan initial position is preferably set so as to minimize the number of the main scanning operations necessary for forming a layer of ink as described above. More specifically, it is conceivable to, for example, set the scan initial position so that the end of the inkjet head 200 at the scan initial position and the position of the end of the position at which ink droplets need to be ejected agree with each other.

As used herein, the term “end of the inkjet head 200 at the scan initial position” denotes an end located rearward during movement toward the sub-scanning direction.

Alternatively, the end of the inkjet head 200 at the scan initial position and the position of the end of the position at which ink droplets need to be ejected may agree with each other with a predetermined allowance interposed therebetween.

When the support later to support the three-dimensional object 50 in the middle of formation is formed around the three-dimensional object 50, the end of position at which ink droplets need to be ejected is preferably an end when viewed by including a region over which the support layer is formed.

In FIG. 13(a), in association with the operation of the small pitch pass method, the direction of the sub-scanning operation performed between the main scanning operations corresponding to the number of passes (four) to be continuously performed on a region is indicated by the numbered arrow.

In this case, when forming a layer of ink, the direction of movement of the inkjet head 200 during the sub-scanning operation is set to one direction (the forward path direction), and the layer of ink is formed in an identical or similar manner to the case described with reference to FIG. 11(a).

Also in this case, the formation of individual layers of ink is carried out by aligning the end of formation data to control the formation with a start position of the main scanning operation.

More specifically, the main scanning operation is started from the position of a left end of the formation data, and four main scanning operations corresponding to the number of passes are carried out while interposing therebetween the sub-scanning operation of the small pitch. Thereafter, the inkjet head 200 is moved in one direction (rightward in the diagram) in the sub-scanning direction by 64 mm corresponding to the length of the array of nozzles.

In the illustrated case, the layer of ink is formable in a range of 128 mm that is a region twice the length of the array of nozzles by repeating the above operation two times. Therefore, in this case, the first layer of ink is completed by performing the above operation two times.

Thereafter, a layer of ink is formed by setting the direction of movement of the inkjet head 200 during the sub-scanning operation to another direction (the backward path direction) and in an identical or similar manner to that described with reference to FIG. 11(a). In this case, the main scanning operation is started from the position of a right end of the formation data.

More specifically, in this case, the main scanning operation is started from the position of a right end of the formation data, and the four main scanning operations corresponding to the number of passes are carried out while interposing therebetween the sub-scanning operation of the small pitch. Thereafter, the inkjet head 200 is moved in another direction (leftward in the diagram) in the sub-scanning direction by 64 mm corresponding to the length of the array of nozzles. Also in this case, similarly to the first layer, the second layer of ink is completed by performing the above operation two times. As to points other than those described above, the operation shown in FIG. 13(a) may be carried in an identical or similar manner to the operation shown in FIG. 12(b).

With this configuration, it is possible to appropriately perform formation by the small pitch pass method. Also in this case, formation time is appropriately reducible by setting the scan initial position according to the end of the formation data when performing the sub-scanning operation in each of the directions.

In FIG. 13(b), in association with the operation of the full-surface sequential pass method, the direction of the sub-scanning operation performed between the main scanning operations corresponding to the number of passes (four) to be continuously performed on a region is indicated by the numbered arrow. In this case, the direction of movement of the inkjet head 200 during the sub-scanning operation is changed whenever the main scanning operations on an identical time are carried out on a full surface (on a pass-by-pass basis), instead of being changed for each layer of ink. Also in this case, the formation of individual layers of ink is carried out by aligning the end of formation data to control the formation with a start position of the main scanning operation.

More specifically, the main scanning operation is started from the position of a left end of the formation data, and the first main scanning operation (first pass) on the full surface of a layer of ink in an identical or similar manner to the case described with reference to FIG. 11(b). In this case, the inkjet head 200 is moved in one direction (rightward in the diagram) in the sub-scanning direction by 64 mm corresponding to the length of the array of nozzles whenever the main scanning operation is carried out once. In the illustrated case, the first main scanning operation is performable on a range of 128 mm that is a region twice the length of the array of nozzles by repeating the above operation two times. This leads to completion of the first main scanning operation on the full surface of the layer of ink.

Thereafter, the direction of movement of the inkjet head 200 during the sub-scanning operation is set to another direction (the backward path direction), and the second main scanning operation (second pass) on the full surface of the layer of ink is completed. In this case, individual operations may be carried out in an identical or similar manner to that of the first pass except for the direction of movement of the inkjet head 200 during the sub-scanning operation. This leads to completion of the second main scanning operation on the full surface of the layer of ink.

Thereafter, the direction of movement of the inkjet head 200 during the sub-scanning operation is sequentially reversed, followed by an identical or similar operation as in the first pass and the second pass. This leads to completion of the third and fourth main scanning operations on the full surface of the layer of ink. As to points other than those described above, the operation shown in FIG. 13(b) may be carried in an identical or similar manner to the operations shown in FIGS. 12(b) and 13(a).

With this configuration, it is possible to, for example, appropriately perform formation by the full-surface sequential pass method. Also in this case, formation time is appropriately reducible by setting the scan initial position according to an end of the formation data when performing the sub-scanning operation in each of the directions.

Of the specific multi-pass methods described above, the large pitch method is conceivable as a method identical or similar to the multi-pass method widely used in, for example, printing apparatuses (2D printers) that print two-dimensional images. However, compared with the large pitch pass method, it cannot be said that the small pitch pass method and the full-surface sequential pass method are general methods. Therefore, the small pitch pass method and the full-surface sequential pass method are described in more detail below.

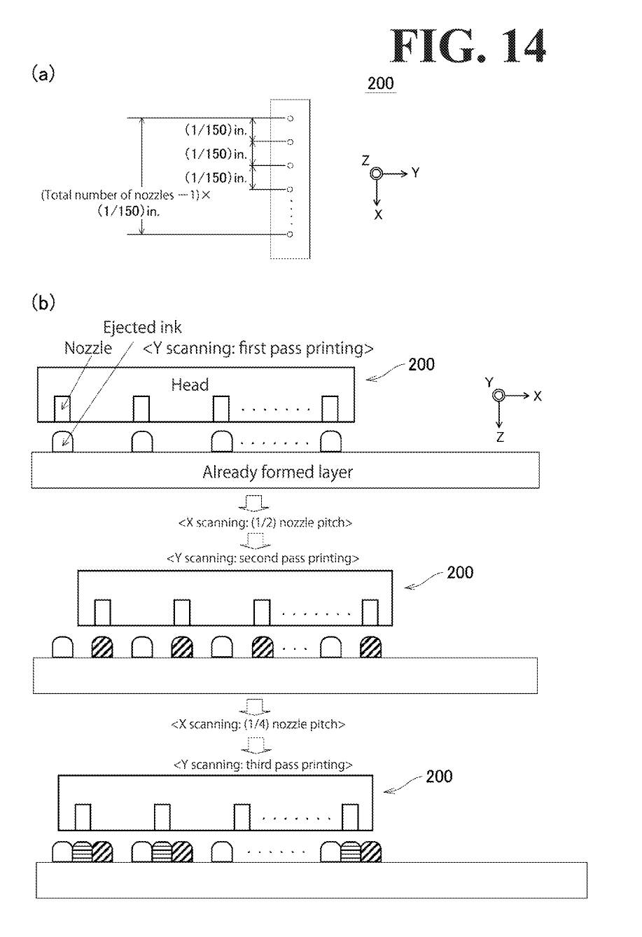

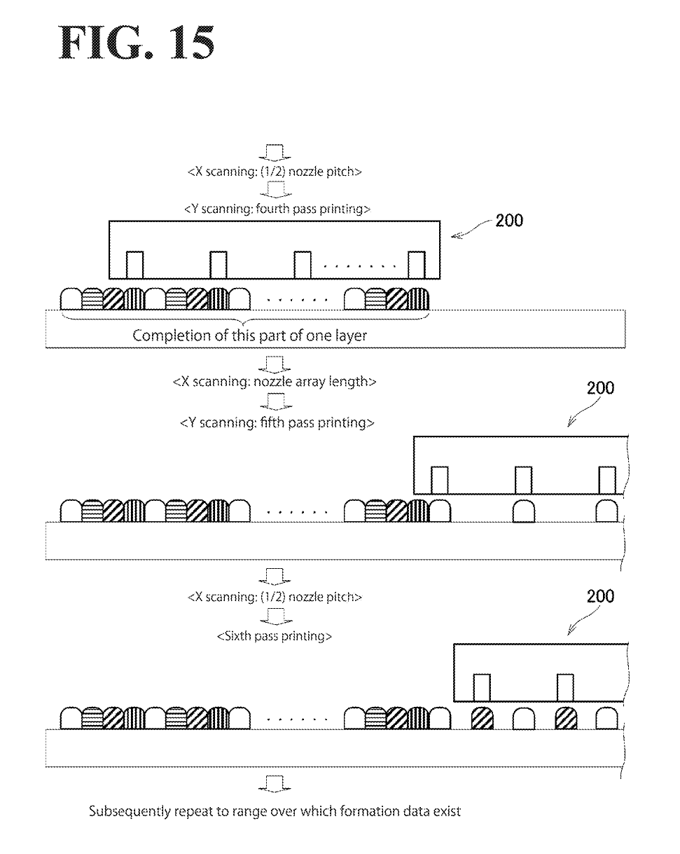

FIGS. 14 and 15 are diagrams that describe an operation of the small pitch pass method in more detail.

FIG. 14(a) is a diagram that describes an embodiment of the configuration of the inkjet head 200.

The illustrated inkjet head 200 is an inkjet head having a configuration identical or similar to the inkjet head 200 in the configuration described with reference to FIGS. 10 to 13, and includes an array of nozzles in which a plurality of nozzle holes are arranged side by side with a resolution of 150 dpi.

FIGS. 14(b) and 15 respectively show an embodiment of a situation of dots of ink formed by first to sixth main scanning operations (Y scanning: first pass printing to a sixth pass printing), and an embodiment of the sub-scanning operation (X scanning) performed between the main scanning operations, in the operation of the small pitch method.

FIGS. 14(b) and 15 show an embodiment of the operation when the number of passes is set to four.

For convenience of illustration, dots of ink formed by the main scanning operations on each time are illustrated by different hatching patterns.

FIGS. 14(b) and 15 show the case where the sub-scanning operation at a small feed rate for performing the main scanning operations corresponding to the number of passes are carried out in two directions (both directions) during an operation of forming a layer of ink.

More specifically, in the illustrated case, the first main scanning operation (first pass printing) is firstly carried out from a state in which the position of an end of formation data and a scan initial position are aligned with each other, so that ink droplets are ejected from the nozzle holes of the inkjet head 200 onto a necessary position. Thereby, dots of ink are formed on a layer of ink that is already formed on a three-dimensional object. Thereafter, the sub-scanning operation to cause relative movement of the inkjet head 200 to the right side in the diagram is carried out by setting the feed rate to half of a nozzle pitch.

Subsequently to this sub-scanning operation, the second main scanning operation (second pass printing) is carried out to form dots of ink with a positional deviation in the sub-scanning direction with respect to the dots of ink formed by the first main scanning operation. Thereafter, the feed rate is set to ¼ of the nozzle pitch, followed by the sub-scanning operation to cause relative movement of the inkjet head 200 to the left side in the diagram, oppositely to the preceding sub-scanning operation.

Subsequently to this sub-scanning operation, the third main scanning operation (third pass printing) is carried out to form dots of ink with a positional deviation in the sub-scanning direction with respect to the dots of ink formed by the first and second main scanning operations. Thereafter, the feed rate is set to ½ of the nozzle pitch, followed by the sub-scanning operation to cause relative movement of the inkjet head 200 to the right side in the diagram, oppositely to the preceding sub-scanning operation.

Subsequently to this sub-scanning operation, the fourth main scanning operation (fourth pass printing) is carried out to form dots of ink with a positional deviation in the sub-scanning direction with respect to the dots of ink formed by the first to third main scanning operations. Thus, in a region where a width in the sub-scanning direction is the length of the array of nozzles, the main scanning operations corresponding to the number of passes are terminated to complete the operation for formation on this region.

Then in the small pitch pass method, after completion of the operation of forming this region, an operation for formation on a subsequent region is carried out. More specifically, after the fourth main scanning operation is carried out, the feed rate is set to be identical with the length of the array of nozzles, followed by the sub-scanning operation. In this case, for example, the inkjet head 200 is subjected to relative movement to the right side in the diagram.

Subsequently to this sub-scanning operation, the fifth main scanning operation (fifth pass printing) is carried out.

In the illustrated case, this main scanning operation is the first main scanning operation on this region. It is therefore conceivable that operations after the fifth main scanning operation are carried out in an identical or similar manner to that after the first main scanning operation except for a position in the sub-scanning direction. For example, after the fifth main scanning operation, the feed rate is set to half of the nozzle pitch, followed by the sub-scanning operation to cause relative movement of the inkjet head 200 to the right side in the diagram.

Subsequently to this sub-scanning operation, the sixth main scanning operation is carried out in an identical or similar to that after the second main scanning operation except for a position in the sub-scanning direction. Thereafter, the above operation is repeated within a range for which formation data exist.

With this configuration, for example, individual layers of ink constituting a three-dimensional object are appropriately formable by the small pitch pass method. A three-dimensional object is appropriately formable by depositing a plurality of layers of ink while sequentially shifting a position in a deposition direction by the deposition direction driver 20 (refer to FIG. 1).

In this case, the formation time for the three-dimensional object is appropriately reducible as described above by setting the direction of movement of the inkjet head 200 to two directions (both directions). In this case, more specifically, the sub-scanning operation whose feed rate is set to be identical with the length of the array of nozzles is preferably set to two directions (both directions) by, for example, setting to the opposite direction for each layer of ink. With this configuration, for example, the formation time of a three-dimensional object is appropriately reducible.

As apparent from the diagram, in the above operation, a position in the sub-scanning direction of dots of ink formed by the second main scanning operation is not a position immediately adjacent to the dots of ink formed by the first main scanning operation, but a position that leaves space for forming dots of ink formed by the subsequent main scanning operation.

This is because, for example, when dots of ink are formed by the second main scanning operation at a position immediately adjacent to the dots of ink formed by the first main scanning operation, new dots of ink are formed in a state of being in contact with the dots of ink in which only one side in the sub-scanning direction is already formed. In this case, for example, symmetry of the shape of dots of ink formed can be lost, and precision of formation can be affected.

In contrast, when dots of ink are formed as described above, the dots of ink formed by the second main scanning operation are appropriately formable with a shape having higher symmetry.

In this case, dots of ink formed by the third and fourth main scanning operations are to be formed in such a manner that new dots of ink are formed in a state in which dots of ink are already formed on both sides in the sub-scanning direction, thus causing no loss of symmetry. Therefore, this configuration makes it possible to, for example, appropriately perform formation of a three-dimensional object.

The foregoing description has described the case where the feed rate when performing the sub-scanning operation at the small feed rate is set to ¼ or ½ of the nozzle pitch so as to be less than the nozzle pitch with higher precision.

It is, however, conceivable that the feed rate in this case is made larger than the nozzle pitch. More specifically, it is conceivable to use, for example, a feed rate obtained by adding a distance of an integer multiple (for example, approximately 1 to 3 times) of the nozzle pitch to a distance of less than a nozzle pitch which corresponds to ¼ or ½ of the nozzle pitch.

This configuration also makes it possible to appropriately perform the operation of the small pitch pass method.

This case follows that in each of layers of ink, dots of ink adjacent to each other in the sub-scanning direction are formed with ink ejected from different nozzle holes. Therefore, even when there is, for example, a poor nozzle having abnormality in ejection characteristics, the influence thereof is reducible appropriately.

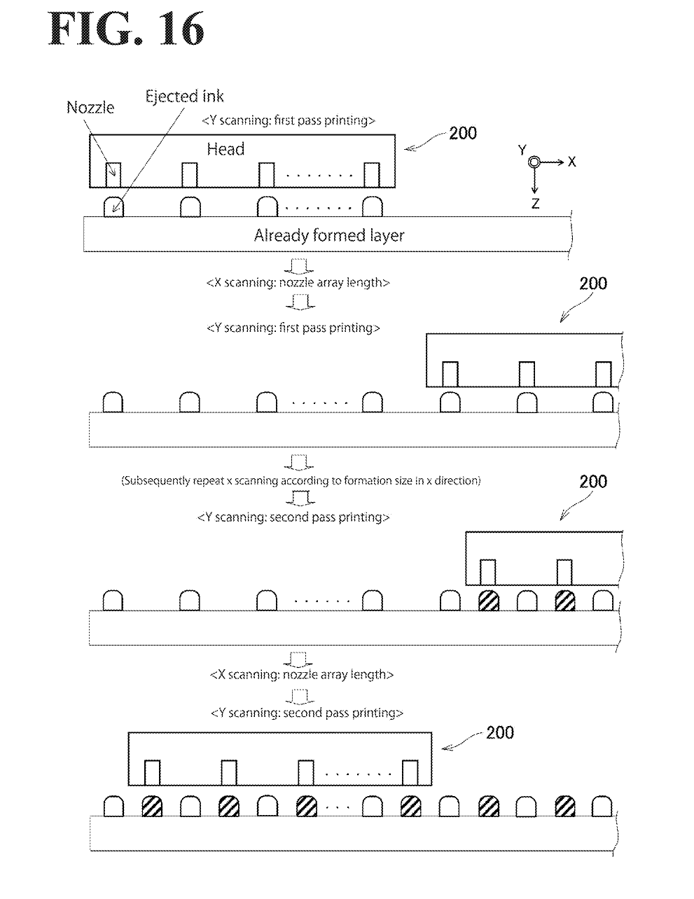

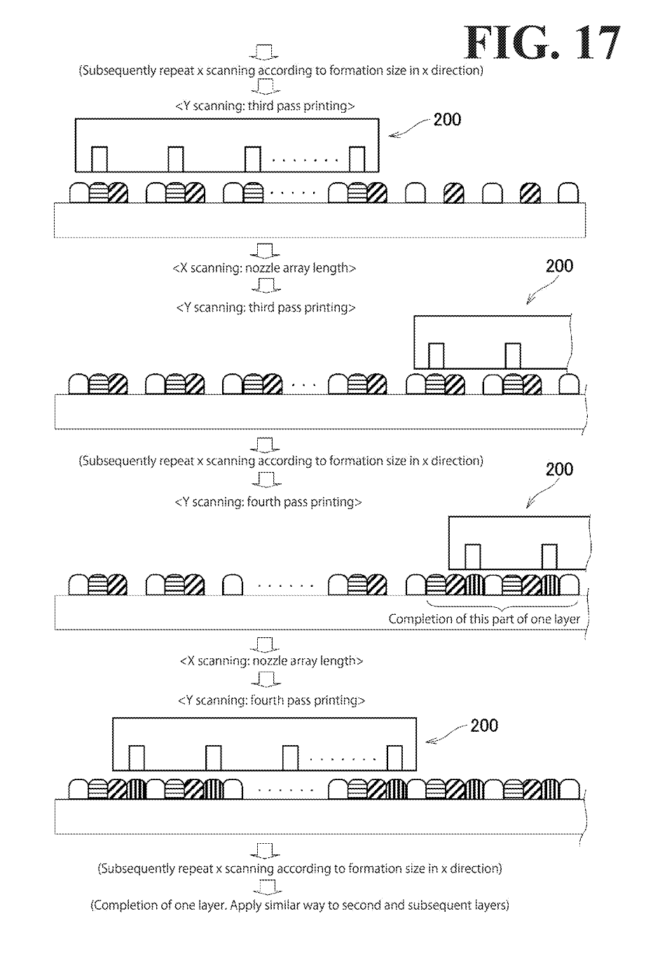

FIGS. 16 and 17 respectively show an embodiment of a situation of dots of ink formed by first to fourth main scanning operations (Y scanning: first pass printing to fourth pass printing) performed on individual positions in order to form a layer of ink, and an embodiment of the sub-scanning operation (X scanning) performed between the main scanning operations, in the operation of the full-surface sequential pass method.

This case also shows the embodiment of the operation when the number of passes is set to four in the same manner as in the case described with reference to FIGS. 14 and 15. For convenience of illustration, dots of ink formed by the main scanning operations on each time are illustrated by different hatching patterns. This case also uses the inkjet head 200 having the configuration shown in FIG. 14(a).

More specifically, in the illustrated case, the first main scanning operation (first pass printing) is firstly carried out from a state in which the position of an end of formation data and a scan initial position are aligned with each other, so that ink droplets are ejected from the nozzle holes of the inkjet head 200 onto a necessary position. Thereby, dots of ink are formed on a layer of ink that is already formed on a three-dimensional object. FIGS. 16 and 17 show the case where the first main scanning operation is started from a region at an end on the left side in the diagram. Therefore, the sub-scanning operation to cause relative movement of the inkjet head 200 to the right side in the diagram is then carried out by setting the feed rate to be identical with the length of the array of nozzles.

Subsequently to this sub-scanning operation, the first main scanning operation on a subsequent region is carried out. Thereafter, the first main scanning operation on a full surface is carried out by repeating the sub-scanning operation corresponding to the length of the array of nozzles in a rightward direction in the diagram, and the main scanning operation according to a length of a region over which a layer of ink needs to be formed in the sub-scanning direction (a formation size in X direction).

Subsequently, the second main scanning (second pass printing) is started from a region at an end on the right side in the diagram. In this case, the second main scanning operation is carried out from a state in which a position of an end of formation data and a scan initial position are aligned with each other, so that dots of ink are formed between the dots of ink formed by the first main scanning operation. Thereafter, the feed rate is set to be identical to the length of the array of nozzle, followed by the sub-scanning operation to cause relative movement of the inkjet head 200 to the left side in the diagram.

Subsequently to this sub-scanning operation, the second main scanning operation on a subsequent region is carried out. Thereafter, the second main scanning operation on the full surface is carried out by repeating the sub-scanning operation corresponding to the length of the array of nozzles in a leftward direction in the diagram, and the main scanning operation according to the length of the region over which the layer of ink needs to be formed in the sub-scanning direction.

Subsequently, the third main scanning operation (third pass printing) is carried out from a region at an end on the left side in diagram. In this case, the third main scanning operation is carried out from a state in which the position of the end of the formation data and the scan initial position are aligned with each other, so that dots of ink are formed between the dots of ink formed by the first and second main scanning operations. Thereafter, the feed rate is set to be identical to the length of the array of nozzle, followed by the sub-scanning operation to cause relative movement of the inkjet head 200 to the right side in the diagram.

Subsequently to this sub-scanning operation, the third main scanning operation on a subsequent region is carried out. Thereafter, the third main scanning operation on the full surface is carried out by repeating the sub-scanning operation corresponding to the length of the array of nozzles in a rightward direction in the diagram, and the main scanning operation according to the length of the region over which the layer of ink needs to be formed in the sub-scanning direction.

Subsequently, the fourth main scanning operation (fourth pass printing) is carried out from the region at the end on the right side in diagram. In this case, the fourth main scanning operation is carried out from a state in which the position of the end of the formation data and the scan initial position are aligned with each other, so that dots of ink are formed between the dots of ink formed by the first to third main scanning operations (for example, between the dots of ink formed by the first and fourth main scanning operations). Thereafter, the feed rate is set to be identical to the length of the array of nozzle, followed by the sub-scanning operation to cause relative movement of the inkjet head 200 to the left side in the diagram.

Subsequently to this sub-scanning operation, the fourth main scanning operation on a subsequent region is carried out. Thereafter, the fourth main scanning operation on the full surface is carried out by repeating the sub-scanning operation corresponding to the length of the array of nozzles in the leftward direction in the diagram, and the main scanning operation according to the length of the region over which the layer of ink needs to be formed in the sub-scanning direction.

With this configuration, for example, individual layers of ink constituting a three-dimensional object are appropriately formable by the full-surface sequential pass method. A three-dimensional object is appropriately formable by depositing a plurality of layers of ink while sequentially shifting a position in a deposition direction by the deposition direction driver 20 (refer to FIG. 1).

In this case, the formation time for the three-dimensional object is appropriately reducible as described above by setting the direction of movement of the inkjet head 200 to two directions (both directions). Dots of ink with enhanced symmetry can be formed to appropriately enhance precision of formation by setting the position of the dots of ink formed by the second main scanning operation in the sub-scanning direction to a position away from the dots of ink formed by the first main scanning operation.

A variety of modifications of the configuration and operation of the forming apparatus 10 are described below.

The foregoing has mainly described the case where the alignment of the dots of ink formed by the major scanning operations on each time in the multi-pass method becomes, for example, a continuous line form in the formation data as described with reference to FIG. 2.

It is, however, conceivable to use a variety of configurations to be completed by a set number of passes (for example, four passes) as the alignment of the dots of ink formed by the main scanning operations on each time. In this case, it is conceivable to use, for example, a variety of known masks used in printing apparatus that print two-dimensional images.

It is possible to make a variety of modifications of the configurations described above. For example, it is conceivable that an error can occur in the amount of movement of the inkjet head 200 by changing the direction of the relative movement (the feed direction) of the inkjet head 200 during the sub-scanning operation when performing the sub-scanning operation in the two directions (both directions) as in the configurations described above. Consequently, a difference can occur in precision of formation. More specifically, it is conceivable that an error can occur in the amount of movement due to a backlash, for example, in timing at which the direction of the feed direction is changed.

Therefore, when performing the sub-scanning operation in the two directions (both directions), it is preferable that before the inkjet head 200 is subjected to relative movement, movement in the opposite direction is carried out once, followed by the sub-scanning operation. In this case, when formation is carried out by any one of the methods (large pitch pass method, small pitch pass method, full-surface sequential pass method), it is conceivable that before performing the sub-scanning operation in one direction and another direction (the sub-scanning operations on the forward path and the backward path), the inkjet head 200 is once subjected to relative movement (scanning) in a reverse direction, followed by the sub-scanning operation in one or another direction.

When this configuration is shown in a more generalized manner, the operation of the sub-scanning driver 18 (refer to FIG. 1) can be said to be such an operation of causing, in between at least part of continuous two sub-scanning operations, the inkjet head 200 to temporarily move relative to the platform 16 in a direction opposite to the direction in which the inkjet head 200 is moved relative to the platform 16 (refer to FIG. 1) in the subsequent sub-scanning operation of the two sub-scanning operations. With this configuration, it is appropriately reduce the influence of the backlash or the like. This makes it possible to more appropriately form a three-dimensional object with more enhanced precision.

A distance over which the inkjet head 200 is moved in the direction opposite to the direction in which the inkjet head 200 is moved relative to the plat form 16 in the sub-scanning operation is preferably be appropriately set, for example, in order to reduce the influence of the backlash. The distance over which the inkjet head is moved in the opposite direction is preferably set to, for example, a distance smaller than the amount of movement of the inkjet head 200) in a subsequent sub-scanning operation.

In the subsequent sub-scanning operation, the inkjet head 200 is preferably moved by also including the amount of distance over which the inkjet head 200 is already moved, in the direction opposite to the direction in which the inkjet head 200 is moved relative to the platform 16 in the above sub-scanning operation.

In this case, it is conceivable to set, as a feed rate, a distance obtained by adding the distance over which the inkjet head 200 is already moved in the direction opposite to the direction in which the inkjet head 200 is moved relative to the platform 16 in the above sub-scanning operation, for example, with respect to the feed rate in the individual configurations described with reference to FIGS. 1 to 10.

The operation of causing the inkjet head 200 to temporarily move in the direction opposite to the direction in which the inkjet head 200 is moved, is preferably carried out in timing of changing the direction of the relative movement of the inkjet head 200 and before performing the sub-scanning operation after being changed.

The operation of causing the inkjet head 200 to temporarily move in the direction opposite to the direction in which the inkjet head 200 is moved may be carried out for each of the sub-scanning operations.

The influence of the backlash is particularly apt to generate a problem when the feed rate in the sub-scanning operation is small. Therefore, when the sub-scanning operation is carried out at a small feed rate when using the small pitch pass method, it is particularly preferable to perform the operation of causing the inkjet head 200 to move in the direction opposite to the direction in which the inkjet head 200 is moved.

With this configuration, the sub-scanning operation with precision less than the nozzle pitch is more appropriately performable with higher precision.

It is also conceivable that the precision of formation becomes lower due to various factors when the sub-scanning operation is carried out in the two directions (both directions) than when the direction of the sub-scanning operation is set to only one direction. For example, when forming a three-dimensional object being colored by using the color ink heads 202y to 202k (refer to FIG. 1), a difference in landing manner of ink droplets can occur depending on the direction of the sub-scanning operation. Consequently, influence can occur on an expressed color.

It is therefore conceivable that a part of a three-dimensional object is formed by setting the direction of the sub-scanning operation to only one direction even when performing the sub-scanning operation in the two directions (both directions). In this case, more specifically, it is conceivable that the direction of the sub-scanning operation performed when forming a region of the three-dimensional object which is subjected to coloring (a coloring region) is set only to one direction.

This configuration ensures, for example, that ink appropriately lands with high precision on the coloring region for which higher precision is needed than a formation region, thereby making it possible to prevent an expressed color from being affected.

Also in this case, formation time is appropriately reducible as a whole by forming portions other than the coloring region (formation region not subjected to coloring) or the like by the sub-scanning operation in the two directions (both directions).

When this configuration is shown in a more generalized manner, the configuration of performing the sub-scanning operation in one direction and another direction can be said to be such a configuration as to cause both of the color ink heads 202y to 202k and the build material head 204 (refer to FIG. 1) to eject ink droplets in the main scanning operations interposing therebetween the sub-scanning operation in one direction, and cause only the build material head 204 of the color ink heads 202y to 202k and the build material head 204 to eject ink droplets in the main scanning operations interposing therebetween the sub-scanning operation in another direction.

This configuration makes it possible to appropriately enhance precision of the landing position of the ink droplets ejected from the color ink heads 202y to 202k. The formation time is reducible by causing the build material head 204 to eject the ink droplets when performing each of the sub-scanning operations in the two directions (both directions). Therefore, with this configuration, the formation time is appropriately reducible, for example, when forming a colored three-dimensional object.

In the configuration shown in FIG. 1, beside the color ink heads 202y to 202k and the build material head 204, a larger number of the inkjet heads 200) (the white ink head 206, the clear ink head 208, and the support material head 210) are used.

Similarly to the build material head 204, it is preferable to cause these ink jet heads 200 to eject ink droplets when performing each of the sub-scanning operations in the two directions (both directions).

In this embodiment, the forming apparatus 10 performs scanning in the deposition direction (Z direction) of the layer of ink, besides the main scanning operation and the sub-scanning operation as described with reference to FIG. 1 and the like. More specifically, as the scanning in the deposition direction, the deposition direction driver 20 (refer to FIG. 1) changes the position of the upper surface of the platform 16 according to the progress of formation of the three-dimensional object 50. In this case, the head-to-platform distance that is the distance between the inkjet head 200 and the platform 16 is increased by, for example, an amount of a thickness being preset as a thickness of a layer of ink, whenever a layer of ink is formed.

Also in this embodiment, the layer of ink is flattened by using the flattening roller 302 in the flattening roller unit 222 (refer to FIG. 1). As used herein, the term “flattening the layer of ink” refers to, for example, removing the ink lying on a portion beyond the thickness being preset as the thickness of a layer of ink. More specifically, the layer of ink is flattened at a height of the preset thickness of the layer of ink (a position in the deposition direction) in the main scanning operation carried out in a direction in which the flattening roller unit 222 is located behind the inkjet head 200. In this case, it is also conceivable to set the head-to-platform distance taking the operation of flattening into consideration.

More specifically, when a layer of ink is formed by using the inkjet head 200, it is conceivable, for example, that whenever the main scanning operations on each time are carried out, dots of ink formed by the main scanning operations at that time are cured.

When the flattening is carried out by the flattening roller 302, the flattening roller 302 flattens the surface of ink by scraping off uncured ink during the operation of forming a layer of ink. In this case, during the main scanning operation that performs the flattening, the flattening is carried out in a state in which the dots of ink already formed by the preceding main scanning operation are already cured. However, in this case, when the flattening roller 302 and the already cured dots of ink contact with each other in the operation of flattening, for example, the cured ink can be rubbed, resulting in the occurrence of excessive residue.

Hence, the setting of the head-to-platform distance is preferably made so as not to generate this problem. As this setting, it is conceivable to, for example, increase stepwise the head-to-platform distance whenever the flattening is carried out, when the main scanning operation that performs flattening is carried out on a region a plurality of times in the operation of forming a layer of ink.

More specifically, for example, in the case where a layer of ink is formed by setting the number of passes to four, and the flattening is carried out by the main scanning operations on each time, the head-to-platform distance is set to 25 μm when the flattening is carried out by setting the height of dots of ink to 25 μm during the first main scanning operation (first pass printing).

The head-to-platform distance is slightly increased to 26 μm during a subsequent main scanning operation (second pass printing). The head-to-platform distance is further increased slightly to 27 μm during a subsequent main scanning operation (third pass printing). The head-to-platform distance is still further increased slightly to 28 μm during a subsequent main scanning operation (fourth pass printing).

This configuration makes it possible to appropriately prevent the flattening roller 302 from coming into contact with the cured dots of ink. This prevents, for example, occurrence of excessive residue, leading to more appropriate flattening.

This configuration can be considered as, for example, a configuration of changing an amount of scanning (Z scanning value) by the deposition direction driver 20 so that the thickness of ink (height of dots of ink) is increased during the subsequent main scanning operation than during the preceding main scanning operation, when a layer of ink is formed by the multi-pass method.

The operation of changing the head-to-platform distance in the above manner is described in more detail below.

FIG. 5 is a diagram that describes the scanning in the deposition direction which changes the head-to-platform distance. FIG. 5(a) shows an embodiment of the scanning in the deposition direction.

The embodiment shown in FIG. 5(a) performs the main scanning operation only in one direction in the main scanning direction in the same manner as in the case described with reference to FIG. 2. Only movement to return the inkjet head 200 to an original position is carried out while causing no ejection of ink droplets at timing indicated as a carriage return in the diagram.

In this case, the flattening roller unit 222 in the ejection unit 12 (refer to FIG. 1) flattens the layer of ink during the main scanning operation, as described with reference to FIG. 1. More specifically, in the embodiment shown in FIG. 5(a), the flattening by the flattening roller unit 222 is carried out at the same time as the operation of each of the main scanning operations (1-pass printing to 4-pass printing).

Thus in the main scanning operation, the main scanning driver 14 (refer to FIG. 1) causes the inkjet head 200 to move in one direction in the main scanning direction. Also in the operation of forming a layer of ink, a plurality of times of the main scanning operations of causing the inkjet head 200 to move in the one direction are carried out on an identical position of a three-dimensional object in the middle of formation. The flattening roller 302 in the flattening roller unit 222 also flattens the layer of ink by moving together with the inkjet head 200 in the main scanning operation in the one direction. Whenever a layer of ink is formed, the deposition direction driver 20 (refer to FIG. 1) lowers the platform 16 by an amount of a thickness of the layer of ink. Consequently, the deposition direction driver 20 increases the head-to-platform distance, which is a distance between the inkjet head 200 and the platform 16 in the ejection unit 12, by the amount of the thickness of the layer of ink than that before starting the formation of the layer of ink.

The setting of the height of the platform 16 during the main scanning operation is made so as to perform an operation of slightly lowering the platform 16 whenever a preset number of times of the main scanning operations are carried out (an inter-pass level difference mode operation) in the operation of forming a layer of ink. Thus, in each of the plurality of the main scanning operations in the one direction carried out during the operation of forming a layer of ink, the heat-to-platform distance during the subsequent main scanning operation is made larger than the head-to-platform distance during the preceding main scanning operation. In other words, in this embodiment, the head-to-platform distance is changed stepwise while performing a plurality of the main canning operations for forming a layer of ink.

In this case, the amount of movement when slightly lowering the platform 16 is preferably made smaller than the thickness of a layer of ink. That is, the deposition direction driver 20 preferably makes head-to-platform distances different from each other by an amount of a distance smaller than the thickness of a layer of ink, with respect to the plurality of the main scanning operations in one direction carried out during the operation of forming a layer of ink. More specifically, in the case shown in FIG. 5(a), the deposition direction driver 20 sets the subsequent head-to-platform distance that is increased by 1 μm whenever the main scanning operation is carried out once. With this configuration, it is possible to stepwise change the head-to-platform distance. This also makes it possible to more appropriately change the head-to-platform distance in a possible range for flattening.

Also in this case, in timing in which the inkjet head 200 is moved without ejection of any ink droplets (a carriage return timing), the inkjet head 200 is moved in a state in which the distance between the inkjet head 200 and the platform 16 is enlarged (a state of clearance during return).

With this configuration, it is possible to appropriately avoid any unnecessary contact between the inkjet head 200 and the three-dimensional object. It is conceivable to set a distance of clearance during return to, for example, approximately 150 μm.

After the formation of a layer of ink is completed, the platform 16 is lowered by an amount of the thickness of the layer of ink (for example, 25 μm), and the head-to-platform distance is adjusted according to the operation of forming the subsequent layer of ink. As used herein, the phrase “the platform 16 is lowered by the amount of the thickness of the layer of ink” refers to, for example, that the height of the platform 16 when the first main scanning operation (1-pass printing) is performed in the formation of each layer as shown in the diagram, is changed by the amount of the thickness of a layer of ink.

With this configuration, for example, the head-to-platform distance during the main scanning operation for forming a layer of ink can be stepwise increased, for example, whenever the main scanning operation is carried out.

Therefore, with this embodiment, it is possible to appropriately prevent that dots of ink formed during the preceding main scanning operation come into contact with the flattening roller 302 in the operation of flattening. It is consequently possible to prevent the occurrence of excessive residue or the like, leading to more appropriate flattening.

In this case, attachment of the residue to the flattening roller 302 is appropriately preventable by preventing the occurrence of the residue or the like.

More specifically, for example, in the case where the flattening roller 302 is used as flattening means, and the blade 304 (refer to FIG. 1) removes the ink scraped up by the flattening roller 302, residue may remain on the blade 304 when the roller 302 scrapes up ink containing excessive residue. Therefore, the blade 304 may not appropriately remove ink scraped up later by the roller 302.

In contrast, the above configuration makes it possible to, for example, appropriately prevent attachment of residue to the flattening roller 302 and the blade 304. It is consequently possible to, for example, stabilize processing of the ink without deteriorating a flow of excessive ink recovered by the flattening. It is also possible to appropriately prevent, for example, ink clogging in a recovery channel.

When the dots of ink formed by the preceding main scanning operation and the flattening roller 302 contact with each other, it is conceivable, for example, that unnecessary vibration (chatter vibration) occurs and affects the result of the flattening. For example, when the flattening roller 302 performs the flattening, unintended irregularities (such as chatter marks) can occur on the surface of layer of ink after flattening.

Whereas the above configuration makes it possible to appropriately prevent, for example, the occurrence of the irregularities.

Also in this case, for example, the surface of the three-dimensional object can be made smooth by gradually changing the head-to-platform distance for each of the main scanning operations. More specifically, even when the surface of the three-dimensional object has a gentle slope shape, for example, occurrence of outstanding steps in the form of contours is preventable, and it is therefore possible to more appropriately perform the formation that ensures a smooth surface.

An amount of change of the head-to-platform distance to be changed whenever the main scanning operation is carried out is, without being limited to 1 μm, preferably appropriately set according to necessary precision and the configuration of the apparatus.

The amount of change is preferably set according to, for example, the thickness of a layer of ink, and the kind of inks used for simultaneously forming a layer within the single layer.

In order to prevent the contact between the flattening roller 302 and the cured dots of ink and appropriately perform flattening, the amount of change of the head-to-platform distance to be changed whenever the main scanning operation is carried out is preferably, for example, approximately 0.5 to 5 μm.

The operation of increasing the head-to-platform distance is not necessarily needed whenever the main scanning operations on each time are carried out.

In this case, it is conceivable to increase the head-to platform distance, for example, whenever a preset main scanning operation is carried out.

For example, it is conceivable that the head-to-platform distance during the succeeding main scanning operation is set larger than the head-to-platform distance during the preceding one, in association with at least part of the main scanning operations of a plurality of times of the main scanning operations that perform flattening.

More specifically, for example, when the number of passes is set to four in the same manner as the case described with reference to FIG. 5(a), the head-to-platform distance may be changed only after performing the second main scanning operation (2-pass printing).

In this case, the head-to-platform distance remains the same during the first and second main scanning operations. The head-to-platform distance remains the same during the third and fourth main scanning operations. In this case, the head-to-platform distance is preferably set to, for example, approximately 5 μm.

The direction of the main scanning operation may be two directions (both directions) on the forward path and the backward path, instead of being only one direction of the main scanning direction. In this case, the scanning in the deposition direction or the like may also be carried out according to a direction in which the main scanning is carried out.

FIG. 5(b) is a diagram that shows another embodiment of scanning in a deposition direction, and shows the embodiment of the scanning in the deposition direction when performing the main scanning operation in two directions (both directions). The scanning in the deposition direction carried out as shown in FIG. 5(b) is identical or similar to the scanning in the deposition direction shown in FIG. 5(a), except for points described below.

In this case, the height of the platform 16 does not remain the same and the operation of slightly lowering the platform 16 is carried out whenever the main scanning operation is carried out, in association with a plurality of times of the main scanning operations in one direction of the forward path or backward path (for example, the main scanning operations corresponding to 1-pass printing and 3-pass printing in the diagram) in the operation of forming a layer of ink.

As used herein, the term “the plurality of times of the main scanning operations in one direction of the forward path or backward path” refers to, for example, the main scanning operation that performs flattening by the flattening roller 302 of the flattening roller unit 222.

Also in this case, in association with a plurality of times of the main scanning operations in another direction (for example, the main scanning operations corresponding to 2-pass printing and 4-pass printing), the main scanning operations may be carried out at the same height in a state in which the platform is lowered by the amount of clearance during return.

With this configuration, the formation of the three-dimensional object is performable in a shorter time by, for example, performing the main scanning operation in two directions (both directions). Even when so configured, the head-to-platform distance during the main scanning operation in one direction of the forward path or backward path for forming a layer of ink can be increased stepwise whenever the main scanning operation is carried out. Therefore, with this configuration, it is possible to appropriately prevent, for example, that dots of ink formed during the preceding main scanning operation come into contact with the flattening roller 302 in the operation of flattening. This makes it possible to appropriately and sufficiently flatten the layer of ink. Furthermore, in this case, for example, the configuration and control of the forming apparatus 10 can be appropriately simplified by performing no flattening during the main scanning operation in another direction on the forward path or backward path, and by setting the head-to-platform distance to an identical distance.

Here, when the configuration described with reference to FIG. 1 is employed, this becomes, for example, the configuration that flattening is carried out only during the main scanning operation in one direction as described above. However, in modifications of the configuration and operation of the forming apparatus 10, for example, the main scanning operation in two directions (both directions) may be carried out, and the flattening may be carried out not only during the main scanning operation in one direction but also during the main scanning operation in another direction. In this case, it is conceivable, for example, that the ejection unit 12 including the flattening roller unit 222 (refer to FIG. 1) is used on one side and another side in the main scanning direction, and the flattening is performed by the flattening roller 302 of the flattening roller unit 222 located rearward during the main scanning operation. In this case, it is preferable to increase stepwise the head-to-platform distance by lowering the platform 16 whenever the main scanning operation is carried out, irrespective of the direction in which the inkjet head 200 is moved during the main scanning operation.

Even with this configuration, it is possible to, for example, appropriately prevent the dots of ink formed during the preceding main scanning operation from coming into contact with the flattening roller 302 by increasing stepwise the head-to-platform distance whenever the main scanning operation is carried out. This prevents, for example, the occurrence of excessive residue, leading to more appropriate flattening.

Although the present invention has been described with reference to the embodiments, the technical scope of the present invention is not limited to the scope of the description of the above embodiments. It is apparent to those skilled in the art that a variety of changes or improvements are applicable to the above embodiments. It is apparent from the description of claims that any embodiment obtained by making such changes or improvements can also be included within the technical scope of the present invention.

### INDUSTRIAL APPLICABILITY

The present invention is suitably applicable to, for example, forming apparatuses.

### DESCRIPTION OF THE REFERENCE NUMERAL

10 . . . forming apparatus, 12 . . . ejection unit, 14 . . . main scanning driver, 16 . . . platform, 18 . . . sub-scanning driver, 20 . . . deposition direction driver, 22 . . . controller, 50 . . . three-dimensional object, 102 . . . carriage, 104 . . . guide rail, 200 . . . inkjet head, 204 . . . build material head, 206 . . . white ink head, 208 . . . clear ink head, 210 . . . support material head, 220 . . . UV light source, 222 . . . flattening roller unit, 302 . . . flattening roller, 304 . . . blade, 306 . . . ink recovery part, 308 . . . suction part, 310 . . . pump, 312 . . . exhaust ink tank, 314 . . . pressurized air discharge part, 402 . . . arrow, 404 . . . region

1. A forming apparatus for forming a three-dimensional object by additive manufacturing, the forming apparatus comprising:
an inkjet head configured to eject ink droplets by inkjet scheme;
flattening means for flattening a layer of ink formed by ink ejected from the inkjet head;
a platform being a table-shaped member to support the three-dimensional object in a middle of formation and being configured to be disposed at a position opposed to the inkjet head;
a first direction scanning driver configured to cause the inkjet head to perform a first direction scanning comprising movement relative to the platform in a preset first direction while ejecting ink droplets; and
a deposition direction driver configured to change a head-to-platform distance being a distance between the inkjet head and the platform by causing at least one of the platform and the inkjet head to move in a deposition direction being orthogonal to the first direction and being a direction in which a plurality of layers are deposited in additive manufacturing,
wherein the inkjet head comprises an array of nozzles with a plurality of nozzles arranged in a nozzle array direction being nonparallel to the first direction,
wherein the first direction scanning driver is configured to cause, in the first direction scanning, the inkjet head to move in at least one direction in the first direction, and configured to cause, in an operation of forming a layer of ink, a plurality of times of the first direction scanning intended to cause the inkjet head to move in the one direction with respect to an identical position of the three-dimensional object in the middle of formation,
wherein the flattening means is configured to flatten a layer of ink by moving together with the inkjet head in the first direction scanning in the one direction,
wherein the deposition direction driver is configured to increase the head-to-platform distance by an amount of a preset thickness of a layer of ink than before starting formation of the layer of ink whenever the layer of ink is formed, and is configured to increase the head-to-platform distance during the first direction scanning to be performed later than the head-to-platform distance during the first direction scanning to be performed earlier in each of at least part of a plurality of times of the first direction scanning in the one direction to be performed during the operation of forming the layer of ink.

2. The forming apparatus according to claim 1, wherein the deposition direction driver differentiates the head-to-platform distance between the at least part of the plurality of times of the first direction scanning by a distance smaller than the preset thickness of the layer of ink.

3. The forming apparatus according to claim 1, wherein the flattening means is a roller to flatten a layer of ink by coming into contact with a surface of the layer of ink.

4. The forming apparatus according to claim 3, further comprising:
a second direction scanning driver configured to cause the inkjet head to move relative to the platform in a second direction orthogonal to the first direction,
wherein the first direction scanning driver causes the inkjet head to perform the first direction scanning corresponding to a plurality of preset number of passes with respect to individual positions of the layer of ink in the operation of forming the layer of ink, and
wherein the second direction scanning driver causes the inkjet head to move relative to the platform in the second direction by an amount of a pass width that is a width obtained by dividing a length of the array of nozzles in the second direction by the number of passes, whenever a preset number of times of the first direction scanning are performed in the operation of forming the layer of ink.

5. The forming apparatus according to claim 3, further comprising:
a second direction scanning driver configured to cause the inkjet head to move relative to the platform in a second direction orthogonal to the first direction,
wherein the first direction scanning driver causes the inkjet head to perform the first direction scanning corresponding to a plurality of preset number of passes with respect to individual positions of the layer of ink in the operation of forming the layer of ink,
wherein the second direction scanning driver causes the inkjet head to move relative to the platform in the second direction by a second direction movement distance that is a distance smaller than a width obtained by dividing the length of the array of nozzles in the second direction by the number of passes, whenever a preset number of times of the first direction scanning are performed in the operation of forming the layer of ink, and
wherein the second direction movement is a distance obtained by adding an integer multiple of a nozzle pitch second direction component that is a distance between the nozzles adjacent to each other in the array of nozzles in the second direction, and a distance less than the nozzle pitch second direction component.

6. The forming apparatus according to claim 3, further comprising:
a second direction scanning driver configured to cause the inkjet head to move relative to the platform in a second direction orthogonal to the first direction,
wherein the first direction scanning driver causes the inkjet head to perform the first direction scanning corresponding to a plurality of preset number of passes with respect to individual positions of the layer of ink in the operation of forming the layer of ink,
wherein the second direction scanning driver causes the inkjet head to move relative to the platform in the second direction by a distance corresponding to the length of the array of nozzles in the second direction, whenever the first direction scanning is performed once in the operation of forming the layer of ink, and
wherein the first direction scanning driver causes the inkjet head to perform the first direction scanning for a second time on each position of the layer of ink after the first direction scanning for a first time is carried out over an entirety of a region over which the layer of ink needs to be formed.

7. The forming apparatus according to claim 1,
wherein the first direction scanning driver causes the inkjet head to perform the first direction scanning in the one direction in the first direction, and the first direction scanning in another direction in the first direction,
wherein the flattening means flattens a layer of ink only during the first direction scanning in the one direction of the first direction scanning in the one direction and the another direction, and
wherein the deposition direction driver sets the head-to-platform distance to an identical distance in each of a plurality of times of the first direction scanning in the another direction performed during the operation of forming the layer of ink.

8. The forming apparatus according to claim 1,
wherein the first direction scanning driver causes the inkjet head to perform the first direction scanning in the one direction in the first direction, and the first direction scanning in another direction in the first direction,
wherein the flattening means comprises first flattening means for flattening a layer of ink during the first direction scanning in the one direction, and second flattening means for flattening a layer of ink during the first direction scanning in the another direction, and
wherein the deposition direction driver increases the head-to-platform distance by an amount of a preset thickness of a layer of ink than before starting formation of the layer of ink whenever the layer of ink is formed, and increases the head-to-platform distance during the first direction scanning to be performed later than the head-to-platform distance during the first direction scanning to be performed earlier in each of at least part of a plurality of times of the first direction scanning in the another direction to be performed during the operation of forming the layer of ink.

9. The forming apparatus according to claim 1, further comprising:
a second direction scanning driver configured to cause the inkjet head to move relative to the platform in a second direction orthogonal to the first direction,
wherein the second direction scanning driver causes the inkjet head to move relative to the platform in one direction in the second direction, subsequently to part of the first direction scanning, and causes the inkjet head to move relative to the platform in another direction in the second direction, subsequently to at least another part of the first direction scanning.

10. A forming method for forming a three-dimensional object by additive manufacturing, the forming method using:
an inkjet head configured to eject ink droplets by inkjet scheme;
flattening means for flattening a layer of ink formed by ink ejected from the inkjet head; and
a platform being a table-shaped member to support the three-dimensional object in a middle of formation and being configured to be disposed at a position opposed to the inkjet head,
the forming method comprising:
causing the inkjet head to perform a first direction scanning comprising movement relative to the platform in a preset first direction while ejecting ink droplets; and
changing a head-to-platform distance being a distance between the inkjet head and the platform by causing at least one of the platform and the inkjet head to move in a deposition direction being orthogonal to the first direction and being a direction in which a plurality of layers are deposited in additive manufacturing,
wherein the inkjet head comprises an array of nozzles with a plurality of nozzles arranged in a nozzle array direction being nonparallel to the first direction,
causing, in the first direction scanning, the inkjet head to move in at least one direction in the first direction;
causing, in an operation of forming a layer of ink, a plurality of times of the first direction scanning intended to cause the inkjet head to move in the one direction with respect to an identical position of the three-dimensional object in the middle of formation,
wherein the flattening means is configured to flatten a layer of ink by moving together with the inkjet head in the first direction scanning in the one direction; and
increasing the head-to-platform distance by an amount of a preset thickness of a layer of ink than before starting formation of the layer of ink whenever the layer of ink is formed, and increasing the head-to-platform distance during the first direction scanning to be performed later than the head-to-platform distance during the first direction scanning to be performed earlier in each of at least part of a plurality of times of the first direction scanning in the one direction to be performed during the operation of forming the layer of ink.

11. A forming apparatus for forming a three-dimensional object by additive manufacturing, the forming apparatus comprising:
an inkjet head configured to eject ink droplets by inkjet scheme;
flattening means for flattening a layer of ink formed by ink ejected from the inkjet head;
a platform being a table-shaped member to support the three-dimensional object in a middle of formation and being configured to be disposed at a position opposed to the inkjet head;
a first direction scanning driver configured to cause the inkjet head to perform a first direction scanning comprising movement relative to the platform in a preset first direction while ejecting ink droplets; and
a deposition direction driver configured to change a head-to-platform distance being a distance between the inkjet head and the platform by causing at least one of the platform and the inkjet head to move in a deposition direction being orthogonal to the first direction and being a direction in which a plurality of layers are deposited in additive manufacturing,
wherein the inkjet head comprises an array of nozzles with a plurality of nozzles arranged in a nozzle array direction being nonparallel to the first direction,
wherein the first direction scanning driver is configured to cause, in the first direction scanning, the inkjet head to move in at least one direction in the first direction, and is configured to cause, in an operation of forming a layer of ink, a plurality of times of the first direction scanning intended to cause the inkjet head to move in the one direction with respect to an identical position of the three-dimensional object in the middle of formation,
wherein the flattening means is configured to flatten a layer of ink by moving together with the inkjet head in the first direction scanning in the one direction,
wherein the deposition direction driver is configured to increase the head-to-platform distance by an amount of a preset thickness of a layer of ink than before starting formation of the layer of ink, whenever the layer of ink is formed, and is configured to differentiate the head-to-platform distance during the first direction scanning to be performed later in each of at least part of a plurality of times of the first direction scanning in the one direction to be performed during the operation of forming the layer of ink, from the head-to-platform distance during the first direction scanning to be performed earlier.

12. A forming method for forming a three-dimensional object by additive manufacturing, the forming method using:
an inkjet head configured to eject ink droplets by inkjet scheme;
flattening means for flattening a layer of ink formed by ink ejected from the inkjet head;
a platform being a table-shaped member to support the three-dimensional object in a middle of formation and being configured to be disposed at a position opposed to the inkjet head,
the forming method comprising:
causing the inkjet head to perform a first direction scanning comprising movement relative to the platform in a preset first direction while ejecting ink droplets; and
changing a head-to-platform distance being a distance between the inkjet head and the platform by causing at least one of the platform and the inkjet head to move in a deposition direction being orthogonal to the first direction and being a direction in which a plurality of layers are deposited in additive manufacturing,
wherein the inkjet head comprises an array of nozzles with a plurality of nozzles arranged in a nozzle array direction being nonparallel to the first direction;
causing, in the first direction scanning, the inkjet head to move in at least one direction in the first direction, and causing, in an operation of forming a layer of ink, a plurality of times of the first direction scanning intended to cause the inkjet head to move in the one direction with respect to an identical position of the three-dimensional object in the middle of formation,
wherein the flattening means is configured to flatten a layer of ink by moving together with the inkjet head in the first direction scanning in the one direction; and
increasing the head-to-platform distance by an amount of a preset thickness of a layer of ink than before starting formation of the layer of ink, whenever the layer of ink is formed, and differentiating the head-to-platform distance during the first direction scanning to be performed later from the head-to-platform distance during the first direction scanning to be performed earlier in each of at least part of a plurality of times of the first direction scanning in the one direction to be performed during the operation of forming the layer of ink.

13. A forming apparatus for forming a three-dimensional object by additive manufacturing, the forming apparatus comprising:
an inkjet head configured to eject ink droplets by inkjet scheme;
a platform being a table-shaped member to support the three-dimensional object in a middle of formation and being configured to be disposed at a position opposed to the inkjet head;
a first direction scanning driver configured to cause the inkjet head to perform a first direction scanning comprising movement relative to the platform in a preset first direction while ejecting ink droplets;
a second direction scanning driver configured to cause the inkjet head to move relative to the platform in a second direction orthogonal to the first direction; and
a deposition direction driver configured to change a head-to-platform distance being a distance between the inkjet head and the platform by causing at least one of the platform and the inkjet head to move in a deposition direction being orthogonal to the first direction and being a direction in which a plurality of layers are deposited in additive manufacturing,
wherein the second direction scanning driver is configured to cause the inkjet head to move in one direction in the second direction subsequently to part of the first direction scanning, and configured to cause the inkjet head to move relative to the platform in another direction in the second direction, subsequently to at least another part of the first direction scanning.

14. The forming apparatus according to claim 13,
wherein the forming apparatus forms the three-dimensional object based on formation data indicating a position at which ink droplets need to be ejected by the inkjet head,
wherein the second direction scanning driver causes the inkjet head to move relative to the platform whenever a preset number of times of the first direction scanning is performed,
wherein the first direction scanning driver causes the inkjet head to perform a plurality of times of the first direction scanning in an operation of forming a layer of ink, and
wherein, when performing the first direction scanning for at least a first time of the plurality of times of the first direction scanning performed during formation of the layer of ink, a position in the second direction at which the inkjet head is disposed, is set based on the formation data, according to an end of a position at which ink droplets need to be ejected for forming the layer of ink.

15. The forming apparatus according to claim 14,
wherein the first direction scanning driver causes the inkjet head to perform a plurality of times of the first direction scanning as at least part of the operation of forming the layer of ink, and, in between the plurality of times of the first direction scanning, the second direction scanning driver causes the inkjet head to move relative to the platform by setting a movement direction in the second direction to an identical direction, and
wherein, when performing the first direction scanning for at least a first time of the plurality of times of the first direction scanning performed while a direction of movement in the second direction is being set to an identical direction, a position in the second direction at which the inkjet head is disposed, is set based on the formation data, according to an end of a position at which ink droplets need to be ejected for forming the layer of ink.

16. The forming apparatus according to claim 13,
wherein, when an operation of causing the inkjet head to move relative to the platform in the second direction is referred to as a second direction scanning, the second direction scanning driver causes, in between at least part of second direction scanning sequentially performed two times, the inkjet head to temporarily move relative to the platform in a direction opposite to a direction in which the inkjet head is moved relative to the platform in the second direction scanning of a subsequent time of the two times.

17. The forming apparatus according to claim 13,
wherein, when an operation of causing the inkjet head to move relative to the platform in the second direction is referred to as a second direction scanning, the second direction scanning driver causes the inkjet head to perform the second direction scanning in one direction intended to cause the inkjet head to move relative to the platform in one direction in the second direction, and the second direction scanning in another direction intended to cause the inkjet head to move relative to the platform in another direction in the second direction,
wherein the forming apparatus comprises, as the inkjet head, a coloring head being an inkjet head to eject ink droplets for coloring, and a build material head being an inkjet head to eject ink droplets of ink used for formation in a region of the three-dimensional object not subjected to coloring,
wherein, when performing the first direction scanning interposing therebetween the second direction scanning in the one direction, the first direction driver causes both of the coloring head and the build material head to eject ink droplets, and
wherein, when performing the first direction scanning interposing therebetween the second direction scanning in the another direction, the first direction driver causes only the build material head of the coloring head and the build material head to eject ink droplets.

18. The forming apparatus according to claim 13, further comprising:
flattening means for flattening a layer of ink formed by the inkjet head,
wherein the inkjet head comprises an array of nozzles with a plurality of nozzles arranged in a nozzle array direction being nonparallel to the first direction,
wherein the first direction scanning driver is configured to cause, in the first direction scanning, the inkjet head to move in at least one direction in the first direction, and configured to cause, in an operation of forming a layer of ink, a plurality of times of the first direction scanning intended to cause the inkjet head to move in the one direction with respect to an identical position of the three-dimensional object in the middle of formation,
wherein the flattening means is configured to flatten a layer of ink by moving together with the inkjet head in the first direction scanning in the one direction,
wherein the deposition direction driver is configured to increase the head-to-platform distance by an amount of a preset thickness of a layer of ink than before starting formation of the layer of ink whenever the layer of ink is formed, and is configured to increase the head-to-platform distance during the first direction scanning to be performed later than the head-to-platform distance during the first direction scanning to be performed earlier in each of at least part of a plurality of times of the first direction scanning in the one direction to be performed during the operation of forming the layer of ink.

19. The forming apparatus according to claim 18,
wherein the first direction scanning driver causes the inkjet head to perform the first direction scanning corresponding to a plurality of preset number of passes with respect to individual positions of the layer of ink in the operation of forming the layer of ink, and
wherein the second direction scanning driver causes the inkjet head to move relative to the platform in the second direction by an amount of a pass width that is a width obtained by dividing a length of the array of nozzles in the second direction by the number of passes, whenever a preset number of times of the first direction scanning are performed in the operation of forming the layer of ink.

20. The forming apparatus according to claim 18,
wherein the first direction scanning driver causes the inkjet head to perform the first direction scanning corresponding to a plurality of preset number of passes with respect to individual positions of the layer of ink in the operation of forming the layer of ink, and
wherein the second direction scanning driver causes the inkjet head to move relative to the platform in the second direction by a second direction movement distance that is a distance smaller than a width obtained by dividing the length of the array of nozzles in the second direction by the number of passes, whenever a preset number of times of the first direction scanning are performed in the operation of forming the layer of ink, and
wherein the second direction movement is a distance obtained by adding an integer multiple of a nozzle pitch second direction component that is a distance between the nozzles adjacent to each other in the array of nozzles in the second direction, and a distance less than the nozzle pitch second direction component.

21. The forming apparatus according to claim 18, further comprising:
a second direction scanning driver configured to cause the inkjet head to move relative to the platform in a second direction orthogonal to the first direction,
wherein the first direction scanning driver causes the inkjet head to perform the first direction scanning corresponding to a plurality of preset number of passes with respect to individual positions of the layer of ink in the operation of forming the layer of ink,
wherein the second direction scanning driver causes the inkjet head to move relative to the platform in the second direction by an amount of a pass width that is a width obtained by dividing a length of the array of nozzles in the second direction by the number of passes, whenever a preset number of times of the first direction scanning are performed in the operation of forming the layer of ink, and
wherein the first direction scanning driver causes the inkjet head to perform the first direction scanning for a second time on each position of the layer of ink after the first direction scanning for a first time is carried out over an entirety of a region over which the layer of ink needs to be formed.

22. A forming method for forming a three-dimensional object by additive manufacturing, the forming method using:
an inkjet head configured to eject ink droplets by inkjet scheme; and
a platform being a table-shaped member to support the three-dimensional object in a middle of formation and being configured to be disposed at a position opposed to the inkjet head,
the forming method comprising:
causing the inkjet head to perform a first direction scanning comprising movement relative to the platform in a preset first direction while ejecting ink droplets;
causing the inkjet head to move relative to the platform in a second direction orthogonal to the first direction;
changing a distance between the inkjet head and the platform by causing at least one of the platform and the inkjet head to move in a deposition direction being orthogonal to the first direction and being a direction in which a plurality of layers are deposited in additive manufacturing;
causing the inkjet head to move relative to the platform in one direction in the second direction, subsequently to part of the first direction scanning, and causing the inkjet head to move relative to the platform in another direction in the second direction, subsequently to at least another part of the first direction scanning.
